(19) United States
(12) Patent Application Publication
(10) Pub. No.: US 2006/0035180 A1
(43) Pub. Date: Feb. 16, 2006

(54) Photothermographic material and image forming method using the same

(75) Inventor: Takayoshi Mori, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/198,850

(22) Filed: Aug. 8, 2005

(30) Foreign Application Priority Data
Aug. 10, 2004 (JP) 2004-233817

(51) Int. Cl. G03C 1/00

(52) U.S. Cl. 430/619

(57) ABSTRACT

A photothermographic material comprising a support and an image-forming layer provided on at least one side of the support, wherein the image-forming layer includes a photosensitive silver halide, a non-photosensitive organic silver salt, a reducing agent, and a binder, at least 50% by mass of the binder is a hydrophilic binder, the non-photosensitive organic silver salt has a silver behenate content of 50% by mol or higher, the photothermographic material further comprises a compound represented by the following formula (I) or (II) and at least one of a compound whose one-electron oxidized form is capable of releasing one or more electron(s) and an adsorbent redox compound having an adsorbent group and a reducing group:

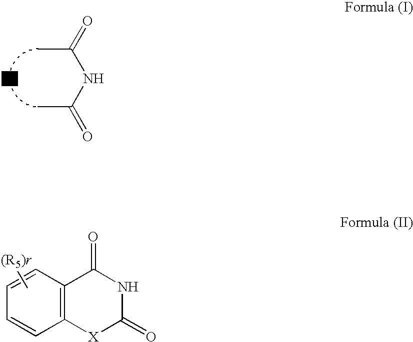

wherein Q represents an atomic group required for forming a five- or six-membered imide ring; R₅ represents a hydrogen atom or a substituent; r represents 0, 1 or 2; and X represents O, S, Se, or N(R₆).

### CROSS-REFERENCE TO RELATED APPLICATION

This application claims priority under 35 USC 119 from Japanese patent Application No. 2004-233817, the disclosure of which is incorporated by reference herein.

### BACKGROUND OF THE INVENTION

1. Field of the Invention

The present invention relates to photothermographic materials and image forming methods using the same.

2. Description of the Related Art

Reduction of waste solutions to be treated has been strongly desired in recent years in the medical field from the viewpoints of environmental protection and space saving. Under such circumstances, technologies on photosensitive photothermographic photographic materials for medical diagnosis and photography which can be exposed to light efficiently with a laser image setter or a laser imager, and can form a clear black image having high resolution and sharpness have been demanded. With these photosensitive photothermographic photographic materials, it is possible to supply to customers a heat development treatment system which has eliminated the necessity of using solvent system processing chemicals, and is simpler and does not impair the environment.

The similar requirements also exist in the field of general image forming materials. However, the image for medical use is required to have a high image quality excellent in sharpness and graininess, because fine details of the image are required. In addition, the medical image is characterized by that a blue black image tone is preferred from the viewpoint of ease of medical diagnosis. Currently, various hard copy systems utilizing pigments or dyes such as inkjet printers and apparatuses for electrophotography are prevailing as general image forming systems. However, there is no system which is satisfactory as a medical image-output system.

A thermal image formation system utilizing an organic silver salt is described in a large number of documents. In particular, the photothermographic material generally has an image-forming layer in which a catalytically active amount of a photocatalyst (e.g., silver halide), a reducing agent, a reducible silver salt (e.g., organic silver salt), and, if required, a toning agent for controlling the color tone of silver are dispersed in a binder matrix. The photothermographic materials are, after being imagewise exposed, heated to a high temperature (for example, to 80° C. or higher) to form black silver images through the oxidation-reduction reaction between the silver halide or the reducible silver salt (which functions as an oxidizing agent) and the reducing agent therein. The oxidation-reduction reaction is accelerated by the catalytic action of the latent image of the silver halide generated through exposure. For this reason, the black silver images are formed in the exposed areas. Fuji Medical Dry Imager FM-DP L has been distributed as a medical image formation system using a photothermographic material.

The production of a thermal image forming system using an organic silver halide involves a coating operation using a solvent or coating and drying operation of a coating liquid containing polymer particles dispersed in water as a main binder. The latter process can be conducted by a simpler manufacturing facility since recovery of the solvent or the like are unnecessary, and imposes less environmental load. Therefore, the latter process is advantageous for large-scale production. However, because the coating liquid does not have setting property, the drying air ruffles the film after application of the coating liquid, and irregular drying is likely to occur.

Use of a hydrophilic binder such as gelatin as the binder has been proposed, for example in U.S. Pat. Nos. 6,713,241 and 6,576,410. However, the resulting material has low sensitivity. Further, a lot of sensitizing means for attaining higher sensitivity have problems of increase in fogging.

In a photothermographic material, the film has to contain chemical components necessary for image formation even before image formation. Accordingly, the chemical components affect the storage stability of the photothermographic material before use. In addition, after image formation through thermal development, the chemical components remain in the film in the form of an unreacted substance or a reaction product. Accordingly, the chemical components affect the transparency of the film and the tone of the image, and adversely affect the storage stability of the image. The problems related to the storage stability are more remarkable when the image-forming layer contains a hydrophilic binder, whereby methods for improving such properties have been desired.

### SUMMARY OF THE INVENTION

The present invention has been made in consideration of the above problems of conventional techniques. According to the invention, a photothermographic material is provided which has better coated surface state, higher sensitivity and storage stability, and smaller environmental dependency at exposure and thermal development. An image forming method using the photothermographic material is also provided.

The invention provides a photothermographic material comprising a support and an image-forming layer provided on at least one side of the support. The image-forming layer includes a photosensitive silver halide, a non-photosensitive organic silver salt, a reducing agent, and a binder. At least 50% by mass of the binder is a hydrophilic binder. The non-photosensitive organic silver salt has a silver behenate content of 50% by mol or higher. The photothermographic material further comprises a compound (silver carrier) represented by the following formula (I) or (II) and a compound whose one-electron oxidized form is capable of releasing one or more electron(s):

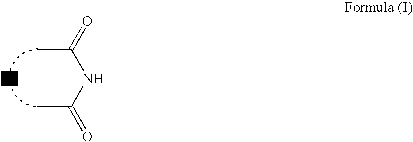

In the formula, Q represents an atomic group required for forming a five- or six-membered imide ring

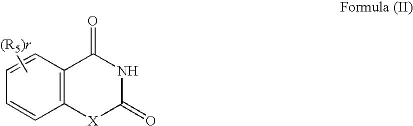

In the formula, R₅ represents a hydrogen atom, an alkyl group, a cycloalkyl group, an alkoxy group, an alkylthio group, an arylthio group, a hydroxy group, a halogen group, or N(R₈R₉). R₈ and R₉ each independently represent a hydrogen atom, an alkyl group, an aryl group, a cycloalkyl group, an alkenyl group, or a heterocyclyl group, and r represents 0, 1 or 2. R₈ and R₉ may be bonded to each other to form a substituted or unsubstituted five- to seven-membered heterocyclic ring. When there are two R₅s, they may be the same as each other or different from each other, and they may be bonded to each other to form an aromatic, heteroaromatic, alicyclic, or heterocyclic condensed ring. X represents O, S, Se, or N(R₆), and R₆ represents a hydrogen atom, an alkyl group, an aryl group, a cycloalkyl group, an alkenyl group, or a heterocyclyl group.

The invention also provides a photothermographic material comprising a support and an image-forming layer provided on at least one side of the support. The image-forming layer includes a photosensitive silver halide, a non-photosensitive organic silver salt, a reducing agent, and a binder. At least 50% by mass of the binder is a hydrophilic binder. The non-photosensitive organic silver salt has a silver behenate content of 50% by mol or higher. The photothermographic material further comprises a compound represented by the formula (I) or (II) as a silver carrier and an adsorbent redox compound having an adsorbent group and a reducing group.

The invention further provides a photothermographic material comprising a support and an image-forming layer provided on at least one side of the support. The image-forming layer includes a photosensitive silver halide, a non-photosensitive organic silver salt, a reducing agent, and a binder. At least 50% by mass of the binder is a hydrophilic binder. The non-photosensitive organic silver salt has a silver behenate content of 50% by mol or higher. The photothermographic material further comprises a compound represented by the formula (I) or (II) as a silver carrier, a compound whose one-electron oxidized form is capable of releasing one or more electron(s), and an adsorbent redox compound having an adsorbent group and a reducing group.

In the above photothermographic materials, the compound whose one-electron oxidized form is capable of releasing one or more electron(s) may be

a) a compound whose one-electron oxidized form is capable of releasing one or more electron(s) through a subsequent bond-cleavage reaction, or

b) a compound whose one-electron oxidized form is capable of releasing one or more electrons after a bond-formation reaction.

The adsorbent redox compound having an adsorbent group and a reducing group may be a compound represented by formula (G):
A-(W)ₙ—B Formula (G)

in the formula, A represents a group (hereinafter referred to as “adsorbent group”) capable of being adsorbed by the silver halide, W represents a divalent connecting group, n represents 0 or 1, and B represents a reducing group.

The photothermographic materials each may further comprise polyacrylamide or a derivative of polyacrylamide. In that case, the non-photosensitive organic silver salt particles may be formed in the presence of the polyacrylamide or derivative of polyacrylamide, and the non-photosensitive organic silver salt particles may be nano-particles. The average particle diameter of the nano-particles may be 10 nm to 1000 nm.

The reducing agent may be a compound represented by the following formula (R):

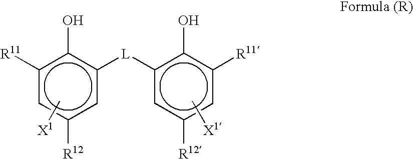

In the formula (R), R¹¹ and R^{11′} each independently represent an alkyl group, and at least one of R¹¹ and R^{11′} represents an a secondary or tertiary alkyl group; R¹² and R^{12′} each independently represent a hydrogen atom or a substituent which can be bonded to the benzene ring; L represents an —S— group or a —CHR¹³— group, and R¹³ represents a hydrogen atom or an alkyl group; X¹ and X^{1′} each independently represent a hydrogen atom or a substituent which can be bonded to the benzene ring.

The hydrophilic binder may be gelatin or a derivative of gelatin. In the image-forming layer, the mass ratio of the non-photosensitive organic silver salt to the binder may be in the range of 1.0 to 2.5. The photothermographic may have a non-photosensitive layer containing gelatin or a gelatin derivative. The non-photosensitive layer may be a surface protecting layer for the image-forming layer.

The invention further provides an image forming method using any of the above photothermographic materials. In the method, after exposure, the photothermographic material is thermally developed at a linear velocity of 23 mm/sec or higher.

The inventor conducted research on the composition of a photothermographic material which can realize superior coated surface state. As a result, the inventor has found that it is effective to use a hydrophilic binder as the binder of the image-forming layer, and to use a compound of formula (I) or (II) as a silver ion carrier from the viewpoint of the improvement of the coated surface state. However, it is also found such a constitution provides low sensitivity and has an unexpected problem of variation of photographic performance accompanying variation in environmental temperature of humidity. Conventional photothermographic material also has such a variation; however, the variation is particularly remarkable in the above constitution. Even though some antifoggants are effective for suppressing the variation, they also have disadvantages such as decrease in sensitivity. The inventor has found that a specific compound is effective for achieving higher sensitivity without deteriorating other characteristics, and that the compound unexpectedly improves the environmental dependency. In this way, the inventor has made the present invention.

### BRIEF DESCRIPTION OF THE DRAWINGS

FIG. 1 is a schematic configuration view of a thermally developing recording apparatus of the invention equipped with a laser recording device.

### DESCRIPTION OF THE INVENTION

In the following, the present invention is described in detail.

1. Photothermographic Material

The photothermographic material of the invention comprises a support and an image-forming layer provided on at least one surface of a support. The image-forming layer comprises a photosensitive silver halide, a non-photosensitive organic silver salt, a reducing agent and a binder. The image-forming layer in the invention comprises one or more layer(s) provided on the support and, optionally, comprises additional materials such as an anti-foggant, a development promoter, a coating aid and other auxiliary agents. The photothermographic material of the invention preferably comprises a non-photosensitive layer. The non-photosensitive layer in the invention may be a single layer or plural layers.

In the image-forming layer, the non-photosensitive organic silver salt has a silver behenate content of 50 mol % or higher, and 50 mass % or more of the binder is a hydrophilic binder.

Further, the image-forming layer further comprises, as a silver ion carrier, a compound having an imide group represented by the formula (I) or (II).

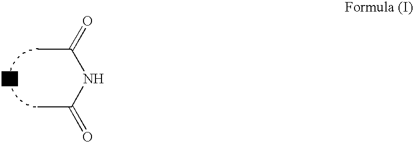

In the formula, Q represents an atomic group required for forming a five- or six-membered imide ring.

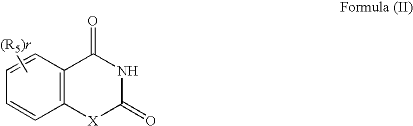

In the formula, R₅ represents a hydrogen atom, an alkyl group, a cycloalkyl group, an alkoxy group, an alkylthio group, an arylthio group, a hydroxy group, a halogen group, or N(R₈R₉). R₈ and R₉ each independently represent a hydrogen atom, an alkyl group, an aryl group, a cycloalkyl group, an alkenyl group, or a heterocyclyl group, and r represents 0, 1 or 2. R₈ and R₉ may be bonded to each other to form a substituted or unsubstituted five- to seven-membered heterocyclic ring. When there are two R₅s, they may be the same as each other or different from each other, and they may be bonded to each other to form an aromatic, heteroaromatic, alicyclic, or heterocyclic condensed ring. X represents O, S, Se, or N(R₆), and R₆ represents a hydrogen atom, an alkyl group, an aryl group, a cycloalkyl group, an alkenyl group, or a heterocyclyl group.

Further, the photothermographic material of the invention comprises a compound whose 1-electron oxidized form formed by 1-electron oxidation can release one electron or more electrons, and an adsorbent redox compound having an adsorbent group and a reducing group.

The compound whose one-electron oxidized form formed by electron oxidation can release one electron or more electrons is, preferably, a compound of the following first group or second group.

(First Group)

A compound whose one-electron oxidized form formed by electron oxidation can release one electron or more electrons through a succeeding bond-cleavage reaction.

(Second Group)

A compound whose one-electron oxidized form formed by electron oxidation can release one electron or more electrons after a succeeding bond-forming reaction.

The adsorbent redox compound having an adsorbent group and a reducing group is preferably a compound represented by the following formula (G)
A-(W)n-B Formula (G)

In the formula, A represents a group that can be adsorbed by the silver halide (hereinafter referred to as an adsorbent group), W represents a divalent connecting group, n represents 0 or 1, and B represents a reducing group.

The photothermographic material of the invention preferably further comprises polyacrylamide or a derivative of polyacrylamide. In a preferable embodiment, the non-photosensitive organic silver salt particles are formed in the presence of polyacrylamide or the derivative of polyacrylamide. In a more preferable embodiment, the non-photosensitive organic silver salt particles are nano particles.

In the invention, the reducing agent is preferably a compound represented by the formula (R). In the invention, the hydrophilic binder in the image-forming layer is preferably gelatin or a gelatin derivative. The ratio by mass of the binder to the non-photosensitive organic silver salt is preferably in the range of 1.0 to 2.5.

In the image forming method, the photothermographic material of the invention is used, and the photothermographic material is thermally developed at a linear velocity of 23 mm/sec or higher to form an image.

Organic Silver Salt

1) Composition

The non-photosensitive organic silver salt used in the invention is an organic silver salt which is relatively stable to light and which supplies a silver ion when heated to 80° C. or higher under the presence of the exposed photosensitive silver halide and the reducing agent, to form a silver image. The organic silver salt may be any organic substance that can be reduced by the reducing agent to provide a silver ion. Such non-photosensitive organic silver salts are described, for example, in JP-A No. 10-62899, Paragraph 0048 to 0049, EP-A No. 0803764A1, Page 18, Line 24 to Page 19, Line 37, EP-A No. 0962812A1, JP-A Nos. 11-349591, 2000-7683, and 2000-72711, the disclosures of which are incorporated herein by reference. The organic silver salt is preferably a silver salt of an organic acid, more preferably a silver salt of a long-chain aliphatic carboxylic acid having 10 to 30 carbon atoms, still more preferably a silver salt of a long-chain aliphatic carboxylic acid having 15 to 28 carbon atoms. Examples of the fatty acid silver salts include silver lignocerate, silver behenate, silver arachidate, silver stearate, silver oleate, silver laurate, silver caproate, silver myristate, silver palmitate, silver erucate, and mixtures thereof. In the invention, the proportion of the amount of silver behenate to the total amount of the organic silver salt is preferably 50 to 100 mol %, more preferably 85 to 100 mol %, still more preferably 95 to 100 mol %. Further, the ratio of the amount of silver erucate to the total amount of the organic silver salts is preferably 2 mol % or less, more preferably 1 mol % or less, further preferably 0.1 mol % or less.

Further, the ratio of the amount of silver stearate to the total amount of the organic silver salts is preferably I mol % or lower so as to obtain a phototherimographic material with a low Dmin, high sensitivity, and excellent image storability. The ratio of the amount of silver stearate to the total amount of the organic silver salts is more preferably 0.5 mol % or lower. In a preferable embodiment, the organic silver salts include substantially no silver stearate.

When the organic silver salts include silver arachidate, the ratio of the amount of silver arachidate to the total amount of the organic silver salts is preferably 6 mol % or lower from the viewpoint of achieving a low Dmin and excellent image storability. The ratio of the amount of silver arachidate to the total amount of the organic silver salts is more preferably 3 mol % or lower.

2) Shape

The organic silver salt in the invention is preferably nano-particles. The average particle diameter of the organic silver salt particles is preferably 10 nm to 1,000 nm, more preferably 30 nm to 400 nm.

When the average particle diameter is smaller than the above range, there may be problems of increase in fogging, increase in fogging during storage of an unused photothermographic material, and enhanced fogging during storage of an image after image formation.

When the average particle diameter is larger than the above range, there may be problems of deterioration of the haze of the coated layer, longer development time, and sedimentation of the solid during long-term storage of the organic silver salt dispersion. Accordingly, the average particle diameter is preferably within the above range.

The shape of the grains of the organic silver-salt is not particularly restricted. The organic silver salt grains may be in a needle shape, a rod shape, a tabular shape, or a flaky shape.

In the invention, the organic silver salt grains are preferably in a flaky shape. It is also preferable to use organic silver salt grains in a short needle-shape, a rectangular shape, a cubic shape, or a potato-like shape, wherein each shape has a ratio of the longer axis to the shorter axis of lower than 5. Such organic silver salt grains cause less fogging which develops on the resultant photothermographic material in the heat development than long needle-shaped grains having a length ratio of the longer axis to the shorter axis of 5 or higher. The ratio of the longer axis to the shorter axis is more preferably 3 or lower, since the mechanical stability of the coating film is improved when organic silver salt grains having such a shape are used. In the invention, organic silver salt grains in a flaky shape are defined as follows. Organic silver salt grains are observed by an electron microscope, and the shape of each grain is approximated by a rectangular parallelepiped shape. The lengths of the three sides of the rectangular parallelepiped shape are respectively represented by a, b, and c in the ascending order (wherein c and b may be the same values), and a value x is calculated from the smaller values a and b using the following equation: x=b/a. The values x of approximately 200 grains are calculated in the above-described manner to obtain an average x (the average of the values x). The organic silver salt grains in a flaky shape are defined as grains with an average x of 1.5 or larger. The average x is preferably 1.5 to 30, more preferably 1.5 to 15. In contrast, the organic silver salt grains in a needle-shape are defined as grains with an average x of 1 or larger but smaller than 1.5.

In the flaky grains (grains in a flaky shape), the length a may be considered as the thickness of a tabular grain having a main plane defined by the sides with the lengths b and c. The average of the lengths a of the grains is preferably 1 nm to 300 nm, more preferably 5 nm to 100 nm. The average of values c/b of the grains is preferably 1 to 9, more preferably 1 to 6, furthermore preferably 1 to 4, most preferably 1 to 3.

In the invention, the equivalent sphere diameter is measured by: directly photographing a sample using an electron microscope, and then image-processing the negative.

The aspect ratio of the flaky grain is defined as the value of the equivalent sphere diameter/a. The aspect ratio of the flaky grain is preferably 1.1 to 30, more preferably 1.1 to 15, so as to prevent the aggregation of the grains in the photosensitive material, thereby improving the image storability.

The grain size distribution of the organic silver salt grains is preferably monodisperse distribution. In the monodisperse distribution, the percentage obtained by dividing the standard deviation of the length of the longer axis by the length of the longer axis and the percentage obtained by dividing the standard deviation of the length of the shorter axis by the length of the shorter axis are preferably 100% or lower, more preferably 80% or less, further preferably 50%.or less. In order to observe the shape of the organic silver salt grain, a transmission electron microscope may be used to give a micrograph of the organic silver salt dispersion. Alternatively, the monodisperse distribution may be evaluated based on the standard deviation of the volume-weighted average diameter of the organic silver salt grains, and the percentage (the variation coefficient) obtained by dividing the standard deviation by the volume-weighted average diameter is preferably 100% or lower, more preferably 80% or lower, further preferably 50% or lower. For example, the grain size (the volume-weighted average diameter) may be measured by: dispersing the organic silver salt grains in a liquid, and exposing the dispersion to a laser light and obtaining the autocorrelation function of fluctuation of the scattering light to time.

3) Preparation

The organic silver salt grains may be prepared and dispersed by known methods described, for example, in JP-A No. 10-62899, EP-A Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868, the disclosures of which are incorporated herein by reference.

The organic acid silver salt used in the invention is preferably prepared under the presence of a compound represented by formulae (W1) or (W2).

The compound may be added upon preparation of the organic silver salt or during dispersing operation.
R-L-S-T Formula (W1)

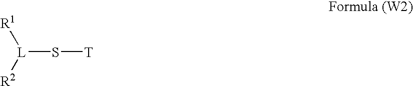

R represents a hydrophobic group. At least one of R₁ and R₂ is a hydrophobic group. L is a connecting group. T is an oligomer moiety, and L (connecting group) and T (oligomer moiety) are bonded by a thio bond (—S). L in the formula (W1) may be omitted.

The number of the hydrophobic groups is determined by the connecting group L. The hydrophobic group is selected from a saturated or unsaturated alkyl group, an arylalkyl group, and an alkylaryl group, in which each alkyl moiety may be linear or branched. R, R₁, and R₂ each have a carbon number of preferably 8 to 21. Typical examples of the connecting group of the compound represented by the formula (W1) are indicated in the italic form in the following formulae:

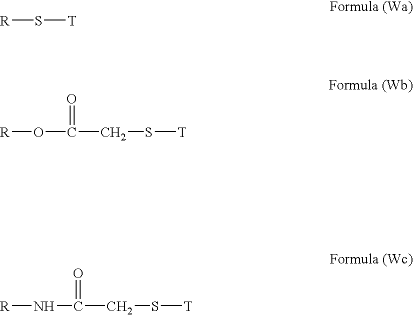

Typical examples of the connecting group of the compound represented by the formula (W2) are indicated in the italic form in the following formulae:

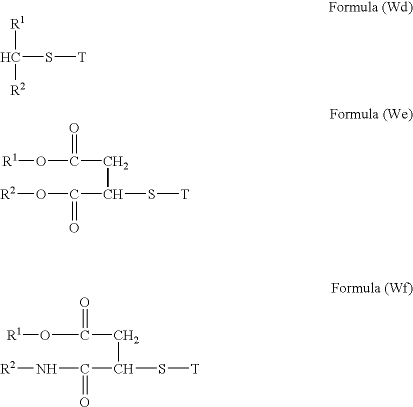

The oligomer group T is based on an oligomer of a vinyl monomer having an amide group, and the vinyl moiety is used for oligomerization. After formation of the oligomer, the amide moiety forms a non-ionic polar group which is a hydrophilic functional group. The oligomer group T may be an oligomer of a single monomer, or may be a copolymerization oligomer containing plural monomers.

Typical examples of the monomer used for forming the oligomer chain T include acrylamide, methacylamide, an acryl amide derivative, a methacrylamide derivative, and 2-vinylpyrrolidone.

These monomers can be represented by the following two formulae:

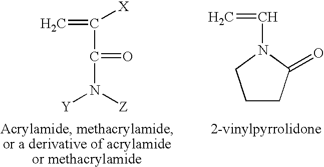

X represents a hydrogen atom or an alkyl group having 1 to 10 carbon atoms, preferably a hydrogen atom or a methyl group. Y and Z each represent a hydrogen atom, an alkyl group having 1 to 10 carbon atoms, or a substituted alkyl group having 1 to 10 carbon atoms. Y and Z each preferably represent a hydrogen atom, a methyl group, an ethyl group, or —C(CH₂OH)₃. X and Y may be the same as or different from each other.

The number of the repeating units in the oligomer group T is 20 or fewer, preferably 5 to 15.

Specific examples of compounds represented by formula (W1) and (W2) usable in the invention are shown below. However, compounds represented by formula (W1) and (W2) usable in the invention are not limited to the specific examples.

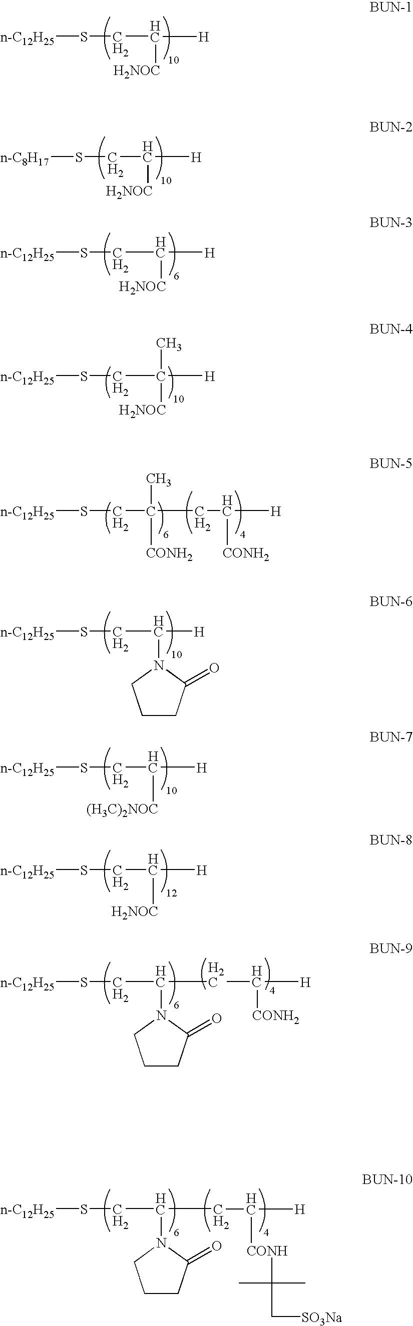

The oligomer surfactant whose main component is the vinyl polymer having an amide functional group described above can be prepared by a method known in the relevant technical field, or by a simple modification of a known method. An illustrative preparation example is shown below. An aqueous dispersion of nano-particles of the silver carboxylate can be formed by a medium grinding method comprising:

(A) preparing silver carboxylate dispersion containing silver carboxylate, water as a carrier for the carboxylate and the surface modifying agent described above;

(B) mixing the silver carboxylate dispersion with a hard grinding medium having an average grain size of less than 500 μm;

(C) charging the obtained mixture in a high speed mill;

(D) grinding the mixture till the grain size distribution of the carboxylate becomes such a distribution that 90 mass % of the carboxylate particles have grain sizes of less than 1 μm; and

(E) separating the grinding medium from the mixture ground in (D).

When the organic silver salt grains are dispersed in the presence of a photosensitive silver salt, the fogging is intensified and the sensitivity is remarkably reduced. Thus, in a preferable embodiment, substantially no photosensitive silver salts are present when the organic silver salt grains are dispersed. In the invention, the amount of photosensitive silver salts in the aqueous dispersion liquid of the organic silver salt is preferably 1 mol % or less, more preferably 0.1 mol % or less, per 1 mol of the organic silver salt. It is more preferable not to add photosensitive silver salts to the dispersion liquid actively.

In an embodiment, the photosensitive material is prepared by processes comprising mixing an aqueous organic silver salt dispersion liquid with an aqueous photosensitive silver salt dispersion liquid. The mixing ratio between the organic silver salt and the photosensitive silver salt may be selected depending on the use of the photosensitive material. The mole ratio of photosensitive silver salt to organic silver salt is preferably 1 mol % to 30 mol %, more preferably 2 to 20 mol %, particularly preferably 3 to 15 mol %. It is preferable to mix two or more aqueous organic silver salt dispersion liquids and two or more aqueous photosensitive silver salt dispersion liquids so as to adjust the photographic properties.

4) Amount

The amount of the organic silver salt may be selected without particular restrictions, and the total amount of the applied silver (including the photosensitive silver halide) is preferably 0.1 g/m² to 5.0 g/m², more preferably 0.3 g/m² to 3.0 g/m², furthermore preferably 0.5 g/m² to 2.0 g/m². In order to improve the image storability, the total amount of the applied silver is preferably 1.8 g/m² or less, more preferably 1.6 g/m² or less. In the invention, when a reducing agent preferred in the invention is used, sufficient image density can be achieved even with such a small amount of silver.

Reducing Agent

The photothermographic material of the invention includes a heat developing agent which is a reducing agent for the organic silver salt. The reducing agent is preferably a so-called hindered phenol reducing agent having a substituent at an ortho position relative to the phenolic hydroxyl group, or a bisphenol reducing agent, particularly preferably a compound represented by the following formula (R).

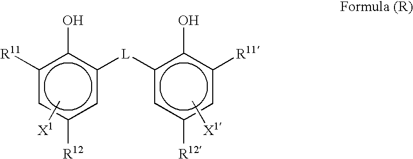

In the formula (R), R¹¹ and R^{11′} each independently represent an alkyl group, and at least one of R¹¹ and R^{11′} represents a secondary or tertiary alkyl group; R¹² and R^{12′} each independently represent a hydrogen atom or a substituent which can be bonded to the benzene ring; L represents an —S— group or a —CHR¹³— group, and R¹³ represents a hydrogen atom or an alkyl group; X¹ and X^{1′} each independently represent a hydrogen atom or a substituent which can be bonded to the benzene ring.

The formula (R) is described in detail below. In the following, the scope of the term “an alkyl group” encompasses “a cycloalkyl group” unless mentioned otherwise.

1) R¹¹ and R^{11′}

R¹¹ and R^{11′} each independently represent a substituted or unsubstituted alkyl group having 1 to 20 carbon atoms. At least one of R¹¹ and R^{11′} represents a secondary or tertiary alkyl group. There are no particular restrictions on the substituents on the alkyl group. Examples of preferred substituents on the alkyl group include aryl groups, a hydroxy group, alkoxy groups, aryloxy groups, alkylthio groups, arylthio groups, acylamino groups, sulfonamide groups, sulfonyl groups, phosphoryl groups, acyl groups, carbamoyl groups, ester groups, ureido groups, urethane groups, and halogen atoms.

2) R¹² and R^{12′} and X¹ and X^{1′}

R¹² and R^{12′} each independently represent a hydrogen atom or a substituent which can be bonded to the benzene ring. Also X¹ and X^{1′} each independently represent a hydrogen atom or a substituent which can be bonded to the benzene ring. Examples of preferable substituents which can be bonded to the benzene ring include alkyl groups, aryl groups, halogen atoms, alkoxy groups, and acylamino groups.

3) L

L represents an —S— group or a —CHR¹³— group. R¹³ represents a hydrogen atom or an alkyl group having 1 to 20 carbon atoms, and the alkyl group may have a substituent. When R¹³ represents an unsubstituted alkyl group, examples thereof include a methyl group, an ethyl group, a propyl group, a butyl group, a heptyl group, an undecyl group, an isopropyl group, a 1-ethylpentyl group, a 2,4,4-trimethylpentyl group, a cyclohexyl group, a 2,4-dimethyl-3-cyclohexenyl group, and a 2,4-dimethyl-3-cyclohexenyl group. Examples of the substituent on the alkyl group represented by R¹³ include the substituents described above as examples of the substituents on R¹¹ or R^{11′}. The substituent on the alkyl group may be a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, or a sulfamoyl group.

4) Preferred Substituents

R¹¹ and R^{11′} are each preferably a secondary or tertiary alkyl group having 1 to 15 carbon atom. Specific examples of such an alkyl group include an isopropyl group, a t-butyl group, a t-octyl group, a cyclohexyl group, a cyclopentyl group, a 1-methyl cyclohexyl group, and a 1-methylcyclopropyl group. R¹¹ and R^{11′} each are more preferably a t-butyl group, a t-amyl group, or a 1-methylcyclohexyl group, most preferably a t-butyl group.

R¹² and R^{12′} are each preferably an alkyl group having 1 to 20 carbon atoms, and specific examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group. R¹² and R^{12′} are each more preferably a methyl group, an ethyl group, a propyl group, an isopropyl group, or a t-butyl group, particularly preferably a methyl group or an ethyl group.

X¹ and X^{1′} are each preferably a hydrogen atom, a halogen atom, or an alkyl group, more preferably a hydrogen atom.

L is preferably a —CHR¹³— group.

R¹³ is preferably a hydrogen atom or an alkyl group having 1 to 15 carbon atoms. The alkyl group may be a linear alkyl group or a cyclic alkyl group, and may have a C═C bond. The alkyl group is preferably a methyl group, an ethyl group, a propyl group, an isopropyl group, a 2,4,4-trimethylpentyl group, a cyclohexyl group, a 2,4-dimethyl-3-cyclohexenyl group, or a 3,5-dimethyl-3-cyclohexenyl group. R¹³ is particularly preferably a hydrogen atom, a methyl group, an ethyl group, a propyl group, an isopropyl group, or a 2,4-dimethyl-3-cyclohexenyl group.

When R¹¹ and R^{11′} are tertiary alkyl groups and R¹² and R^{12′} are methyl groups, R¹³ is preferably a primary or secondary alkyl group having 1 to 8 carbon atoms such as a methyl group, an ethyl group, a propyl group, an isopropyl group, or a 2,4-dimethyl-3-cyclohexenyl group.

When R¹¹ and R^{11′} are tertiary alkyl groups and R¹² and R^{12′} are alkyl groups other than methyl, R¹³ is preferably a hydrogen atom.

When none of R¹¹ and R^{11′} is a tertiary alkyl group, R¹³ is preferably a hydrogen atom or a secondary alkyl group, particularly preferably a secondary alkyl group. The secondary alkyl group is preferably an isopropyl group or a 2,4-dimethyl-3-cyclohexenyl group.

The combination of R¹¹, R^{11′}, R¹², R^{12′} and R¹³ affects the heat developability of the resultant photothermographic material, the tone of the developed silver, and the like. It is preferable to use a combination of two or more reducing agents depending on the purpose since such properties can be adjusted by the combination of the reducing agents.

Examples of the reducing agent used in the invention, such as the compound represented by formula (R), are shown below. However, reducing agents usable in the invention are not limited to the examples.

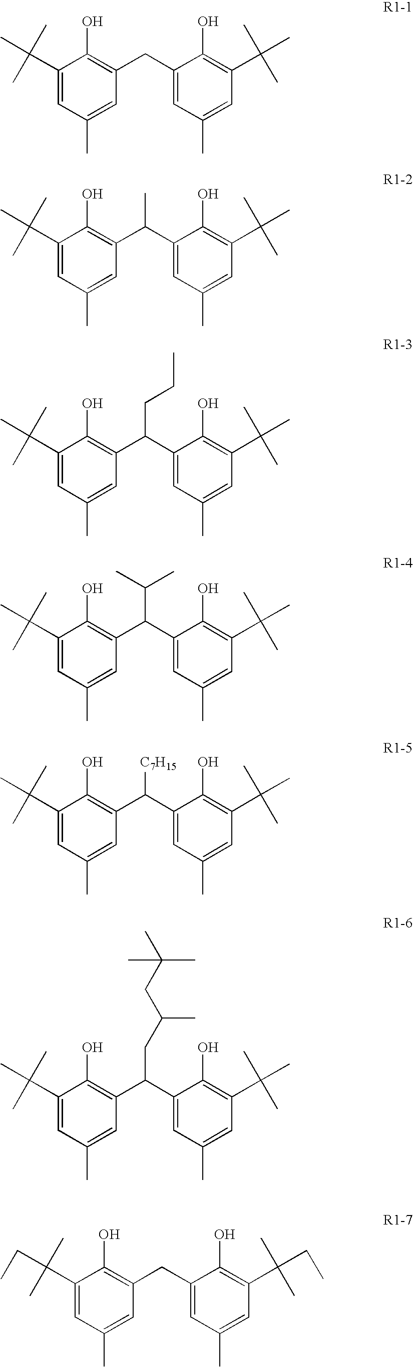

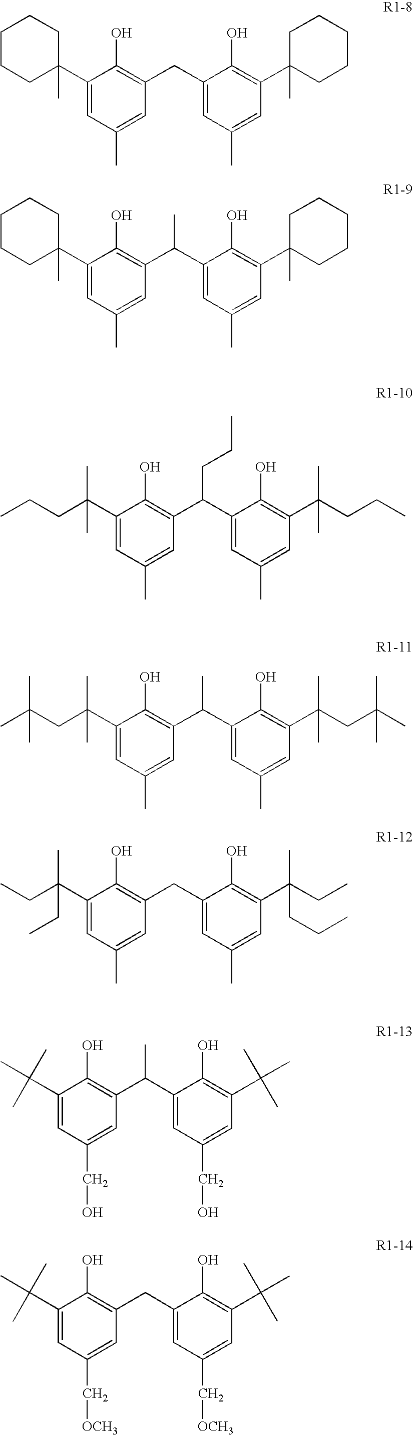

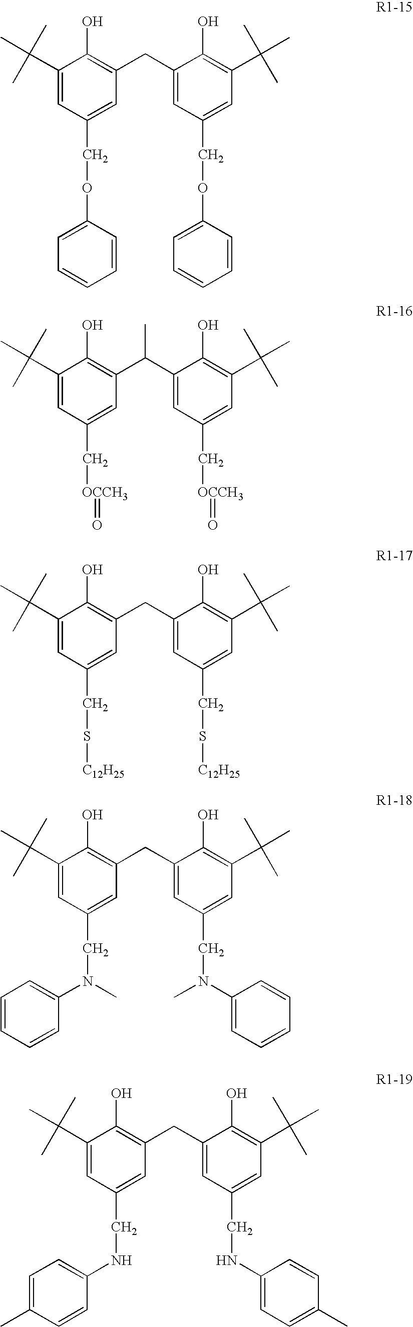

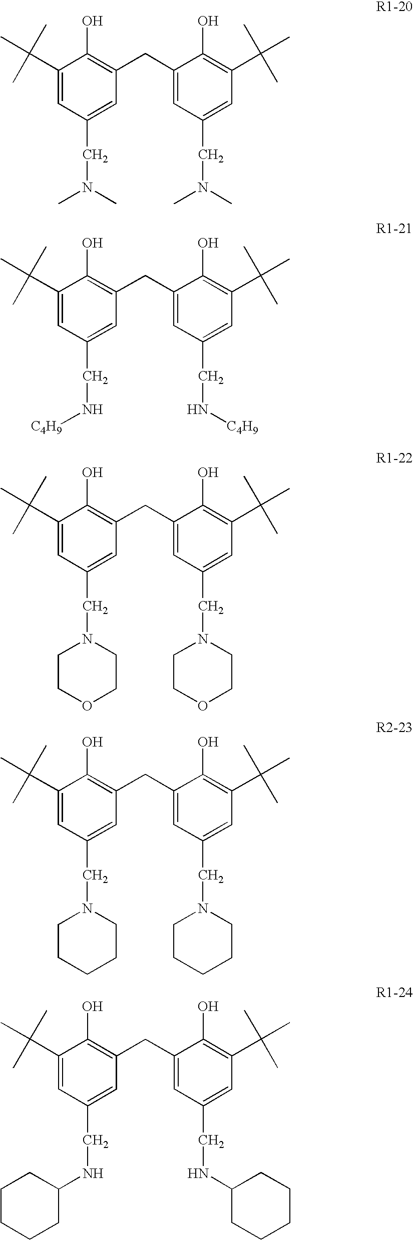

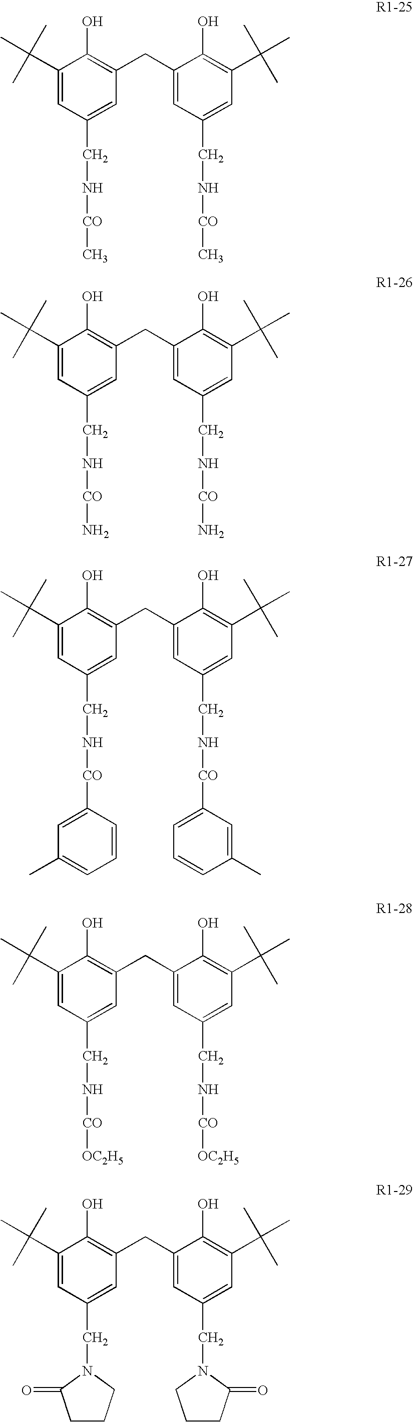

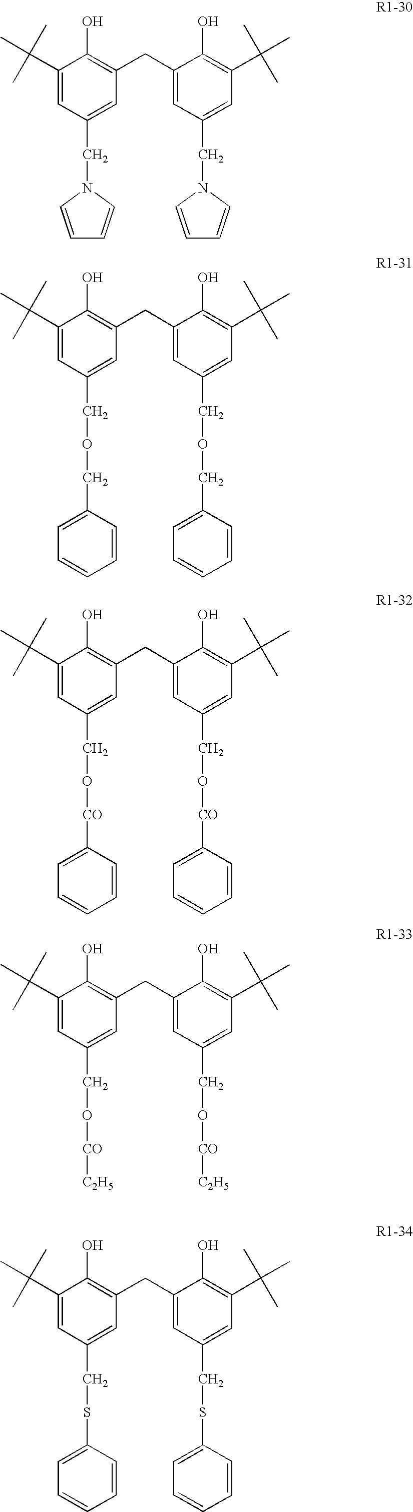

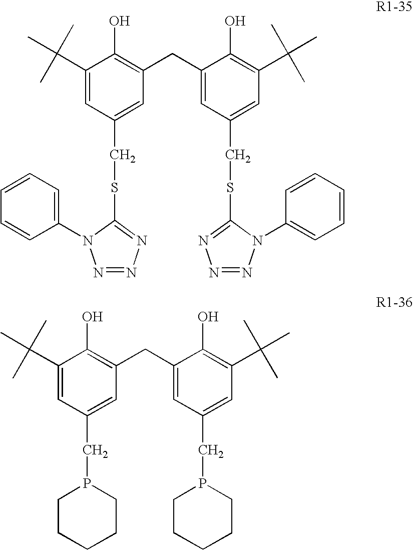

In addition, preferable reducing agents are also disclosed in JP-A Nos. 2001-188314, 2001-209145, 2001-350235, and 2002-156727, and EP-A 1278101A2, the disclosures of which are incorporated herein by reference.

The amount of the reducing agent in the photothermographic material is preferably 0.1 to 3.0 g/m², more preferably 0.2 to 2.0 g/m², furthermore preferably 0.3 to 1.0 g/m². Further, the mole ratio of reducing agent to silver on the image-forming layer side is preferably 5 to 50 mol %, more preferably 8 to 30 mol %, further preferably 10 to 20 mol %.

The reducing agent may be added to any layer on the image-forming layer side, preferably to the image-forming layer.

The state of the reducing agent in the coating liquid may be any state such as a solution, an emulsion, a solid particle dispersion.

The emulsion of the reducing agent may be prepared by a well-known emulsifying method. The exemplary method comprises: dissolving the reducing agent in an oil such as dibutyl phthalate, tricresyl phosphate, dioctyl sebacate, or tri(2-ethylhexyl)phosphate, optionally using a cosolvent such as ethyl acetate or cyclohexanone; and then mechanically emulsifying the reducing agent in the presence of a surfactant such as sodium dodecylbenzene sulfonate, sodium oleoyl-N-methyltaurinate, or sodium di(2-ethylhexyl)sulfosuccinate. In this method, it is preferable to add a polymer such as α-methylstyrene oligomer or poly(t-butylacrylamide) to the emulsion in order to control the viscosity and the refractive index of the oil droplets.

In an embodiment, the solid particle dispersion is prepared by a method comprising dispersing powder of the reducing agent in an appropriate solvent such as water using a ball mill, a colloid mill, a vibration ball mill, a sand mill, a jet mill, a roll mill, or ultrasonic wave. A protective colloid (e.g. a polyvinyl alcohol) and/or a surfactant such as an anionic surfactant (e.g. a mixture of sodium triisopropylnaphthalenesulfonates each having a different combination of the substitution positions of the three isopropyl groups) may be used in the preparation. Beads of zirconia, etc. are commonly used as a dispersing medium in the above mills, and in some cases Zr, etc. is eluted from the beads and mixed with the dispersion. The amount of the eluted and mixed component depends on the dispersion conditions, and is generally within the range of 1 to 1,000 ppm. The eluted zirconia does not cause practical problems as long as the amount of Zr in the photothermographic material is 0.5 mg or smaller per 1 g of silver.

In a preferable embodiment, the aqueous dispersion includes an antiseptic agent such as a benzoisothiazolinone sodium salt.

The reducing agent is particularly preferably used in the state of a solid particle dispersion. The reducing agent is preferably added in the form of fine particles having an average particle diameter of 0.01 to 10 μm, more preferably 0.05 to 5 μm, further preferably 0.1 to 2 μm. In the invention, the particle diameters of particles in other solid dispersions are preferably in the above range.

(Development Accelerator)

The photothermographic material of the invention preferably includes a development accelerator, and preferred examples thereof include sulfonamidephenol compounds such as sulfonamidephenol compounds represented by the formula (A) described in JP-A Nos. 2000-267222 and 2000-330234; hindered phenol compounds such as hindered phenol compounds represented by the formula (II) described in JP-A No. 2001-92075; hydrazine compounds such as hydrazine compounds represented by the formula (I) described in JP-A Nos. 10-62895 and 11-15116; hydrazine compounds represented by the formula (D) described in JP-A No. 2002-156727; hydrazine compounds represented by the formula (1) described in JP-A No. 2002-278017; phenol compounds and naphthol compounds such as phenol compounds and naphthol compounds represented by the formula (2) described in JP-A No. 2001-264929; phenol compounds described in JP-A Nos. 2002-311533 and 2002-341484; and naphthol compounds described in JP-A No. 2003-66558. The disclosures of the above patent documents are incorporated herein by reference. Naphthol compounds described in JP-A No. 2003-66558 are preferable.

The mol ratio of development accelerator to reducing agent may be 0.1 to 20 mol %, preferably 0.5 to 10 mol %, more preferably 1 to 5 mol %.

The development accelerator may be added to the photothermographic material in any of the manners described above as examples of the method of adding the reducing agent. The development accelerator is particularly preferably added in the form of a solid dispersion or an emulsion. The emulsion of the development accelerator is preferably a dispersion prepared by emulsifying the development accelerator in a mixture of a high-boiling-point solvent that is solid at ordinary temperature and a low-boiling-point cosolvent, or a so-called oilless emulsion which includes no high-boiling-point solvents.

In the invention, the hydrazine compounds described in JP-A Nos. 2002-156727 and 2002-278017, and the naphthol compounds described in JP-A No. 2003-66558 are more preferable development accelerators.

In the invention, the development accelerator is particularly preferably a compound represented by the following formula (A-1) or (A-2).
Q1-NHNH-Q2 Formula (A-1)

In the formula (A-1), Q1 represents an aromatic group or a heterocyclic group each of which has a carbon atom bonded to the —NHNH-Q2 group. Q2 represents a carbamoyl group, an acyl group, an alkoxycarbonyl group, an aryloxycarbonyl group, a sulfonyl group, or a sulfamoyl group.

In the formula (A-1), the aromatic group or the heterocyclic group represented by Q1 preferably has a 5- to 7-membered unsaturated ring. Examples of the 5- to 7-membered unsaturated ring include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isoxazole ring, a thiophene ring, and condensed rings thereof.

The ring may have a substituent. When the ring has two or more substituents, they may be the same as each other or different from each other. Examples of the substituents include halogen atoms, alkyl groups, aryl groups, carbonamide groups, alkylsulfonamide groups, arylsulfonamide groups, alkoxy groups, aryloxy groups, alkylthio groups, arylthio groups, carbamoyl groups, sulfamoyl groups, a cyano group, alkylsulfonyl groups, arylsulfonyl groups, alkoxycarbonyl groups, aryloxycarbonyl groups, and acyl groups. These substituents may further have substituents, and preferred examples thereof include halogen atoms, alkyl groups, aryl groups, carbonamide groups, alkylsulfonamide groups, arylsulfonamide groups, alkoxy groups, aryloxy groups, alkylthio groups, arylthio groups, acyl groups, alkoxycarbonyl groups, aryloxycarbonyl groups, carbamoyl groups, a cyano group, sulfamoyl groups, alkylsulfonyl groups, arylsulfonyl groups, and acyloxy groups.

When Q2 represents a carbamoyl group, the carbamoyl group preferably has 1 to 50 carbon atoms, and more preferably has 6 to 40 carbon atoms. Examples of the carbamoyl group include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphtylcarbamoyl, N-3-pyridylcarbamoyl, and N-benzylcarbamoyl.

When Q2 represents an acyl group, the acyl group preferably has 1 to 50 carbon atoms, and more preferably has 6 to 40 carbon atoms. Examples of the acyl group include formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl.

When Q2 represents an alkoxycarbonyl group, the alkoxycarbonyl group preferably has 2 to 50 carbon atoms, and more preferably has 6 to 40 carbon atoms. Examples of the alkoxycarbonyl group include methoxycarbonyl, ethoxycarbonyl, isobutyloxycarbonyl, cyclohexyloxycarbonyl, dodecyloxycarbonyl, and benzyloxycarbonyl.

When Q2 represents an aryloxycarbonyl group, the aryloxycarbonyl group preferably has 7 to 50 carbon atoms, and more preferably has 7 to 40 carbon atoms. Examples of the aryloxycarbonyl group include phenoxycarbonyl, 4-octyloxyphenoxycarbonyl, 2-hydroxymethylphenoxycarbonyl, and 4-dodecyloxyphenoxycarbonyl.

When Q2 represents a sulfonyl group, the sulfonyl group preferably has 1 to 50 carbon atoms, and more preferably has 6 to 40 carbon atoms. Examples of the sulfonyl groups include methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

When Q2 represents a sulfamoyl group, the sulfamoyl group preferably has 0 to 50 carbon atoms, and more preferably has 6 to 40 carbon atoms. Examples of the sulfamoyl group include unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl.

The group represented by Q2 may have a substituent selected from the groups described above as examples of the substituent on the 5- to 7-membered unsaturated ring of Q1. When the group represented by Q2 has two or more substituents, the substituents may be the same as each other or different from each other.

Next, preferable range of the compound represented by formula (A-1) is described. The group represented by Q1 preferably has a 5- or 6-membered unsaturated ring, and more preferably has a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isoxazole ring, or a condensed ring in which any of the above rings is fused with a benzene ring or with an unsaturated heterocycle. Q2 represents preferably a carbamoyl group, particularly preferably a carbamoyl group having a hydrogen atom on the nitrogen atom.

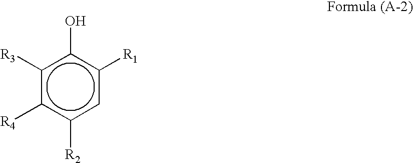

In the formula (A-2), R₁ represents an alkyl group, an acyl group, an acylamino group, a sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group, or a carbonic acid ester group. R₃ and R₄ each independently represent a substituent which can be bonded to the benzene ring, which may be selected from the substituents described above in the explanation on the formula (A-1). R₃ and R₄ may combine to form a condensed ring.

R₁ represents preferably: an alkyl group having 1 to 20 carbon atoms such as a methyl group, an ethyl group, an isopropyl group, a butyl group, a tert-octyl group, or a cyclohexyl group; an acylamino group such as an acetylamino group, a benzoylamino group, a methylureido group, or a 4-cyanophenylureido group; or a carbamoyl group such as an n-butylcarbamoyl group, an N,N-diethylcarbamoyl group, a phenylcarbamoyl group, a 2-chlorophenylcarbamoyl group, or a 2,4-dichlorophenylcarbamoyl group. R₁ represents more preferably an acylamino group, which may be an ureido group or a urethane group. R₂ represents preferably: a halogen atom (more preferably a chlorine atom or a bromine atom); an alkoxy group such as a methoxy group, a butoxy group, an n-hexyloxy group, an n-decyloxy group, a cyclohexyloxy group, or a benzyloxy group; or an aryloxy group such as a phenoxy group or a naphthoxy group.

R₃ represents preferably a hydrogen atom, a halogen atom, or an alkyl group having 1 to 20 carbon atoms, most preferably a halogen atom. R₄ represents preferably a hydrogen atom, an alkyl group, or an acylamino group, more preferably an alkyl group or an acylamino group. Preferred examples of the group represented by R₃ or R₄ are equal to the above-described examples of the group represented by R₁. When R₄ represents an acylamino group, R₄ and R₃ may be bound to each other to form a carbostyryl ring.

When R₃ and R₄ combine with each other to form a condensed ring in the formula (A-2), the condensed ring is particularly preferably a naphthalene ring. The naphthalene ring may have a substituent selected from the above-described examples of the substituents on the ring of Q1 in the formula (A-1). When the compound represented by the formula (A-2) is a naphthol-based compound, R₁ represents preferably a carbamoyl group, particularly preferably a benzoyl group. R₂ represents preferably an alkoxy group or an aryloxy group, particularly preferably an alkoxy group.

Preferable examples of the development accelerator are illustrated below without intention of restricting the scope of the present invention. 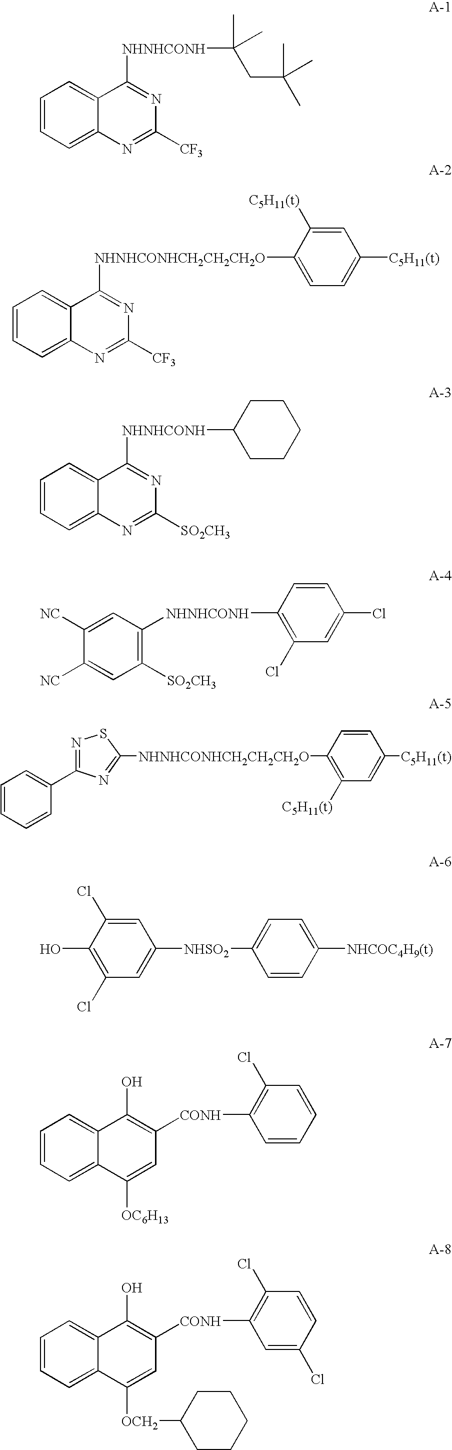 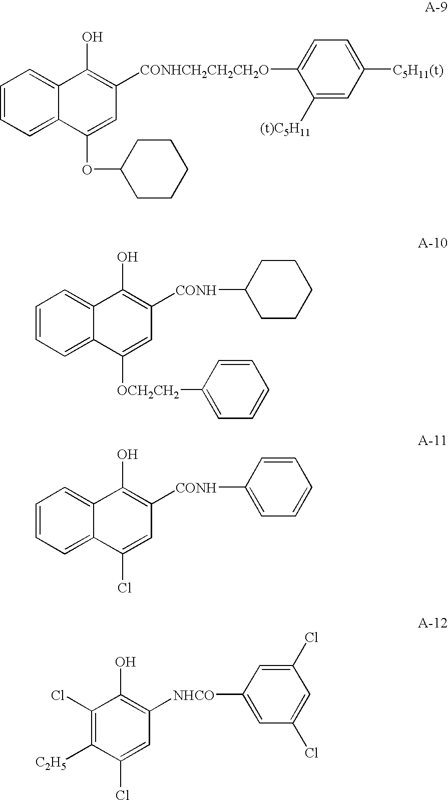
(Hydrogen-Bonding Compound)

When the reducing agent has an aromatic hydroxyl group (—OH) or amino group (—NHR, in which R represents a hydrogen atom or an alkyl group), particularly when the reducing agent is the above-mentioned bisphenol compound, it is preferable to use a non-reducing, hydrogen-bonding compound having a group capable of forming a hydrogen bond with the hydroxyl or amino group.

Examples of the group capable of forming a hydrogen bond with the hydroxyl or amino group include phosphoryl groups, sulfoxide groups, sulfonyl groups, carbonyl groups, amide groups, ester groups, urethane groups, ureido groups, tertiary amino groups, and nitrogen-including aromatic groups. The group capable of forming a hydrogen bond with the hydroxyl or amino group is preferably a phosphoryl group; a sulfoxide group; an amide group having no >N—H groups, but the nitrogen atom being blocked as >N—Ra (in which Ra represents a substituent other than H); an urethane group having no >N—H groups, the nitrogen atom being blocked as >N—Ra (in which Ra represents a substituent other than H); and an ureido group having no >N—H group, but the nitrogen atom being blocked as >N—Ra (in which Ra represents a substituent other than H).

The hydrogen-bonding compound used in the invention is particularly preferably a compound represented by the following formula (D):

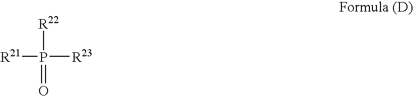

In the formula (D), R²¹ to R²³ each independently represent an alkyl group, an aryl group, an alkoxy group, an aryloxy group, an amino group, or a heterocyclic group. These groups each may be unsubstituted or substituted.

When any of R²¹ to R²³ has a substituent, examples of the substituent include halogen atoms, alkyl groups, aryl groups, alkoxy groups, amino groups, acyl groups, acylamino groups, alkylthio groups, arylthio groups, sulfonamide groups, acyloxy groups, oxycarbonyl groups, carbamoyl groups, sulfamoyl groups, sulfonyl groups, and phosphoryl groups. Preferred substituents are alkyl groups and aryl groups, and specific examples thereof include a methyl group, an ethyl group, an isopropyl group, a t-butyl group, a t-octyl group, a phenyl group, 4-alkoxyphenyl groups, and 4-acyloxyphenyl groups.

When any of R²¹ to R²³ represents an alkyl group, examples thereof include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group.

When any of R²¹ to R²³ represents an aryl group, examples thereof include a phenyl group, a cresyl group, a xylyl group, a naphtyl group, a 4-t-butylphenyl group, a 4-t-octylphenyl group, a 4-anisidyl group, and a 3,5-dichlorophenyl group.

When any of R²¹ to R²³ represents an alkoxy group, examples thereof include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group.

When any of R²¹ to R²³ represents an aryloxy group, examples thereof include a phenoxy group, a cresyloxy group, an isopropylphenoxy group, a 4-t-butylphenoxy group, a naphthoxy group, and a biphenyloxy group.

When any of R²¹ to R²³ represents an amino group, examples thereof include a dimethylamino group, a diethylamino group, a dibutylamino group, a dioctylamino group, an N-methyl-N-hexylamino group, a dicyclohexylamino group, a diphenylamino group, and an N-methyl-N-phenylamino group.

R²¹ to R²³ are each preferably an alkyl group, an aryl group, an alkoxy group, or an aryloxy group. In order to obtain the effects of the invention, in a preferable embodiment, at least one of R²¹ to R²³ represents an alkyl group or an aryl group. In a more preferable embodiment, two or more of R²¹ to R²³ represent groups selected from alkyl groups and aryl groups. Further, it is preferable to use a compound represented by the formula (D) in which R²¹ to R²³ represent the same groups, from the viewpoint of reducing the cost.

Specific examples of the hydrogen-bonding compound (such as a compound represented by the formula (D)) are illustrated below without intention of restricting the scope of the present invention.

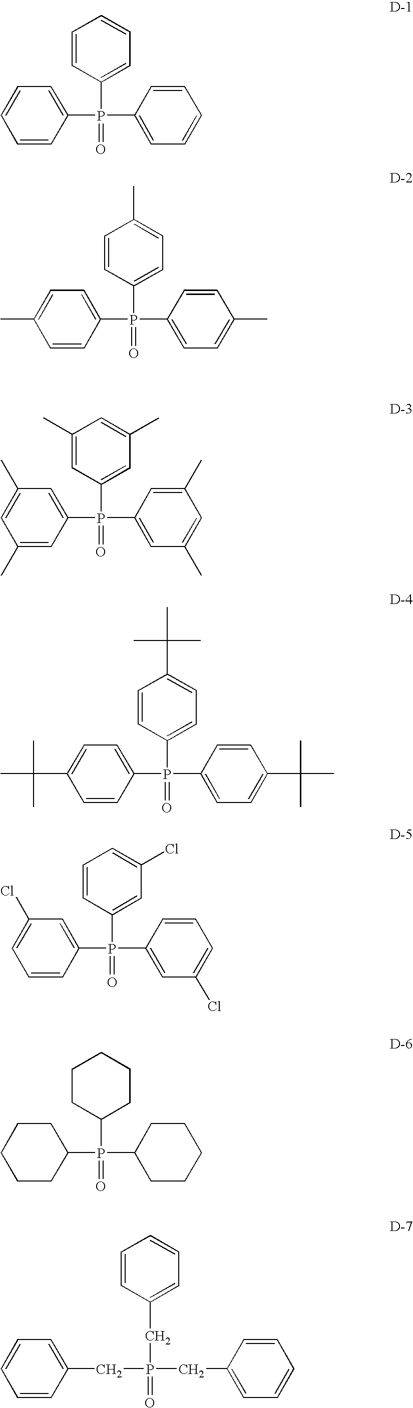

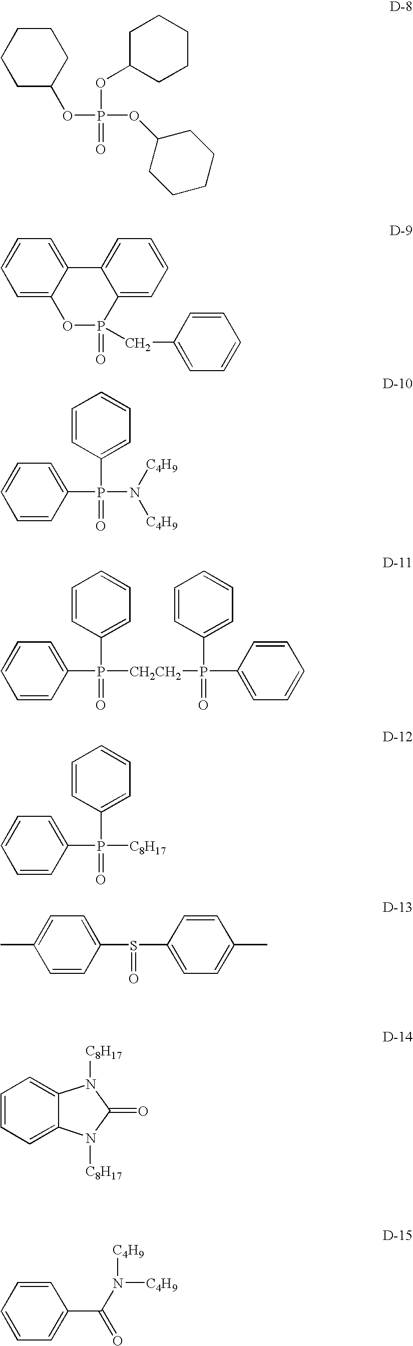

Specific examples of the hydrogen-bonding compound further include compounds disclosed in EP Patent No. 1096310, and JP-A Nos. 2002-156727 and 2002-318431, the disclosures of which are incorporated by reference herein.

The compound of the formula (D) may be added to the coating liquid and used in the photothermographic material in the form of a solution, an emulsion, or a solid particle dispersion. The specific manner of producing the solution, emulsion, or solid particle dispersion may be the same as in the case of the reducing agent. The compound is preferably used in the form of a solid dispersion. The hydrogen-bonding compound forms a hydrogen-bond complex with the reducing agent having a phenolic hydroxyl group or an amino group in the solution. The complex can be isolated as a crystal depending on the combination of the reducing agent and the compound of the formula (D).

It is particularly preferable to use the powder of the isolated crystal to form a solid particle dispersion, from the viewpoint of achieving stable performances. In a preferable embodiment, powder of the reducing agent and powder of the compound of the formula (D) are mixed, and then the mixture is dispersed in the presence of a dispersing agent by a sand grinder mill, etc., thereby forming the complex in the dispersing process.

The mole ratio of compound represented by the formula (D) to reducing agent is preferably 1 to 200 mol %, more preferably 10 to 150 mol %, further preferably 20 to 100 mol %.

Silver Halide

1) Halogen Composition

The halogen composition of the photosensitive silver halide used in the invention is not particularly restricted, and may be silver chloride, silver chlorobromide, silver bromide, silver iodobromide, silver iodochlorobromide, or silver iodide. Among them, silver bromide, silver iodobromide, and silver iodide are preferable. In a grain of the photosensitive silver halide, the halogen composition may be uniform in the entire grain, or may vary stepwise or steplessly. In an embodiment, the photosensitive silver halide grain has a core-shell structure. The core-shell structure is preferably a 2- to 5-layered structure, more preferably a 2- to 4-layered structure. It is also preferable to employ techniques for localizing silver bromide or silver iodide on the surface of the grain of silver chloride, silver bromide, or silver chlorobromide.

2) Method of Forming a Photosensitive Silver Halide Grain

Methods of forming the photosensitive silver halide grain are well known in the field. For example, the methods described in Research Disclosure, No. 17029, June 1978 (the disclosure of which is incorporated by reference) and U.S. Pat. No. 3,700,458 (the disclosure of which is incorporated by reference) may be used in the invention. In an embodiment, the photosensitive silver halide grains are prepared by: adding a silver source and a halogen source to a solution of gelatin or another polymer to form a photosensitive silver halide; and then mixing the silver halide with an organic silver salt. The method disclosed in the following documents are also preferable: JP-A No. 11-119374, Paragraph 0217 to 0224, and JP-A Nos. 11-352627 and 2000-347335, the disclosures of which are incorporated by reference herein.

3) Grain Size

The grain size of the photosensitive silver halide grain is preferably small so as to suppress the clouding after image formation. Specifically, the grain size is preferably 0.20 μm or smaller, more preferably 0.01 μm to 0.15 μm, further preferably 0.02 μm to 0.12 μm. The grain size of the photosensitive silver halide grain is the average diameter of the circle having the same area as the projected area of the grain; in the case of tabular grain, the projected area refers to the projected area of the principal plane.

4) Shape of Photosensitive Silver Halide Grain

The photosensitive silver halide grain may be a cuboidal grain, an octahedral grain, a tabular grain, a spherical grain, a rod-shaped grain, a potato-like grain, etc. In the invention, the cuboidal grain is preferable. Silver halide grains with roundish corners are also preferable. The face index (Miller index) of the outer surface plane of the photosensitive silver halide grain is not particularly limited. In a preferable embodiment, the silver halide grains have a high proportion of {100} faces; a spectrally sensitizing dye adsorbed to the {100} faces exhibits a higher spectral sensitization efficiency. The proportion of the {100} faces is preferably 50% or higher, more preferably 65% or higher, further preferably 80% or higher. The proportion of the {100} faces according to the Miller indices can be determined by a method described in T. Tani, J. Imaging Sci., 29, 165 (1985) (the disclosure of which is incorporated herein by reference) using adsorption dependency between {111} faces and {100} faces upon adsorption of a sensitizing dye.

5) Heavy Metal

The photosensitive silver halide grain used in the invention may include a metal selected from the metals of Groups 6 to 13 of the Periodic Table of Elements (having Groups 1 to 18) or a complex thereof. The metal is more preferably selected from metals of Groups 6 to 10 of the Periodic Table of Elements. When the photosensitive silver halide grain includes a metal selected from the metals of Groups 6 to 13 of the Periodic Table of Elements or a metal complex containing a metal selected from the metals of Groups 6 to 13 as the central metal, the metal or the central metal is preferably rhodium, ruthenium, iridium, or iron. The metal complex may be used singly or in combination with another complex including the same or different metal. The amount of the metal or the metal complex is preferably 1×10⁻⁹ mol to 1×10⁻³ mol per 1 mol of silver. The heavy metals, the metal complexes, and methods of adding them are described, for example, in JP-A No. 7-225449, JP-A No. 11-65021, Paragraph 0018 to 0024, and JP-A No. 11-119374, Paragraph 0227 to 0240, the disclosures of which are incorporated by reference herein.

In the invention, the silver halide grain is preferably a silver halide grain having a hexacyano metal complex on its outer surface. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. The hexacyano metal complex is preferably a hexacyano Fe complex.

The counter cation of the hexacyano metal complex is not important because the hexacyano metal complex exists as an ion in an aqueous solution. The counter cation is preferably a cation which is highly miscible with water and suitable for an operation to precipitate the silver halide emulsion; examples thereof include: alkaline metal ions such as a sodium ion, a potassium ion, a rubidium ion, a cesium ion, and a lithium ion; and ammonium and alkylammonium ions such as a tetramethylammonium ion, a tetraethylammonium ion, a tetrapropylammonium ion, and a tetra-(n-butyl)-ammonium ion.

The hexacyano metal complex may be added in the form of a solution in water, or in a mixed solvent of water and a water-miscible organic solvent (e.g. an alcohol, an ether, a glycol, a ketone, an ester, an amide, etc.), or in a gelatin.

The amount of the hexacyano metal complex to be added is preferably 1×10⁻⁵ mol to 1×10⁻² mol per 1 mol of silver, more preferably 1×10⁻⁴ mol to 1×10⁻³ mol per 1 mol of silver.

In order to allow the hexacyano metal complex to exist on the outer surface of the silver halide grains, the hexacyano metal complex may be directly added to the silver halide grains after the completion of the addition of an aqueous silver nitrate solution for grain formation but before the chemical sensitization (which may be chalcogen sensitization such as sulfur sensitization, selenium sensitization, or tellurium sensitization or may be noble metal sensitization such as gold sensitization). Specifically, the hexacyano metal complex may be directly added to the silver halide grains before the completion of the preparation step, in the water-washing step, in the dispersion step, or before the chemical sensitization step. It is preferable to add the hexacyano metal complex immediately after grain formation but before the completion of the preparation step so as to prevent excess growth of the silver halide grains.

In an embodiment, the addition of the hexacyano metal complex is started after 96% by mass of the total amount of silver nitrate for the grain formation is added. In a preferable embodiment, the addition is started after 98% by mass of the total amount of silver nitrate is added. In a more preferable embodiment, the addition is started after 99% by mass of the total amount of silver nitrate is added.

When the hexacyano metal complex is added after the addition of the aqueous silver nitrate solution but immediately before the completion of the grain formation, the hexacyano metal complex is adsorbed onto the outer surface of the silver halide grain, and most of the adsorbed hexacyano metal complex forms a hardly-soluble salt with silver ion on the surface. The silver salt of hexacyano iron (II) is less soluble than AgI and thus preventing redissolution of the fine grains, whereby the silver halide grains with a smaller grain size can be produced.

The metal atoms and metal complexes such as [Fe(CN)₆]⁴⁻ which may be added to the silver halide grains, and the desalination methods and the chemical sensitization methods for the silver halide emulsion are described in JP-A No. 11-84574, Paragraph 0046 to 0050, JP-A No. 11-65021, Paragraph 0025 to 0031, and JP-A No. 11-119374, Paragraph 0242 to 0250, the disclosures of which are incorporated herein by reference.

6) Gelatin

In the invention, the gelatin contained in the photosensitive silver halide emulsion may be selected from various gelatins. The gelatin has a molecular weight of preferably 10,000 to 1,000,000 so as to maintain excellent dispersion state of the photosensitive silver halide emulsion in the coating liquid including the organic silver salt. Substituents on the gelatin are preferably phthalated. The gelatin may be added during the grain formation or during the dispersing process after the desalting treatment, and is preferably added during the grain formation.

7) Sensitizing Dye

The sensitizing dye used in the invention is a sensitizing dye which can spectrally sensitize the silver halide grains when adsorbed by the grains, so that the sensitivity of the silver halide is heightened in the desired wavelength range. The sensitizing dye may be selected from sensitizing dyes having spectral sensitivities which are suitable for spectral characteristics of the exposure light source. The sensitizing dyes and methods of adding them are described, for example, in JP-A No. 11-65021, Paragraph 0103 to 0109; JP-A No. 10-186572 (the compounds represented by the formula (II)); JP-A No. 11-119374 (the dyes represented by the formula (I) and Paragraph 0106); U.S. Pat. No. 5,510,236; U.S. Pat. No. 3,871,887 (the dyes described in Example 5); JP-A No. 2-96131; JP-A No. 59-48753 (the dyes disclosed therein); EP-A No. 0803764A1, Page 19, Line 38 to Page 20, Line 35; JP-A Nos. 2001-272747, 2001-290238, and 2002-23306, the disclosures of which are incorporated herein by reference. Only a single sensitizing dye may be used or two or more sensitizing dyes may be used. In an embodiment, the sensitizing dye is added to the silver halide emulsion after the desalination but before the coating. In a preferable embodiment, the sensitizing dye is added to the silver halide emulsion after the desalination but before the completion of the chemical ripening.

The amount of the sensitizing dye to be added may be selected in accordance with the sensitivity and the fogging properties, and is preferably 10⁻⁶ mol to 1 mol per 1 mol of the silver halide in the image-forming layer, more preferably 10⁴ mol to 10⁻¹ mol per 1 mol of the silver halide in the image-forming layer.

In the invention, a super-sensitizer may be used in order to increase the spectral sensitization efficiency. Examples of the super-sensitizer include compounds described in EP-A No. 587,338, U.S. Pat. Nos. 3,877,943 and 4,873,184, JP-A Nos. 5-341432, 11-109547, and 10-111543, the disclosures of which are incorporated herein by reference.

8) Chemical Sensitization

In a preferable embodiment, the photosensitive silver halide grains are chemically sensitized by methods selected from the sulfur sensitization method, the selenium sensitization method, and the tellurium sensitization method. Known compounds such as the compounds described in JP-A No. 7-128768 (the disclosure of which is incorporated herein by reference) may be used in the sulfur sensitization method, the selenium sensitization method, and the tellurium sensitization method. In the invention, the tellurium sensitization is preferred, and it is preferable to use a compound or compounds selected from the compounds described in JP-A No. 11-65021, Paragraph 0030 and compounds represented by the formula (II), (III), or (IV) described in JP-A No. 5-313284, the disclosures of which are incorporated by reference herein.

In a preferable embodiment, the photosensitive silver halide grains are chemically sensitized by the gold sensitization method, which may be conducted alone or in combination with the chalcogen sensitization. The gold sensitization method preferably uses a gold sensitizer having a gold atom with the valence of +1 or +3. The gold sensitizer is preferably a common gold compound. Typical examples of the gold sensitizer include chloroauric acid, bromoauric acid, potassium chloroaurate, potassium bromoaurate, auric trichloride, potassium auricthiocyanate, potassium iodoaurate, tetracyanoauric acid, ammonium aurothiocyanate, and pyridyltrichloro gold. Further, the gold sensitizers described in U.S. Pat. No. 5,858,637 and JP-A No. 2002-278016 (the disclosures of which are incorporated herein by reference) are also preferable in the invention.

In the invention, the chemical sensitization may be carried out at any time between grain formation and coating. The chemical sensitization may be carried out after desalination, for example, (1) before spectral sensitization, (2) during spectral sensitization, (3) after spectral sensitization, or (4) immediately before coating.

The amount of the sulfur, selenium, or tellurium sensitizer may be changed in accordance with the kind of the silver halide grains, the chemical ripening condition, and the like, and is generally 10⁻⁸ mol to 10⁻² mol per 1 mol of silver halide, preferably 10⁻⁷ mol to 10⁻³ mol per 1 mol of silver halide.

The amount of the gold sensitizer to be added may be selected in accordance with the conditions, and is preferably 10⁻⁷ mol to 10⁻³ mol per 1 mol of silver halide, more preferably 10⁻⁶ mol to 5×10⁻⁴ mol per 1 mol of silver halide.

The conditions for the chemical sensitization are not particularly restricted and are generally conditions in which pH is 5 to 8, pAg is 6 to 11, and temperature is 40 to 95° C.

A thiosulfonic acid compound may be added to the silver halide emulsion by a method described in EP-A No. 293,917, the disclosure of which is incorporated by reference herein.

In the invention, the photosensitive silver halide grains may be subjected to reduction sensitization using a reduction sensitizer. The reduction sensitizer is preferably selected from ascorbic acid, aminoiminomethanesulfinic acid, stannous chloride, hydrazine derivatives, borane compounds, silane compounds, and polyamine compounds. The reduction sensitizer may be added at any time between crystal growth and coating in the preparation of the photosensitive emulsion. It is also preferable to ripen the emulsion while maintaining the pH value of the emulsion at 7 or higher and/or maintaining the pAg value at 8.3 or lower, so as to reduction-sensitize the photosensitive emulsion. Further, it is also preferable to conduct reduction sensitization by introducing a single addition part of a silver ion during grain formation.

9) Compound Whose One-Electron Oxidized Form Formed by One-Electron Oxidation can Release One or More Electron(s)

The photothermographic material of the invention preferably comprises a compound whose one-electron oxidized form formed by one-electron oxidation can release one or more electron(s). The compound may be used alone or in combination with the above-mentioned chemical sensitizers, thereby heightening the sensitivity of the silver halide.

The compound whose one-electron oxidized form formed by one-electron oxidation can release one or more electron(s) is the following compound of Type 1 or 2.

(Type 1) a compound whose one-electron oxidized form formed by one-electron oxidation can release one or more electron(s) through a subsequent bond cleavage reaction.

(Type 2) a compound whose one-electron oxidized form formed by one-electron oxidation can release one or more electron(s) after a subsequent bond formation.

The compound of Type 1 is described first.

Specific examples of the compound of Type 1 include compounds described as a one-photon two-electron sensitizer or a deprotonating electron donating sensitizer described in JP-A No. 9-211769 (Compounds PMT-1 to S-37 described in Tables E and F on Pages 28 to 32); JP-A No. 9-211774; JP-A No. 11-95355 (Compounds INV 1 to 36); Japanese Patent Application National Publication Laid-Open No. 2001-500996 (Compounds 1 to 74, 80 to 87, and 92 to 122); U.S. Pat. Nos. 5,747,235, and 5,747,236; EP Patent No. 786692A1 (Compounds INV 1 to 35); EP Patent No. 893732A1; U.S. Pat. Nos. 6,054,260, and 5,994,051; the disclosures of which are incorporated by reference herein. Preferred embodiments of the compounds are also described in the patent documents.

Further, examples of the compounds of Type 1 include compounds represented by the following formula (1) (equivalent to the formula (1) described in JP-A No. 2003-114487); compounds represented by the following formula (2) (equivalent to the formula (2) described in JP-A No. 2003-114487); compounds represented by the following formula (3) (equivalent to the formula (1) described in JP-A No. 2003-114488); compounds represented by the following formula (4) (equivalent to the formula (2) described in JP-A No. 2003-114488); compounds represented by the following formula (5) (equivalent to the formula (3) described in JP-A No. 2003-114488); compounds represented by the following formula (6) (equivalent to the formula (1) described in JP-A No. 2003-75950); compounds represented by the following formula (7) (equivalent to the formula (2) described in JP-A No. 2003-75950); compounds represented by the following formula (8) (equivalent to the formula (1) described in JP-A No. 2004-239943); and compounds represented by the following formula (9) (equivalent to the formula (3) described in JP-A No. 2004-245929) which can undergo a reaction represented by the following chemical reaction formula (1) (equivalent to the chemical reaction formula (1) described in JP-A No. 2004-245929). The disclosures of the above patent documents are incorporated by reference herein. Preferred embodiments of the compounds are described in the patent documents.

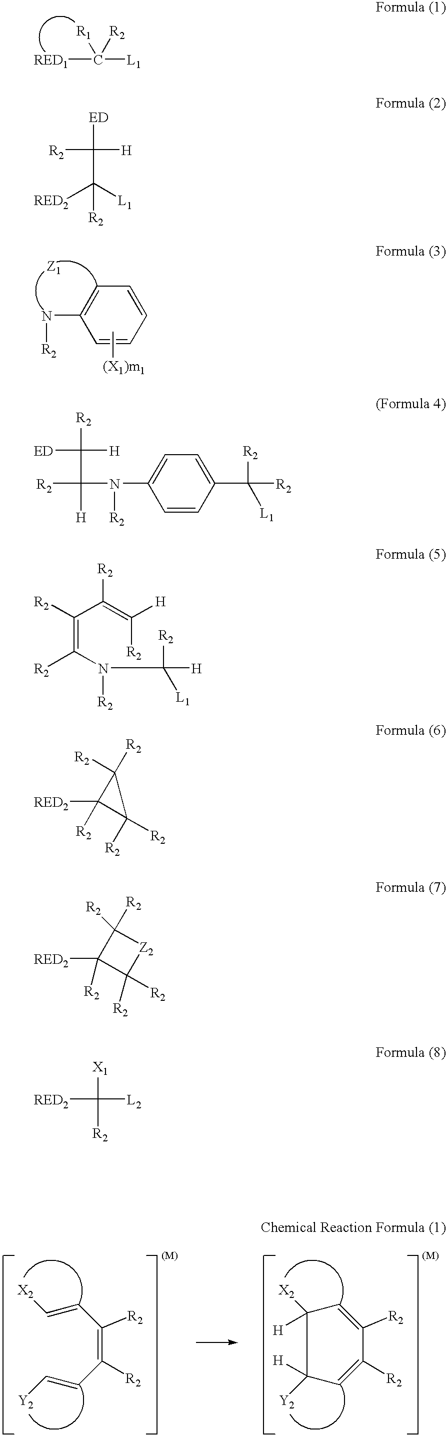

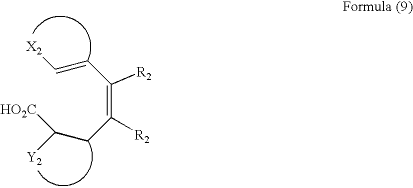

In the formulae, RED₁ and RED₂ each represent a reducing group. R₁ represents a nonmetallic atomic group which, together with the carbon atom C and RED₁, forms a ring structure corresponding to a tetrahydro- or octahydro-derivative of a 5- or 6-membered aromatic ring (such as an aromatic heterocycle). R₂ represents a hydrogen atom or a substituent. When one compound has a plurality of R₂'s, they may be the same as each other or different from each other. L₁ represents a leaving group. ED represents an electron-donating group. Z₁ represents an atomic group which, together with the nitrogen atom and two carbon atoms in the benzene ring, can form a 6-membered ring. X₁ represents a substituent, and m₁ represents an integer of O to 3. Z₂ represents —CR₁₁R₁₂—, —NR₁₃—, or —O—. R₁₁ and R₁₂ each independently represent a hydrogen atom or a substituent. R₁₃ represents a hydrogen atom, an alkyl group, an aryl group, or a heterocyclic group. Specifically, X₁ may represent an alkoxy group, an aryloxy group, a heterocyclyloxy group, an alkylthio group, an arylthio group, a heterocyclylthio group, an alkylamino group, an arylamino group, or a heterocyclylamino group. L₂ represents a carboxyl group or a salt thereof, or a hydrogen atom. X₂ represents a group which, together with the C═C group, forms a 5-membered heterocycle. Y₂ represents a group which, together with the C═C group, forms a 5- or 6-membered, aryl or heterocyclic group. M represents a radical, a radical cation, or a cation.

The compound of Type 2 is described next.

Examples of the compounds of Type 2 include compounds represented by the following formula (10) (equivalent to the formula (1) described in JP-A No. 2003-140287), and compounds represented by the following formula (11) (equivalent to the formula (2) described in JP-A No. 2004-245929) which can undergo a reaction represented by the following chemical reaction formula (1) (equivalent to the chemical reaction formula (1) described in JP-A No. 2004-245929). Preferred embodiments of the compounds are described in the patent documents.
X-L₂-Y Formula (10)

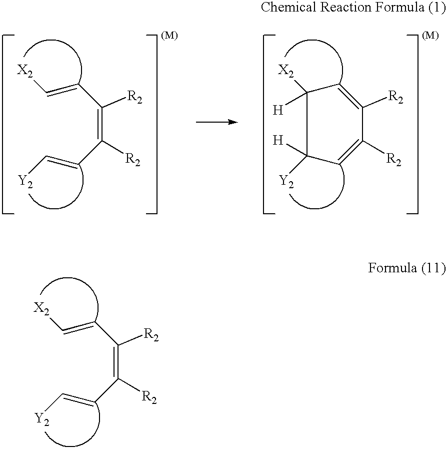

In the formulae, X represents a reducing group that can be one-electron-oxidized. Y represents a reactive group which includes a carbon-carbon double bond, a carbon-carbon triple bond, an aromatic group, or a benzo-condensed, nonaromatic heterocyclic group, and which can react with the one-electron-oxidized group derived from X to form a bond. L₂ represents a linking group that connects X and Y. R₂ represents a hydrogen atom or a substituent. When a compound has a plurality of R₂'s, they may be the same as each other or different from each other. X₂ represents a group which, together with the C═C group, forms a 5-membered heterocycle. Y₂ represents a group which, together with the C═C group, forms a 5- or 6-membered, aryl or heterocyclic group. M represents a radical, a radical cation, or a cation.

The compound of Type 1 or 2 preferably has a group which can adsorb silver halide, or a spectrally sensitizing dye moiety. Typical examples of the group which can adsorb silver halide include groups described in JP-A No. 2003-156823, Page 16, Right column, Line 1 to Page 17, Right column, Line 12, disclosure of which is incorporated by reference herein. The spectrally sensitizing dye moiety has a structure described in JP-A No. 2003-156823, Page 17, Right column, Line 34 to Page 18, Left column, Line 6, disclosure of which is incorporated by reference herein.

The compound of Type 1 or 2 is more preferably a compound having a group which can adsorb silver halide, and furthermore preferably has a compound having two or more groups which can adsorb silver halide. When the compound has two or more groups which can adsorb silver halide, the groups may be the same as each other or different from each other.

Preferable examples of the group which can adsorb silver halide include mercapto-substituted, nitrogen-including, heterocyclic groups (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzthiazole group, a 1,5-dimethyl-1,2,4-triazolium-3-thiolate group, etc.), and nitrogen-including heterocyclic groups each having an —NH— group capable of forming a silver imide (>NAg) as a moiety of the heterocycle (e.g., a benzotriazole group, a benzimidazole group, an indazole group, etc.) Particularly preferred among them are a 5-mercaptotetrazole group, a 3-mercapto-1,2,4-triazole group, and a benzotriazole group, and most preferred are a 3-mercapto-1,2,4-triazole group and a 5-mercaptotetrazole group.

In a preferable embodiment, the compound of Type 1 or 2 is a compound having a group which can adsorb silver halide, the group having two or more mercapto groups. Each mercapto group (—SH) may be converted to a thione group when it can be tautomerized. The group which can adsorb silver halide and has two or more mercapto groups may be a dimercapto-substituted, nitrogen-including, heterocyclic group, etc., and preferred examples thereof include a 2,4-dimercaptopyrimidine group, a 2,4-dimercaptotriazine group, and a 3,5-dimercapto-1,2,4-triazole group.

The group which can adsorb silver may be a quaternary salt group of nitrogen or phosphorus. Specifically, the quaternary nitrogen salt group may comprise: an ammonio group such as a trialkylammonio group, a dialkyl-aryl (or heteroaryl)-ammonio group or an alkyl-diaryl (or diheteroaryl)-ammonio group; or a heterocyclic group containing a quaternary nitrogen. The quaternary phosphorus salt group may comprise a phosphonio group such as a trialkylphosphonio group, a dialkyl-aryl (or heteroaryl)-phosphonio group, an alkyl-diaryl (or diheteroaryl)-phosphonio group, or a triaryl (or triheteroaryl)-phosphonio group. The quaternary salt group is more preferably a quaternary nitrogen salt group, further preferably an aromatic, quaternary-nitrogen-containing, heterocyclic group having a 5- or 6-membered ring structure, particularly preferably a pyridinio group, a quinolinio group, or a isoquinolinio group. The quaternary-nitrogen-containing heterocyclic groups may have a substituent.

Examples of the counter anion of the quaternary salt group include halogen ions, a carboxylate ion, a sulfonate ion, a sulfate ion, a perchlorate ion, a carbonate ion, a nitrate ion, BF₄⁻, PF₆⁻, and Ph₄B⁻. When the compound has a group with a negative charge such as a carboxylate group, the quaternary salt may be formed within the molecule. Examples of preferred counter anions other than the internal anions include a chlorine ion, a bromine ion, and a methanesulfonate ion.

When the compound of Type 1 or 2 has a quaternary nitrogen or phosphorus salt group as the group which can adsorb silver halide, the compound is preferably a compound represented by the following formula (X):
(P-Q1-)ᵢ-R(-Q2-S)ⱼ. Formula (X)

In the formula (X), P and R each independently represent a quaternary nitrogen or phosphorus salt group which is not the sensitizing dye moiety. Q1 and Q2 each independently represent a linking group which may be selected from a single bond, an alkylene group, an arylene group, a heterocyclic group, —O—, —S—, —NR_{N}—, —C(═O)—, —SO₂—, —SO—, —P(═O)—, or a combination of groups selected from the above groups. R_{N} represents a hydrogen atom, an alkyl group, an aryl group, or a heterocyclic group. S represents a residue obtained by removing an atom from a compound of Type 1 or 2. i and j each independently represent an integer of 1 or larger, the sum of i and j being 2 to 6. In an embodiment, i represents 1 to 3 and j represents 1 to 2. In a preferable embodiment, i represents 1 or 2 and j represents 1. In a more preferable embodiment, i represents 1 and j represents 1. The compound represented by the formula (X) preferably has 10 to 100 carbon atoms. The carbon number of the compound is more preferably 10 to 70, further preferably 11 to 60, particularly preferably 12 to 50.

The compound of Type 1 or 2 may be added at any time in the preparation of the photothermographic material, for example, in the preparation of the photosensitive silver halide emulsion. For example, the compound may be added during the formation of the photosensitive silver halide grains, during the desalination, during the chemical sensitization, or before coating. The compound may be added two or more times. The compound may be added, preferably after the completion of the photosensitive silver halide grain formation but before desalination; or during the chemical sensitization (just before the chemical sensitization to immediately after the chemical sensitization); or before coating. The compound may be added, more preferably during the period from the chemical sensitization to just before the mixing of the silver halide with the non-photosensitive organic silver salt.

The compound of Type 1 or 2 may be added preferably after dissolved in water, a water-soluble solvent such as methanol or ethanol, or a mixed solvent thereof. When the compound whose solubitity in water varies depending on pH is dissolved in water, the pH value of the solution may be appropriately adjusted so as to dissolve the compound well, before added to the silver halide.

It is preferable to incorporate the compound of Type 1 or 2 into the image-forming layer comprising the photosensitive silver halide and the non-photosensitive organic silver salt. It is also preferable to incorporate the compound of Type 1 or 2 into a protective layer, an intermediate layer, etc. as well as the image-forming layer, so that the compound diffuses during the coating. The compound may be added after or before or simultaneously with the addition of the sensitizing dye. In the silver halide emulsion layer (the image-forming layer), the amount of the compound is preferably 1×10⁻⁹ mol to 5×10⁻¹ mol per 1 mol of silver halide, more preferably 1×10⁻⁸ mol to 5×10⁻² mol, per 1 mol of silver halide.

Examples of compounds of Type 1 and 2 are shown below. However, compounds of Type 1 and 2 are not limited to the examples. 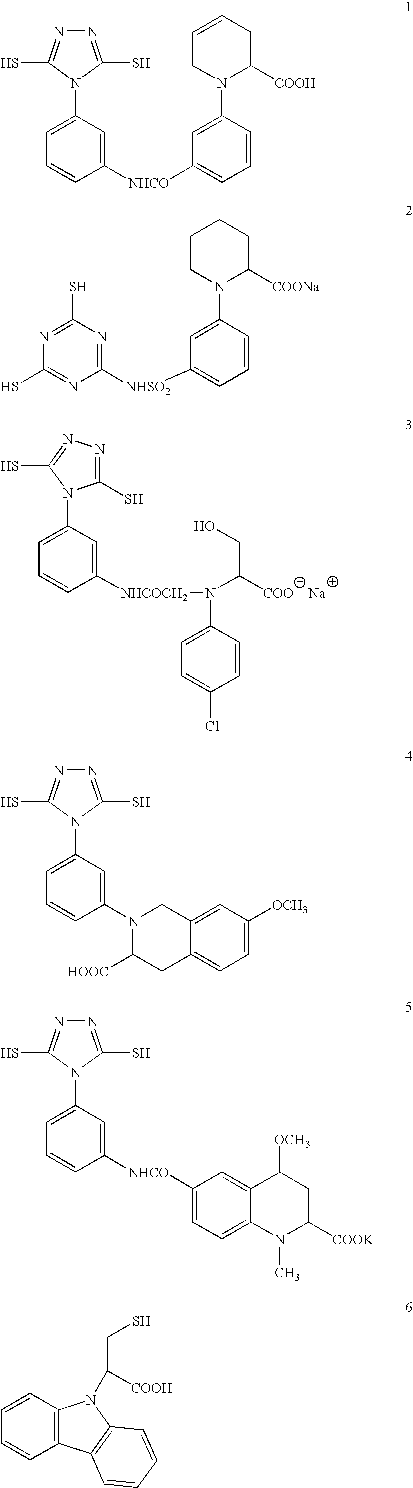 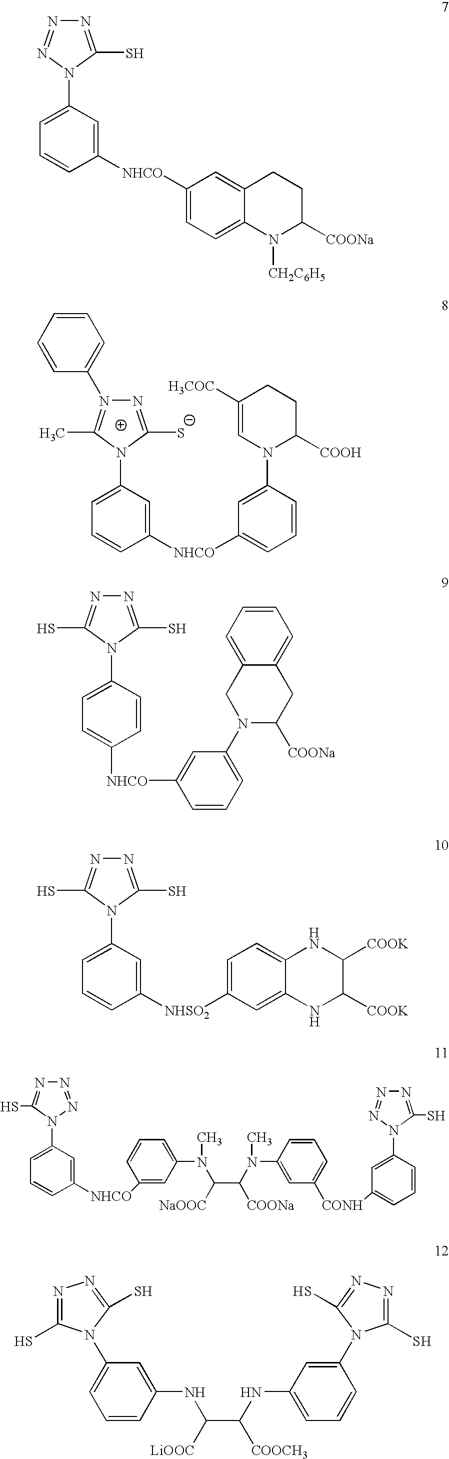 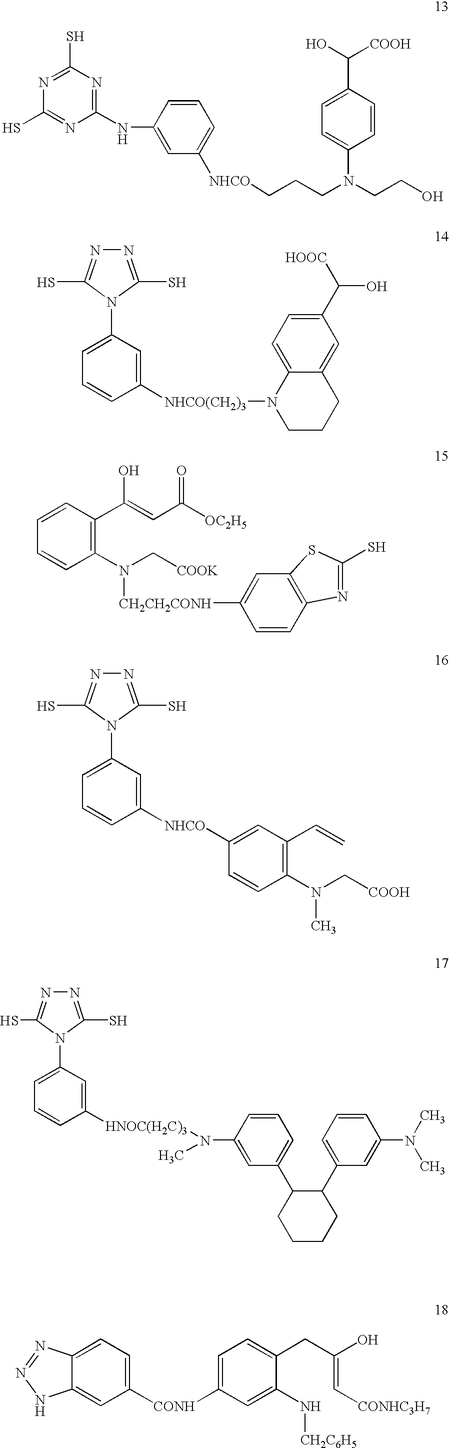 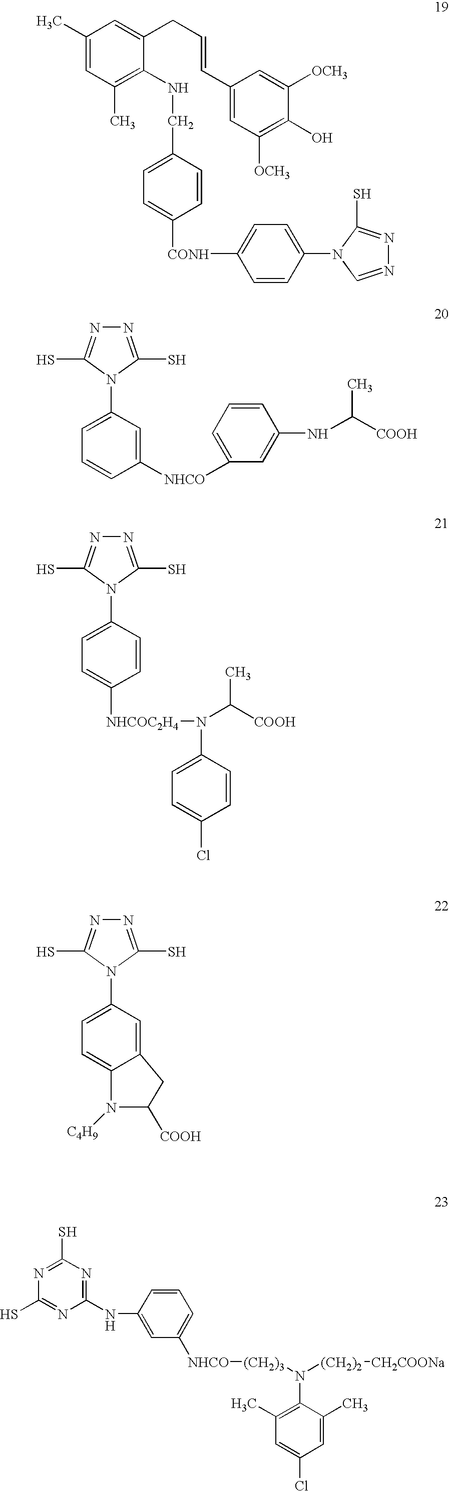 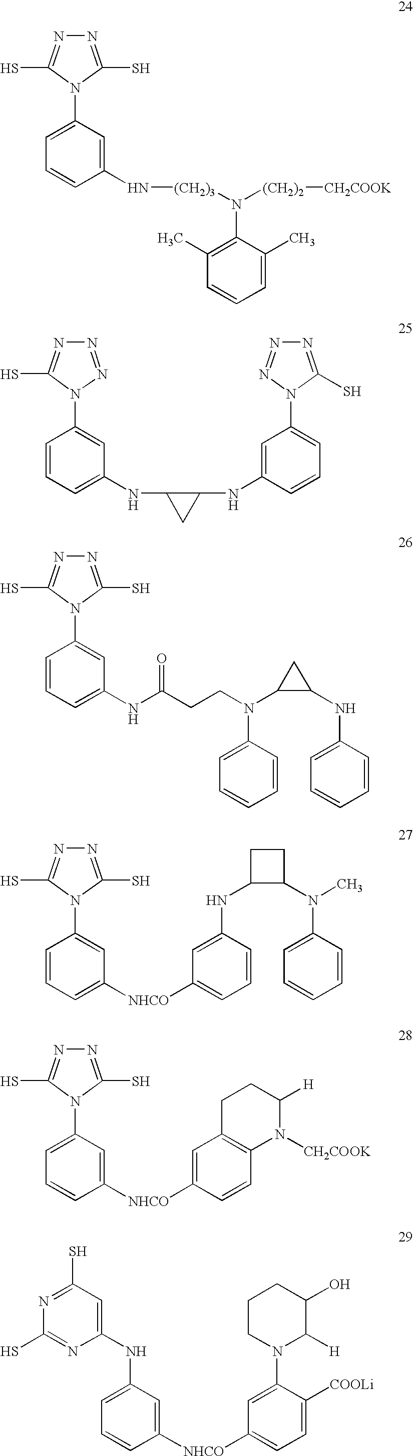 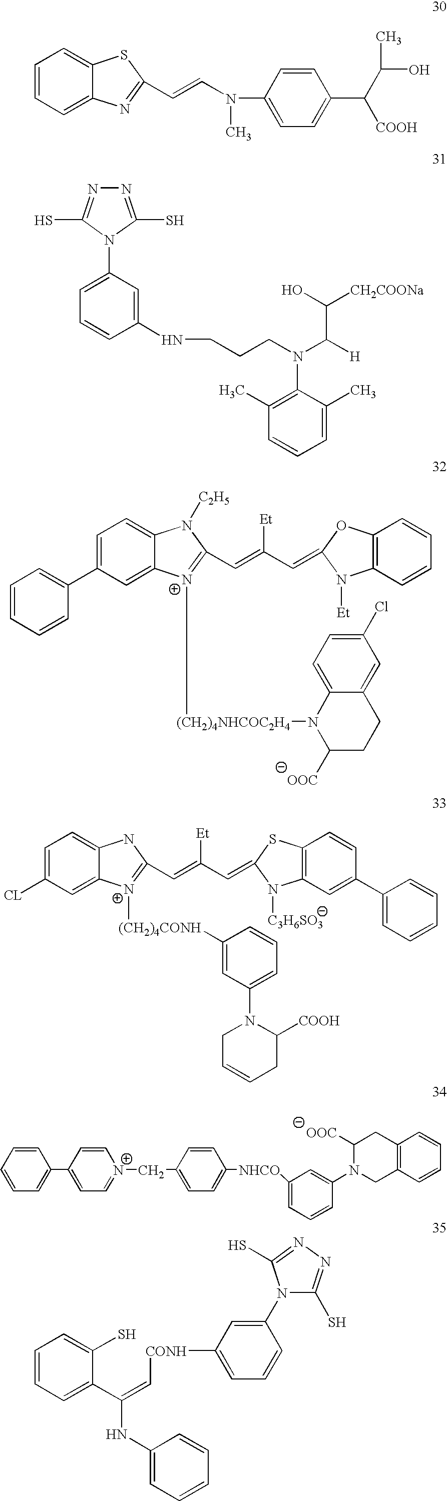 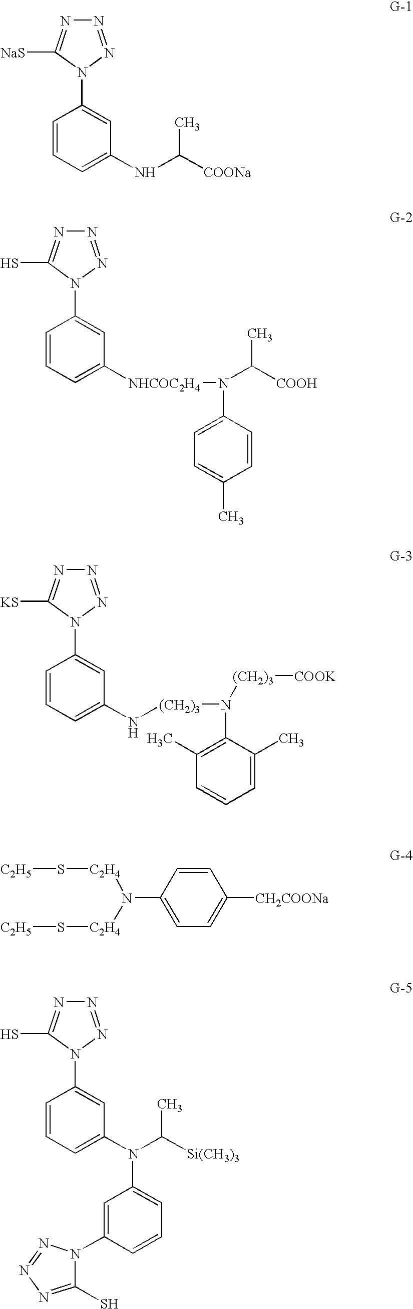
10) Adsorbent Redox Compound Having Adsorbent Group and Reducing Group

The photothermographic material of the invention preferably includes an adsorbent redox compound having a reducing group and an adsorbent group which can adsorb silver halide. The adsorbent redox compound is preferably a compound represented by the following formula (I):
A-(W)n-B. Formula (I)

In the formula (I), A represents a group which can adsorb silver halide (hereinafter referred to as an adsorbent group), W represents a divalent linking group, n represents 0 or 1, B represents a reducing group.

In the formula (I), the adsorbent group represented by A is a group which can directly adsorb silver halide, or a group which fascilitates the adsorption of silver halide. Specifically, the adsorbent groups may be a mercapto group or a salt thereof; a thione group comprising —C(═S)—; a heterocyclic group including at least one atom selected from the group consisting of nitrogen atoms, sulfur atoms, selenium atoms, and tellurium atoms; a sulfide group; a disulfide group; a cationic group; or an ethynyl group.

The mercapto groups (or a salt thereof) used as the adsorbent group may be a mercapto group itself (or a salt thereof), and is more preferably a heterocyclic group, an aryl group, or an alkyl group, each of which has at least one mercapto group (or salt thereof). The heterocyclic group may be a 5- to 7-membered, aromatic or nonaromatic, heterocyclic group having a monocyclic or condensed ring structure, and examples thereof include imidazole ring groups, thiazole ring groups, oxazole ring groups, benzoimidazole ring groups, benzothiazole ring groups, benzoxazole ring groups, triazole ring groups, thiadiazole ring groups, oxadiazole ring groups, tetrazole ring groups, purine ring groups, pyridine ring groups, quinoline ring groups, isoquinoline ring groups, pyrimidine ring groups, and triazine ring groups. The heterocyclic group may include a quaternary nitrogen atom, and in this case, the mercapto group as the substituent may be dissociated to form a meso-ion. When the mercapto group forms a salt, the counter ion thereof may be: a cation of an alkaline metal, an alkaline earth metal, a heavy metal, etc. such as Li⁺, Na⁺, K⁺, Mg²⁺, Ag⁺ and Zn²⁺; an ammonium ion; a heterocyclic group including a quaternary nitrogen atom; or a phosphonium ion.

The mercapto group as the adsorbent group may be tautomerized into a thione group.

The thione group as the adsorbent group may be, for example, a linear or cyclic, thioamide or thioureide or thiourethane or dithiocarbamic acid ester group.

The heterocyclic group including at least one atom selected from the group consisting of nitrogen atoms, sulfur atoms, selenium atoms, and tellurium atoms, used as the adsorbent group, is a nitrogen-containing heterocyclic group having —NH— capable of forming a silver imide (>NAg) as a moiety of the heterocycle, or a heterocyclic group having, as a moiety of the heterocycle, —S—, —Se—, —Te—, or ═N— capable of forming a coordinate bond with a silver ion. Examples of the former include benzotriazole groups, triazole groups, indazole groups, pyrazole groups, tetrazole groups, benzoimidazole groups, imidazole groups, and purine groups. Examples of the latter include thiophene groups, thiazole groups, oxazole groups, benzothiophene groups, benzothiazole groups, benzoxazole groups, thiadiazole groups, oxadiazole groups, triazine groups, selenazole groups, benzoselenazole groups, tellurazole groups, and benzotellurazole groups.

The sulfide group and the disulfide group used as the adsorbent group may be any group having an —S— or —S—S— moiety.

The cationic group used as the adsorbent group is a group including a quaternary nitrogen atom, and may be a group having a nitrogen-including heterocyclic group containing an ammonio group or a quaternary nitrogen atom. Examples of the quaternary-nitrogen-containing heterocyclic group include pyridinio groups, quinolinio groups, isoquinolinio groups, and imidazolio groups.

The ethynyl group used as the adsorbent group is a —C≡CH group, in which the hydrogen atom may be replaced by a substituent.

The above-described adsorbent groups may have any substituents.

Specific examples of the adsorbent group further include those described in JP-A No. 11-95355, Page 4 to 7, the disclosure of which is incorporated herein by reference.

In the formula (I), the adsorbent group represented by A is preferably a mercapto-substituted heterocyclic group (e.g. a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazolium-3-thiolate group, a 2,4-dimercaptopyrimidine group, a 2,4-dimercaptotriazine group, a 3,5-dimercapto-1,2,4-triazole group, 2,5-dimercapto-1,3-thiazole group, etc.) or a nitrogen-including heterocyclic group having —NH— capable of forming a silver imide (>NAg) in the heterocycle (e.g. a benzotriazole group, a benzimidazole group, an indazole group, etc.), more preferably a 2-mercaptobenzimidazole group or a 3,5-dimercapto-1,2,4-triazole group.

In the formula (I), W represents a divalent linking group. The linking group is not particularly limited as long as the linking group causes no adverse effects on the photographic properties. For example, the divalent linking group may be composed of an atom or atoms selected from carbon atoms, hydrogen atoms, oxygen atoms, nitrogen atoms, and sulfur atoms. Specific examples of the divalent linking group include: alkylene groups each having 1 to 20 carbon atoms such as a methylene group, an ethylene group, a trimethylene group, a tetramethylene group, and a hexamethylene group; alkenylene groups each having 2 to 20 carbon atoms; alkynylene groups each having 2 to 20 carbon atoms; arylene groups each having 6 to 20 carbon atoms such as a phenylene group and a naphthylene group; —CO—; —SO₂—; —O—; —S—; —NR1-; and combinations thereof. R1 represents a hydrogen atom, an alkyl group, a heterocyclic group, or an aryl group.

The linking group represented by W may have any substituent(s).

In the formula (I), the reducing group represented by B is a group capable of reducing a silver ion, and examples thereof include a formyl group, an amino group, triple bond groups such as an acetylene group and a propargyl group, a mercapto group, and residues obtained by removing one hydrogen atom from each of the following compounds: hydroxylamine compounds, hydroxamic acid compounds, hydroxyurea compounds, hydroxyurethane compounds, hydroxysemicarbazide compounds, reductone compounds (including reductone derivatives), aniline compounds, phenol compounds (including chroman-6-ol compounds, 2,3-dihydrobenzofuran-5-ol compounds, aminophenol compounds, sulfonamidephenol compounds, and polyphenol compounds such as hydroquinone compounds, catechol compounds, resorcinol compounds, benzenetriol compounds, and bisphenol compounds), acylhydrazine compounds, carbamoylhydrazine compounds, and 3-pyrazolidone compounds. The above reducing groups may have any substituent(s).

The oxidation potential of the reducing group represented by B in the formula (I) can be measured by a method described in Akira Fujishima, Denki Kagaku Sokutei-ho, Page 150-208, Gihodo Shuppan Co., Ltd., or The Chemical Society of Japan, Jikken Kagaku Koza, 4th edition, Vol. 9, Page 282-344, Maruzen, the disclosures of which are incorporated by reference herein. For example, the oxidation potential may be determined by a rotating disk voltammetry technique; specifically, in the technique, a sample is dissolved in a 10/90 (volume %) solvent of methanol/pH 6.5 Britton-Robinson buffer, and then the solution is subjected to bubbling with nitrogen gas for 10 minutes, and then the electric potential of the solution is measured at 25° C. at 1,000 round/minute at the sweep rate of 20 mV/second using a glassy carbon rotating disk electrode (RDE) as a working electrode, a platinum wire as a counter electrode, and a saturated calomel electrode as a reference electrode, thereby obtaining a voltammogram. The half wave potential (E1/2) can be obtained from the voltammogram.

The reducing group represented by B has an oxidation potential of preferably about −0.3 to about 1.0 V when measured by the above method. The oxidation potential is more preferably about −0.1 to about 0.8 V, particularly preferably about 0 to about 0.7 V.

The reducing group represented by B is preferably a residue provided by removing one hydrogen atom from a hydroxylamine compound, a hydroxamic acid compound, a hydroxyurea compound, a hydroxysemicarbazide compound, a reductone compound, a phenol compound, an acylhydrazine compound, a carbamoylhydrazine compound, or a 3-pyrazolidone compound.

The compound of the formula (I) may have a ballast group or a polymer chain each of which is commonly used in an immobile photographic additive such as a coupler. The polymer chain may be selected from the polymer chains described in JP-A No. 1-100530, the disclosure of which is incorporated by reference herein.

The compound of the formula (I) may be in the form of a dimer or a trimer. The molecular weight of the compound of the formula (I) is preferably 100 to 10,000, more preferably 120 to 1,000, particularly preferably 150 to 500.

Examples of the compound represented by the formula (I) are illustrated below without intention of restricting the scope of the invention.

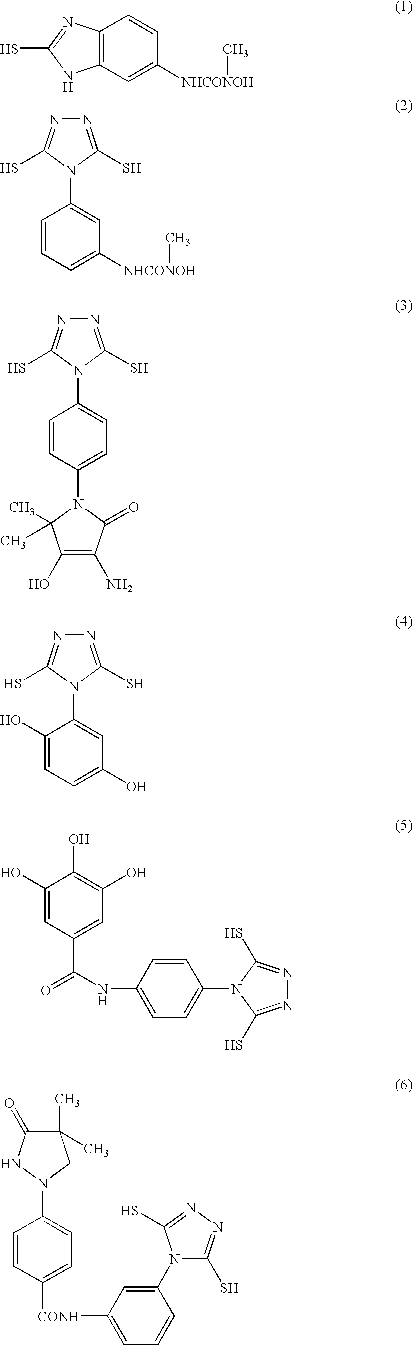

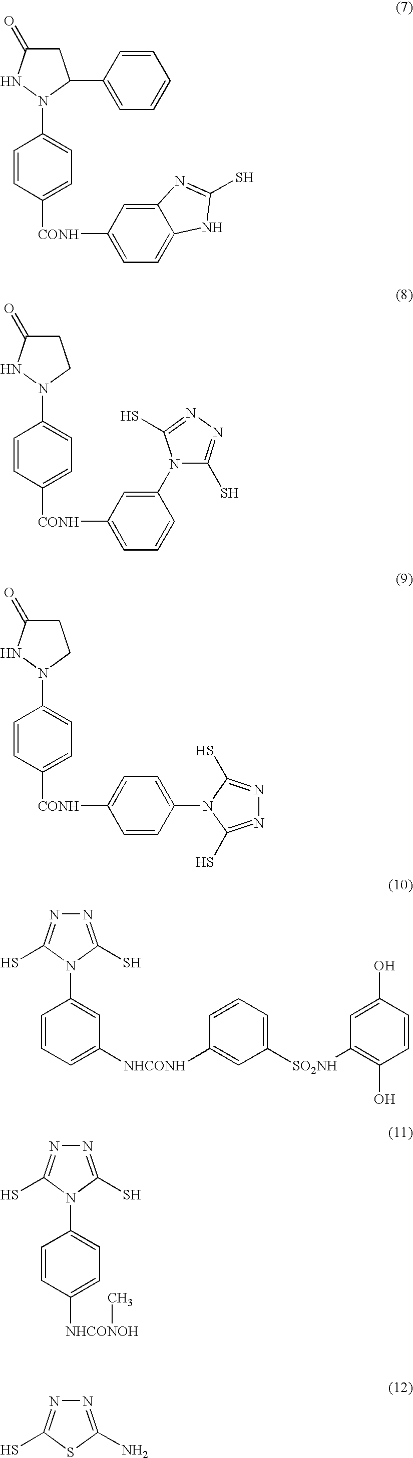

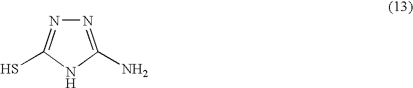

Further, Compounds 1 to 30 and 1″-1 to 1″-77 described in EP Patent No. 1308776A2, Page 73 to 87 (the disclosure of which is incorporated herein by reference) may be preferably used as the compound having the adsorbent group and the reducing group.

These compounds can be easily synthesized by a known method. Only a single kind of a compound of the formula (I) may be used, or two or more kinds of compounds of the formula (I) may be used in combination. When two or more compounds of the formula (I) are used, they may be included in the same layer or in respectively different layers, and may be added by respectively different methods.

The compound of the formula (I) is preferably included in the silver halide emulsion layer. It is preferable to add the compound of the formula (I) during the preparation of the silver halide emulsion. The compound may be added at any time in the preparation of the emulsion. For example, the compound may be added (i) during the silver halide grain formation, (ii) before the desalination, (iii) during the desalination, (iv) before the chemical ripening, (v) during the chemical ripening, (vi) before the finishing. The compound may be added two or more times. The compound may be used preferably in the image-forming layer. In an embodiment, the compound is added to a protective layer, an intermediate layer, etc. as well as the image-forming layer, so that the compound diffuses during coating.

The preferred amount of the compound to be added depends largely on the adding method and the type of the compound. The amount of the compound is generally 1×10⁻⁶ mol to 1 mol per 1 mol of the photosensitive silver halide, preferably 1×10⁻⁵ mol to 5×10⁻¹ per 1 mol of the photosensitive silver halide, more preferably 1×10⁻⁴ mol to 1×10⁻¹ mol per 1 mol of the photosensitive silver halide.

The compound of the formula (I) may be added in the form of a solution in water, a water-soluble solvent such as methanol or ethanol, or a mixed solvent thereof. The pH value of the solution may be appropriately adjusted by an acid or a base. A surfactant may be added to the solution. Further, the compound may be added in the form of an emulsion in an organic high boiling point solvent, or in the form of a solid dispersion.

11) Combination of Silver Halides

In an embodiment, only one kind of photosensitive silver halide emulsion is used in the photothermographic material of the invention. In another embodiment, two or more kinds of photosensitive silver halide emulsions are used in the photothermographic material; the photosensitive silver halide emulsions may be different from each other in characteristics such as average grain size, halogen composition, crystal habit, and chemical sensitization condition. The image gradation can be adjusted by using two or more kinds of photosensitive silver halide emulsions having different sensitivities. The related techniques are described, for example in JP-A Nos. 57-119341, 53-106125, 47-3929, 48-55730, 46-5187, 50-73627, and 57-150841, the disclosures of which are incorporated herein by reference. The difference in sensitivity between the emulsions is preferably 0.2 log E or larger.

12) Application Amount

The amount of the photosensitive silver halide to be applied is, in terms of the applied silver amount per 1 m² of photothermographic material, preferably 0.03 to 0.6 g/m², more preferably 0.05 to 0.4 g/m², still more preferably 0.07 to 0.3 g/m². Further, the amount of the photosensitive silver halide per 1 mol of the organic silver salt is preferably 0.01 to 0.5 mol, more preferably 0.02 to 0.3 mol, further preferably 0.03 to 0.2 mol.

13) Mixing of Photosensitive Silver Halide and Organic Silver Salt

The methods and conditions of mixing the photosensitive silver halide and the organic silver salt, which are separately prepared, are not particularly restricted as long as the advantageous effects of the invention can be sufficiently obtained. In an embodiment, the silver halide and the organic silver salt are separately prepared and then mixed by a high-speed stirrer, a ball mill, a sand mill, a colloid mill, a vibrating mill, a homogenizer, etc. In another embodiment, the prepared photosensitive silver halide is added to the organic silver salt during the preparation of the organic silver salt, and the preparation of the organic silver salt is then completed. It is preferable to mix two or more aqueous organic silver salt dispersion liquids and two or more aqueous photosensitive silver salt dispersion liquids so as to adjust the photographic properties.

14) Addition of Silver Halide to Coating Liquid

The silver halide is added to the coating liquid for the image-forming layer preferably between 180 minutes before coating and immediately before coating, more preferably between 60 minutes before coating and 10 seconds before coating. There are no particular restrictions on the methods and conditions of the coating as long as the advantageous effects of the invention can be sufficiently obtained. In an embodiment, the silver halide is mixed with the coating liquid in a tank while controlling the addition flow rate and the feeding amount to the coater, such that the average retention time calculated from the addition flow rate and the feeding amount to the coater is the desired time. In another embodiment, the silver halide is mixed with the coating liquid by a method using a static mixer described, for example, in N. Harnby, M. F. Edwards, and A. W. Nienow, translated by Koji Takahashi, Ekitai Kongo Gijutsu, Chapter 8 (Nikkan Kogyo Shimbun, Ltd., 1989), the disclosure of which is incorporated herein by reference.

(Explanation of Binder)

As the binder in the image-forming layer in the invention, any polymer may be used. The binder is preferably hydrophilic. The polymer is preferably transparent or translucent, and generally colorless. The polymer may be a natural resin, polymer or copolymer, a synthetic resin, polymer or copolymer, or another film-forming medium, and specific examples thereof include gelatins, gums, polyvinyl alcohols, hydroxyethylcelluloses, cellulose acetates, polyvinylpyrrolidones, caseins, starches, polyacrylic acids, polymethylmethacrylic acids.

In a preferable embodiment, 50 mass % to 100 mass % of the binder in the layer containing the organic silver salt is hydrophilic. In a more preferable embodiment, 70 mass % to 100 mass % of the binder in the layer containing the organic silver salt is hydrophilic.

Examples of hydrophilic binders include: gelatin and gelatin derivatives such as alkali-treated or acid treated gelatins, acetylated gelatins, oxidized gelatins, phthalated gelatins, and deionized gelatins; polysilisic acid; acrylamide-methacrylamide copolymers; acryl/methacryl polymers; polyvinyl pyrrolidones; poly(vinylacetate)s; poly(vinylalcohol)s; poly(vinyllactam)s; polymers of sulfoalkyl acrylates or sulfoalkyl methacrylates; hydrolyzed poly(vinylacetate); polysaccharides such as dextrans and starch ethers; and intrinsically hydrophilic (defined above) synthetic or natural vehicles (see, for example, Research Disclosure item 38957, the disclosure of which is incorporated herein by reference). The binder is preferably gelatin, a gelatin derivative, or a poly(vinylalcohol), more preferably gelatin or a gelatin derivative.

In the invention, it is preferable to form the image-forming layer by applying and drying a coating liquid in which 30 mass % or more (preferably 50 mass % or more) of the solvent is water.

The aqueous solvent in which the binder may be soluble or dispersible is water or a mixed solvent of water and a water-miscible organic solvent, the mixed solvent having a content of the water-miscible organic solvent of 70% by mass or lower. Examples of the water-miscible organic solvent include: alcohol solvents such as methyl alcohol, ethyl alcohol, and propyl alcohol; cellosolve solvents such as methyl cellosolve, ethyl cellosolve, and butyl cellosolve; ethyl acetate; and dimethylformamide.

Binders other than hydrophilic binders to be used are preferably polymers which are dispersible in aqueous solvents. Preferred examples of the polymers dispersible in the aqueous solvents include hydrophobic polymers such as acrylic polymers, polyesters, rubbers (e.g. SBR resins), polyurethanes, polyvinyl chlorides, polyvinyl acetates, polyvinylidene chlorides, and polyolefins. The polymer may be linear, branched, or cross-linked, and may be a homopolymer derived form one monomer or a copolymer derived form two or more monomers. The copolymer may be a random copolymer or a block copolymer. The number-average molecular weight of the polymer is preferably 5,000 to 1,000,000, more preferably 10,000 to 200,000. When the number-average molecular weight is too small, the resultant image-forming layer tends to have insufficient strength. On the other hand, when the number-average molecular weight is too large, the polymer is poor in the film-forming properties. Further, cross-linkable polymer latexes are particularly preferable.

In the invention, in the layer containing the organic silver salt (the image-forming layer), the ratio of the mass of the organic silver to the total mass of the binder is preferably in the range of 1/10 to 10/1, more preferably in the range of 0.6 to 3.0, still more preferably in the range of 1.0 to 2.5.

The total amount of the binder in the image-forming layer is preferably 0.2 g/m² to 30 g/m², more preferably 1 g/m² to 15 g/m², still more preferably 2 g/m² to 10 g/m². A crosslinking agent for crosslinking, or a surfactant for improving the coating property, may be added to the image-forming layer.

(Preferred Solvent for Coating Liquid)

In the invention, the solvent of the coating liquid for the image-forming layer is preferably an aqueous solvent including 30% by mass or more of water. The term “solvent” used herein means a solvent or a dispersion medium. The aqueous solvent may include any water-miscible organic solvent such as methyl alcohol, ethyl alcohol, isopropyl alcohol, methyl cellosolve, ethyl cellosolve, dimethylformamide, and ethyl acetate. The water content of the solvent for the coating liquid is preferably 50% by mass or higher, more preferably 70% by mass or higher. Examples of preferred solvents include water, 90/10 mixture of water/methyl alcohol, 70/30 mixture of water/methyl alcohol, 80/15/5 mixture of water/methyl alcohol/dimethylformamide, 85/10/5 mixture of water/methyl alcohol/ethyl cellosolve, and 85/10/5 mixture of water/methyl alcohol/isopropyl alcohol, the numerals representing the mass ratios (% by mass).

(Antifoggant)

Examples of antifoggants, stabilizers, and stabilizer precursors usable in the invention include compounds disclosed in JP-A No. 10-62899, Paragraph 0070 and EP-A No. 0803764A1, Page 20, Line 57 to Page 21, Line 7; compounds described in JP-A Nos. 9-281637 and 9-329864; and compounds described in U.S. Pat. No. 6,083,681 and EP Patent No. 1048975. The disclosures of the above patent documents are incorporated herein by reference.

(1) Polyhalogen Compound

Organic polyhalogen compounds, which can be preferably used as the antifoggant in the invention, are described in detail below. The antifoggant is preferably an organic polyhalogen compound represented by the following formula (H):
Q-(Y)ₙ-C(X1)(X2)Z. Formula (H)

In the formula (H), Q represents an alkyl group, an aryl group, or a heterocyclic group, Y represents a divalent linking group, n represents 0 to 1, X1 and X2 each independently represent a hydrogen atom or an electron-withdrawing group, and Z represents a halogen atom.

In the formula (H), Q represents preferably an alkyl group having 1 to 6 carbon atoms, an aryl group having 6 to 12 carbon atoms, or a heterocyclic group including at least one nitrogen atom such as a pyridyl group and a quinolyl group.

When Q represents an aryl group, the aryl group is preferably a phenyl group substituted by an electron-withdrawing group with a positive Hammett's substituent constant up. The Hammett's substituent constant is described, for example, in Journal of Medicinal Chemistry, 1973, Vol. 16, No. 11, 1207-1216, the disclosure of which is incorporated herein by reference. Examples of such an electron-withdrawing group include halogen atoms, alkyl groups having substituents of electron-withdrawing groups, aryl groups substituted by electron-withdrawing groups, heterocyclic groups, alkyl sulfonyl groups, aryl sulfonyl groups, acyl groups, alkoxycarbonyl groups, carbamoyl groups, and sulfamoyl groups. The electron-withdrawing group is preferably a halogen atom, a carbamoyl group, or an arylsulfonyl group, particularly preferably a carbamoyl group.

In a preferable embodiment, at least one of X1 and X2 represents an electron-withdrawing group. The electron-withdrawing group is preferably a halogen atom, an aliphatic, aryl, or heterocyclyl sulfonyl group, an aliphatic, aryl, or heterocyclyl acyl group, an aliphatic, aryl, or heterocyclyl oxycarbonyl group, a carbamoyl group, or a sulfamoyl group, more preferably a halogen atom or a carbamoyl group, particularly preferably a bromine atom.

Z represents preferably a bromine atom or an iodine atom, more preferably a bromine atom.

Y represent preferably —C(═O)—, —SO—, —SO₂—, —C(═O)N(R)—, or —SO₂N(R)—, more preferably —C(═O)—, —SO₂—, or —C(═O)N(R)—, particularly preferably —SO₂— or —C(═O)N(R)—, in which R represents a hydrogen atom, an aryl group, or an alkyl group, preferably a hydrogen atom or an alkyl group, particularly preferably a hydrogen atom.

In the formula (H), n represents 0 or 1, preferably 1.

In the formula (H), Y represents preferably —C(═O)N(R)— when Q represents an alkyl group, and Y represents preferably —SO₂— when Q represents an aryl group or a heterocyclic group.

In an embodiment, the antifoggant is a compound including two or more units represented by the formula (H), wherein each unit is bound to another unit, and a hydrogen atom in the formula (H) is substituted with the bond in each unit. Such a compound is referred to as a bis-, tris-, or tetrakis-type compound.

The compound represented by (H) is preferably substituted by a dissociative group (such as a COOH group, a salt of a COOH group, an SO₃H group, a salt of an SO₃H group, a PO₃H group, or a salt of a PO₃H group); a group containing a quaternary nitrogen cation, such as an ammonium group or a pyridinium group; a polyethyleneoxy group; a hydroxyl group; or the like.

Specific examples of the compounds represented by the formula (H) are shown below.

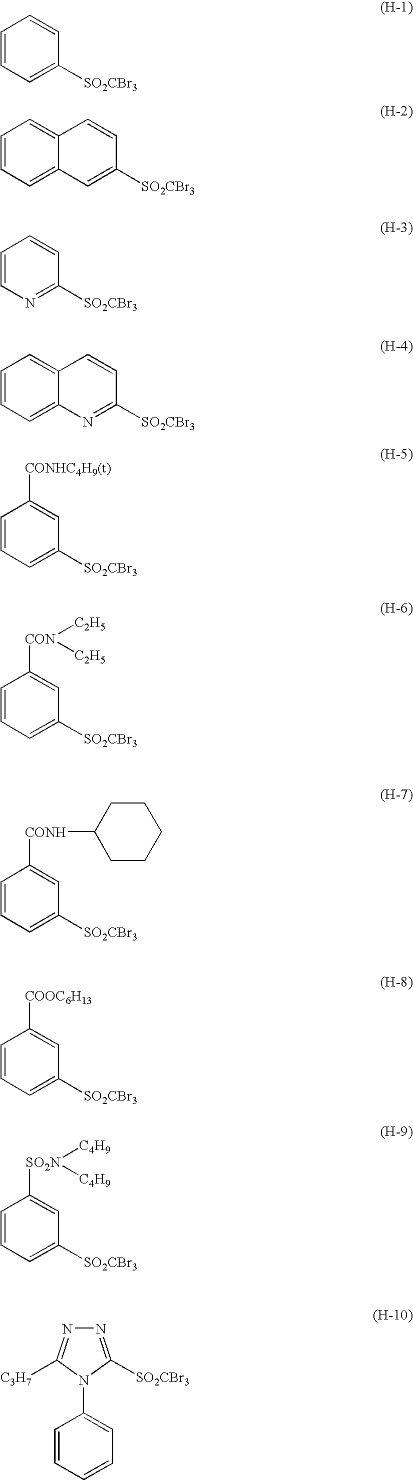

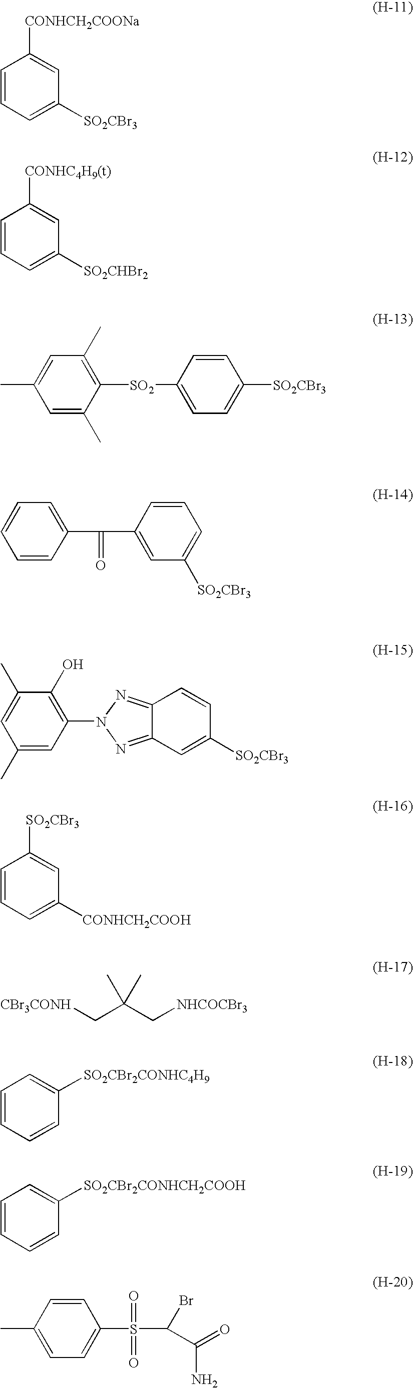

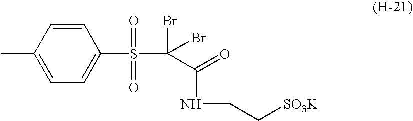

Examples of polyhalogen compounds usable in the invention include, in addition to the above compounds, compounds described in U.S. Pat. Nos. 3,874,946, 4,756,999, 5,340,712, 5,369,000, 5,464,737, and 6,506,548, and JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027, and 2003-50441, the disclosures of which are incorporated herein by reference. The compounds described in JP-A Nos. 7-2781, 2001-33911, and 2001-312027 are particularly preferred.

The amount of the polyhalogen compound is preferably 10⁻⁴ mol to 1 mol, more preferably 10⁻³ mol to 0.5 mol, further preferably mol 10⁻² to 0.2 mol, per 1 mol of the non-photosensitive silver salt.

The antifoggant may be added to the photosensitive material in any of the manners described above as examples of the method of adding the reducing agent. The organic polyhalogen compound is preferably added in the state of a solid particle dispersion.

(2) Other Antifoggants

Examples of other antifoggants usable in the invention include mercury (II) salts described in JP-A No. 11-65021, Paragraph 0113; benzoic acid compounds described in JP-A No. 11-65021, Paragraph 0114; salicylic acid derivatives described in JP-A No. 2000-206642; formalin scavenger compounds represented by the formula (S) described in JP-A No. 2000-221634; triazine compounds disclosed in claim 9 of JP-A No. 11-352624; compounds represented by the formula (III) described in JP-A No. 6-11791; and 4-hydroxy-6-methyl-1,3,3a,7-tetrazaindene. The disclosures of the above patent documents are incorporated herein by reference.

The photothermographic materials of the invention may further include an azolium salt for the purpose of preventing the fogging. Examples of the azolium salt include compounds represented by the formula (XI) described in JP-A No. 59-193447; compounds described in JP-B No. 55-12581; and compounds represented by the formula (II) described in JP-A No. 60-153039. The disclosures of the above patent documents are incorporated herein by reference. In an embodiment, the azolium salt is added to a layer on the same side as the image-forming layer. The layer to which the azolium salt may be added is preferably the image-forming layer. However, the azolium salt may be added to any portion of the material. The azolium salt may be added in any step in the preparation of the coating liquid. When the azolium salt is added to the image-forming layer, the azolium salt may be added in any step between the preparation of the organic silver salt and the preparation of the coating liquid. In an embodiment, the azolium salt is added during the period after the preparation of the organic silver salt but before the application of the coating liquid. The azolium salt may be added in the form of powder, a solution, a fine particle dispersion, etc. Further, the azolium salt may be added in the form of a solution which further contains other additives such as sensitizing dyes, reducing agents, and toning agents. The amount of the azolium salt to be added per 1 mol of silver is not particularly limited, and is preferably 1×10⁻⁶ mol to 2 mol, more preferably 1×10⁻³ mol to 0.5 mol.
(Description for the Compound of the Formula (I) or (II))

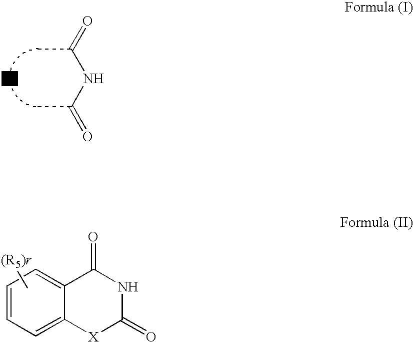

In the formula (I), Q represents an atomic group required for forming a 5- or 6-membered imide ring. In the formula (II), R₅ represents a hydrogen atom, an alkyl group, a cycloalkyl group, an alkoxy group, an alkylthio group, an arylthio group, a hydroxyl group, a halogeno group or a N(R₈R₉) group, wherein R₈ and R₉ each independently represents a hydrogen atom, an alkyl group, an aryl group, a cycloalkyl group, an alkenyl group or a heterocyclic group, or R₈ and R₉ may join to each other to represent an atomic group necessary for forming a substituted or not-substituted 5-membered to 7-membered heterocyclic ring. When there are two R₅'s, they may be the same as each other or different from each other, and they may join to each other to form an atomic group required for forming aromatic, heteroaromatic, alicyclic or heterocyclic condensed ring. X represents O, S, Se, or N(R₆), wherein R₆ represents a hydrogen atom, an alkyl group, an aryl group, a cycloalkyl group, an alkenyl group, or a heterocyclic group. In the formula (I), r represents 0, 1, or 2.

1) Description of Formula (I)

The nitrogen atom(s) and the carbon atom(s) constituting Q may have a hydrogen atom, an amino group, an alkyl group having 1 to 4 carbon atoms, a halogen atom, a keto oxygen atom, an aryl group, or the like bonded as a branch thereto. Specific examples of the compound having the imide ring represented by the formula (I) include uracil, 5-bromouracil, 4-methyluracil, 5-methyluracil, 4-carboxyuracil, 4,5-dimethyluracil, 5-aminouracil, dihyrouracil, 1-ethyl-6-methyluracil, 5-carboxymethylaminouracil, barbituric acid, 5-phenylbarbituric acid, cyanulic acid, urazole, hydantoin, 5,5-dimethyl hydantoin, glutal imide, glutacon imide, citrazinic acid, succinic imide, 3,4-dimethyl siccunic imide, maleimide, phthalimide, and naphthal imide. In the invention, among the compounds having the imide group represented by the formula (I), succinimide, phthalimide, naphthalimide, and 3,4-dimethyl succinine imide are preferred, and succine imide is particularly preferred.

2) Description of Formula (II)

In the formula (II), R₅ represents a hydrogen, an alkyl group, a cycloalkyl group, an alkoxy group, an alkylthio group, an arylthio group, a hydroxyl group, a halogen group, or a N(R₈R₉) group. Further, When there are two R₅'s, they may be the same as each other or different from each other, and they may join to each other to form an atomic group required for forming aromatic, heteroaromatic, alicyclic or heterocyclic condensed ring. In a case where R₅ represents an amino group [N(R₈R₉)], R₈ and R₉ each independently represents a hydrogen atom, an alkyl group, an aryl group, a cycloalkyl group, an alkenyl group, or a heterocyclic ring.

Further, R₈ and R₉ may join to each other to represent an atomic group required for forming a substituted or not-substituted 5-membered to 7-membered heterocyclic ring. In the formula (II), X represents O, S, Se, or N(R₆) in which R₆ represents a hydrogen atom, an alkyl group, an aryl group, a cycloalkyl group, an alkenyl group, or a heterocyclic group. r represents 0, 1 or 2.

An alkyl group useful as R₅, R₆, R₈, or R₉ is a linear, branched or cyclic alkyl groups which may have 1 to 20 carbon atoms, preferably 1 to 5 carbon atoms. Alkyl groups having 1 to 4 carbon atoms (for example, methyl, ethyl, iso-propyl, n-butyl, t-butyl, and sec-butyl) are particularly preferred.

An aryl group useful as R₅, R₆, R₈, or R₉ may have 6 to 14 carbon atoms in its aromatic ring(s). The aryl group is preferably a phenyl group or a substituted phenyl group.

A cycloalkyl group useful as R₅, R₆, R₈, or R₉ may have 5 to 14 carbon atoms in its central ring system. The cycloalkyl group is preferably a cyclopentyl groups or a cyclohexyl group.

A useful alkenyl group or alkynyl group may be branched or linear and may have 2 to 20 carbon atoms. The alkenyl group is preferably an allyl group.

A heterocyclic group useful as R₅, R₆, R₈, or R₉ may have 5 to 10 atoms selected from carbon atoms, oxygen atoms, sulfur atoms and nitrogen atoms in its central ring system and may have a condensed ring.

The alkyl, aryl, cycloalkyl, or heterocyclic group may be further substituted, for example, by one or more groups selected from halo groups, alkoxycarbonyl groups, hydroxyl groups, alkoxy groups, cyano groups, acyl groups, acyloxy groups, carbonyloxyester groups, sulfonic acid ester groups, alkylthio groups, dialkylamino groups, carboxy groups, sulfo groups, phosphono groups, and other groups known in the art.

An alkoxy, alkylthio, or arylthio group useful as R₅ has such an alkyl or aryl group as described above. The halogen group is preferably a chloro group or a bromo group. Representative examples of compounds represented by the formula (II) include the following compounds II-1 to II-10. The compound II-1 is most preferred.

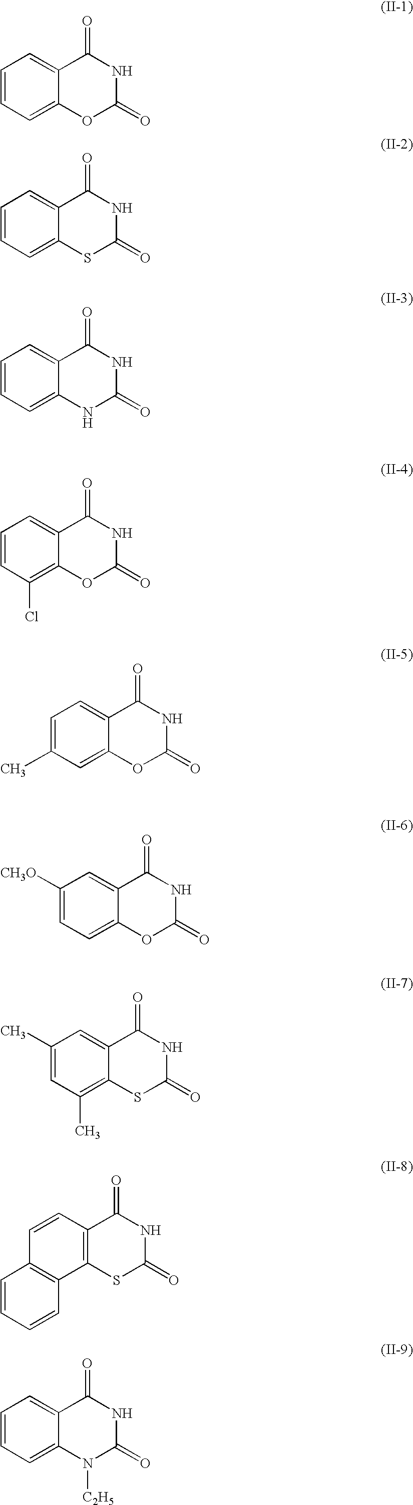

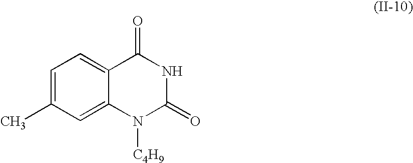

Other useful substituted benzoxadinediones are described in U.S. Pat. No. 3,951,660 (Hagemann, et al.), the disclosure of which is incorporated herein by reference. Compounds of the formulae (I) and (II) are preferably used as toning agents. The compounds of the formulae (I) and (II) may be used in combination with other toning agents such as phthalazinone, phthalazinone derivatives, and metal salts of derivatives of phthaladinone. Examples thereof include: 4-(1-naphthyl)phthalazinone; 6-chlorophthalazinone; 5,7-dimethoxyphthalazinone; and 2,3-dihydro-1,4-phthalazinedione; and a combination of phthalazine or a phthalazine derivative (such as 5-isopropylphthalazine) with a phthalic acid derivative (such as phthalic acid, 4-methyl phthalic acid, 4-nitro phthalic acid, or tetrachloro phthalic acid).

(Plasticizer and Lubricant)

In the invention, known plasticizers and lubricants can be used for improving the physical property of films. Particularly, it is preferred to use a lubricant such as liquid paraffin, a long-chain fatty acid, a fatty acid amide, or a fatty acid ester, for the purpose of improving the handling property at production and the scratch resistance at heat development. The lubricant is preferably liquid paraffin from which low-boiling ingredients have been removed, or a fatty acid ester with a molecular weight of 1,000 or more having a branched structure.

The plasticizer and lubricant that can be used in the image-forming layer and the non-photosensitive layer are preferably selected from the compounds described in JP-A No. 11-65021, paragraph 0117, JP-A Nos. 2000-5137, 2004-219794, 2004-219802, and 2004-334077, the disclosures of which are incorporated herein by reference.

(Dye and Pigment)

In the invention, the image-forming layer may further comprise various dyes and pigments (for example, C. I. Pigment Blue 60, C. I. Pigment Blue 64, and C. I. Pigment Blue 15:6) from the viewpoint of improving the tone, preventing occurrence of interference fringe and irradiation upon laser exposure. The dyes and pigments are described, for example, in WO98/36322 and JP-A Nos. 10-268465 and 11-338098, the disclosures of which are incorporated herein by reference.

(Nucleating Agent)

It is preferable to incorporate a nucleating agent into the image-forming layer. Examples of the nucleating agents, examples of the methods for adding them, and examples of the amount thereof are described in JP-A No. 11-65021, Paragraph 0118; JP-A No. 11-223898, Paragraph 0136 to 0193; JP-A No. 2000-284399 (the compounds each represented by any one of the formulae (H), (1) to (3), (A), and (B)); JP-A No. 2000-347345 (the compounds represented by the formulae (III) to (V) and the example compounds of Chemical Formula 21 to 24); etc. Further, examples of nucleation promoting agents are described in JP-A No. 11-65021, Paragraph 0102, and JP-A No. 11-223898, Paragraphs 0194 and 0195.

Formic acid or a formate salt may be used as a strong fogging agent. The amount of the formic acid or the formate salt per 1 mol of silver is preferably 5 mmol or smaller, more preferably 1 mmol or smaller, on the the image-forming layer side.

In the photothermographic material of the invention, the nucleating agent is preferably used in combination with an acid generated by hydration of diphosphorus pentaoxide or a salt thereof. Examples of the acid and the salt include metaphosphoric acid, pyrophosphoric acid, orthophosphoric acid, triphosphoric acid, tetraphosphoric acid, hexametaphosphoric acid, and salts thereof. Particularly preferred are orthophosphoric acid, hexametaphosphoric acid, and salts thereof. Specific examples of the salts include sodium orthophosphate, sodium dihydrogen orthophospate, sodium hexametaphosphate, and ammonium hexametaphosphate.

The amount of the acid generated by the hydration of diphosphorus pentaoxide or the salt thereof may be selected depending on the sensitivity, the fogging properties, etc. The amount of the acid or the salt to be applied per 1 m² of the photosensitive material is preferably 0.1 to 500 mg/m², more preferably 0.5 to 100 mg/m².

The reducing agent, the hydrogen bonding compound, the development accelerator and the polyhalogen compound are each preferably used in the form of a solid dispersion and a preferred method of manufacturing the solid dispersion is described in JP-A No. 2002-55405, the disclosure of which is incorporated herein by reference.

(Preparation and Application of Coating Liquid)

The coating liquid for the image-forming layer is prepared preferably at a preparation temperature of 30 to 65° C., more preferably 35° C. or higher but lower than 60° C., furthermore preferably 35 to 55° C. The temperature of the coating liquid immediately after addition of polymer latex is preferably maintained at 30 to 65° C.

(Layer Structure and Components)

The image-forming layer of the invention comprises at least one layer provided on the support. When the image-forming layer is a single layer, the image-forming layer includes an organic silver salt, a photosensitive silver halide, a reducing agent, and a binder. The image-forming layer may further include additional components such as a toning agent, a coating auxiliary, and other auxiliaries, in accordance with the necessity. When the image-forming layer comprises two or more layers, the first image-forming layer (usually the layer adjacent to the support) includes an organic silver salt and a photosensitive silver halide, and other components are each contained in the second image-forming layer and/or the first image-forming layer. When the photothermographic material of the invention is used as a multicolor photothermographic material, the material may comprise a combination of such two layers for each color or comprise a single layer including all the components as described in U.S. Pat. No. 4,708,928, the disclosure of which is incorporated by reference herein. When a plurality of dyes are used in the multicolor photothermographic material, the respective emulsion layers are separated from each other generally by functional or non-functional barrier layers provided between the respective photosensitive layers as described in U.S. Pat. No. 4,460,681, the disclosure of which is incorporated by reference herein.

The photothermographic material of the invention may have a non-photosensitive layer or non-photosensitive layers, in addition to the image-forming layer. The non-photosensitive layers can be classified, based on the configuration thereof, as (a) a surface protecting layer provided on the image-forming layer (on the side farther from the support), (b) intermediate layer(s) provided between plural image-forming layers and/or between the image-forming layer and a surface protecting layer, (c) an undercoating layer provided between the image-forming layer and the support, and (d) a back layer provided on the side of the support opposite to the image-forming layer.

In addition, a layer serving as an optical filter may be provided as a non-photosensitive layer (a) or (b). An antihalation layer may be provided as a non-photosensitive layer (c) or (d).

1) Surface Protective Layer

The photothermographic material of the invention may be provided with a surface protective layer for the purpose of, for example, preventing adhesion of the image-forming layer. The surface protective layer may have a monolayered structure or a multilayered structure.

The surface protective layer is described, for example, in paragraph Nos. 0119 to 0120 of JP-A No. 11-65021, and JP-A No. 2000-171936, the disclosures of which are incorporated herein by reference.

As the binder for the surface protective layer, gelatin is preferred. It is also preferable to use polyvinyl alcohol (PVA) singly or in combination with gelatin. Examples of usable gelatins include inert gelatin (e.g., Nitta gelatin 750) and phthalated gelatin (e.g., Nitta gelatin 801). PVA may be selected from ones described in paragraph Nos. 0009 to 0020 of JP-A 2000-171936 (the disclosure of which is incorporated herein by reference), preferably from: PVA-105, which is a completely saponified product, PVA-205, which is a partially saponified product, PVA-335, which is a partially saponified product, MP-203, wihch is a modified polyvinyl alcohol (all are manufactured by Kuraray Co., Ltd.), and the like. The coating amount (per square meter of the support) of polyvinyl alcohol of the protective layer (per one layer) is preferably 0.3 g/m² to 4.0 g/m², more preferably 0.3 g/m² to 2.0 g/m².

The coating amount (per square meter of the support) of the total binder (including water-soluble polymers and latex polymers) of the protective layer (per one layer) is preferably 0.3 g/m² to 5.0 g/m², more preferably 0.3 g/m² to 2.0 g/m².

The surface protective layer preferably includes a lubricant such as liquid paraffin or an aliphatic ester. The lubricant is used in an amount of 1 mg/m² to 200 mg/m², preferably 10 mg/m² to 150 mg/m², more preferably 20 mg/m² to 100 mg/m².

2) Antihalation Layer

In the photothermographic material of the invention, an antihalation layer may be disposed such that the antihalation layer is farther from the exposure light source than the image-forming layer is.

The antihalation layer is described, for example, in JP-A No. 11-65021, Paragraphs 0123 to 0124, JP-A Nos. 11-223898, 9-230531, 10-36695, 10-104779, 11-231457, 11-352625, and 11-352626, the disclosures of which are incorporated herein by reference.

The antihalation layer includes an antihalation dye having absorption in the exposure wavelength range. When the exposure wavelength is within the infrared range, an infrared-absorbing dye may be used as the antihalation dye, and the infrared-absorbing dye is preferably a dye which does not absorb visible light.

When a dye having absorption in the visible light range is used to prevent the halation, in a preferable embodiment, the color of the dye does not substantially remain after image formation. It is preferable to achromatize the dye by heat at the heat development. In a more preferable embodiment, a base precursor and a thermally-achromatizable dye are added to a non-photosensitive layer so as to impart the antihalation function to the non-photosensitive layer. These techniques are described, for example in JP-A No. 11-231457, the disclosure of which is incorporated by reference herein.

The amount of the achromatizable dye to be applied may be determined depending on the purpose. Generally, the amount of the achromatizable dye is selected such that the optical density (the absorbance) exceeds 0.1 at the desired wavelength. The optical density is preferably 0.15 to 2, more preferably 0.2 to 1. The amount of the dye required for obtaining such an optical density is generally 0.001 to 1 g/m².

When the dye is achromatized in this manner, the optical density after the heat development can be lowered to 0.1 or lower. In an embodiment, two or more achromatizable dyes are used in combination in a thermally achromatizable recording material or a photothermographic material. Similarly, two or more base precursors may be used in combination.

In the thermal achromatization, it is preferable to use an achromatizable dye, a base precursor, and a substance which can lower the melting point of the base precursor by 3° C. or more when mixed with the base precursor, in view of the thermal achromatizability, as described in JP-A No. 11-352626, the disclosure of which is incorporated by reference herein. Examples of the substance include diphenylsulfone, 4-chlorophenyl(phenyl)sulfone, and 2-naphtyl benzoate.

3) Back Layer

Examples of the back layer usable in the invention are described in JP-A No. 11-65021, Paragraphs 0128 to 0130, the disclosure of which is incorporated herein by reference.

In the invention, a coloring agent having an absorption peak within the wavelength range of 300 to 450 nm may be added to the photosensitive material so as to improve the color tone of silver and to suppress the image deterioration with time. Examples of the coloring agent are described in JP-A Nos. 62-210458, 63-104046, 63-103235, 63-208846, 63-306436, 63-314535, 01-61745, and 2001-100363, the disclosures of which are incorporated by reference herein.

Such a coloring agent is generally added in an amount in the range of 0.1 mg/m² to 1 g/m². In an embodiment, a coloring agent is added to a back layer disposed on the opposite side to the image-forming layer.

It is preferable to use a dye having an absorption peak at 580 to 680 nm in order to control base color tone. Preferable examples of the dye include azomethine type oil-soluble dyes such as described in JP-A Nos. 4-359967 and 4-359968, and phthalocyanine type water-soluble dyes such as described in JP-A No. 2003-295388, which each have a small absorption intensity in the shorter wavelength range. The disclosures of the above patent documents are incorporated herein by reference. The dye for this purpose may be added to any layer, preferably to a non-photosensitive layer on the image-forming layer side or on the back side.

The photothermographic material of the invention is preferably a so-called single-sided photosensitive material, which comprises at least one image-forming layer including the silver halide emulsion on one side of the support, and a back layer on the other side of the support. The photothermographic material of the invention is used preferably in the form of a cut sheet rather than in the form of a roll.

4) Matting Agent

In the invention, a matting agent is preferably added to improve the conveyability. The matting agent is described in JP-A No. 11-65021, Paragraphs 0126 and 0127, the disclosure of which is incorporated herein by reference. The amount of the matting agent to be applied per 1 m² of the photosensitive material is preferably 1 to 400 mg/m², more preferably 5 to 300 mg/m².

The matting agent may be delomorphous or amorphous, and is preferably delomorphous. The matting agent is preferably in a sphere shape.

The volume-weighted average equivalent sphere diameter of the matting agent provided on the emulsion surface is preferably 0.3 to 10 μm, more preferably 0.5 to 7 μm. The variation coefficient of the particle diameter distribution of the matting agent is preferably 5 to 80%, more preferably 20 to 80%. The variation coefficient is obtained according to the equation:
variation coefficient=(standard deviation of particle diameter)/(average particle diameter)×100.

Further, two or more types of the matting agents having different average particle diameters may be provided on the emulsion surface. In this case, the difference of the average particle diameters between the smallest matting agent and the largest matting agent is preferably 2 to 8 μm, more preferably 2 to 6 μm.

The volume-weighted average equivalent sphere diameter of the matting agent provided on the back surface is preferably 1 to 15 μm, more preferably 3 to 10 μm. The variation coefficient of the particle diameter distribution of the matting agent is preferably 3 to 50%, more preferably 5 to 30%. Further, two or more types of the matting agents having different average particle diameters may be provided on the back surface. In this case, the difference of the average particle diameters between the smallest matting agent and the largest matting agent is preferably 2 to 14 μm, more preferably 2 to 9 μm.

The mattness of the emulsion surface is not limited as long as star defects are not caused. The Bekk smoothness of the surface is preferably 30 to 2,000 seconds, particularly preferably 40 to 1,500 seconds. The Bekk smoothness can be easily obtained by Method for testing smoothness of paper and paperboard by Bekk tester according to JIS P8119, or TAPPI standard method T479, the disclosures of which are incorporated by reference herein.

The mattness of the back layer is preferably such that the Beck smoothness is 10 to 1,200 seconds. The Beck smoothness is more preferably 20 to 800 seconds, further preferably 40 to 500 seconds.

In the invention, the matting agent is preferably included in a layer or layers selected from the outermost layer, the layer functioning as the outermost layer, and a layer near the outermost layer. The matting agent is preferably contained in a layer functioning as a protective layer.

5) Polymer Latex

When the photothermographic material of the invention is used for printing, in which dimensional change is problematic, it is preferable to use a polymer latex in a surface protective layer and/or a back layer. Such a polymer latex is described, for example, in Gosei Jushi Emulsion, (compiled by Taira Okuda and Hiroshi Inagaki, issued by Kobunshi Kanko Kai (1978)); Gosei Latex no Oyo, (compiled by Takaaki Sugimura, Yasuo Kataoka, Souichi Suzuki, and Keishi Kasahara, issued by Kobunshi Kanko Kai (1993); Gosei Latekkusu no Kagaku (written by Soichi Muroi, issued by Kobunshi Kanko Kai (1970)), the disclosures of which are incorporated herein by reference. Specific examples thereof include latex of methyl methacrylate (33.5 mass %)—ethyl acrylate (50 mass %)—methacrylic acid (16.5 mass %) copolymer, latex of methyl methacrylate (47.5 mass %)—butadiene (47.5 mass %)—itaconic acid (5 mass %) copolymer, latex of ethyl acrylate-methacrylic acid copolymer, latex of methyl methacrylate (58.9 mass %)—2-ethylhexyl acrylate (25.4 mass %)—styrene (8.6 mass %)—2-hydroxyethyl methacrylate (5.1 mass %)—acrylic acid (2.0 mass %) copolymer, and latex of methyl methacrylate (64.0 mass %)—styrene (9.0 mass %)—butyl acrylate (20.0 mass %)—2-hydroxyethyl methacrylate (5.0 mass %)—acrylic acid (2.0 mass %) copolymer. Further, regarding the binder for the surface protective layer, the combinations of polymer latexes described in JP-A No. 2000-267226, the technique described in paragraph Nos. 0021 to 0025 of JP-A No. 2000-267226, the technique described in paragraph nos. 0027 to 0028 of Japanese Patent Application No. 11-6872, and the technique described in paragraph Nos. 0023 to 0041 of JP-A No. 2000-19678 may also be applied, the disclosures of which are incorporated herein by reference. The proportion of amount of the polymer latex to the total amount of binder in the surface protective layer is preferably 10 mass % to 90 mass %, more preferably 20 mass % to 80 mass %.

6) Film Surface pH

The photothermographic material of the invention before heat development preferably has a film surface pH of 7.0 or lower. The film surface pH is more preferably 6.6 or lower. The lower limit of the film surface pH may be approximately 3, though it is not particularly restricted. The film surface pH is still more preferably 4 to 6.2. It is preferable to adjust the film surface pH using an organic acid such as a phthalic acid derivative, a nonvolatile acid such as sulfuric acid, or a volatile base such as ammonia, from the viewpoint of lowering the film surface pH. In order to achieve a low film surface pH, it is preferable to use ammonia since ammonia is high in volatility and can be removed during coating or before heat development. It is also preferable to use ammonia in combination with a nonvolatile base such as sodium hydroxide, potassium hydroxide, or lithium hydroxide. Methods for measuring the film surface pH are described in JP-A No. 2000-284399, Paragraph 0123, the disclosure of which is incorporated herein by reference.

7) Film Hardener

A film hardener may be included in layers such as the image-forming layer, the protective layer, and the back layer. Examples of the film hardeners are described in T. H. James, The Theory of the Photographic Process, Fourth Edition, Page 77 to 87 (Macmillan Publishing Co., Inc., 1977), the disclosure of which is incorporated by reference herein. Preferred examples of the film hardeners include: chromium alums; 2,4-dichloro-6-hydroxy-s-triazine sodium salt; N,N-ethylenebis(vinylsulfonacetamide); N,N-propylenebis(vinylsulfonacetamide); polyvalent metal ions described in Page 78 of the above reference; polyisocyanates described in U.S. Pat. No. 4,281,060, JP-A No. 6-208193, etc.; epoxy compounds described in U.S. Pat. No. 4,791,042, etc.; and vinylsulfone compounds described in JP-A No. 62-89048, etc. The disclosures of the above patent documents are incorporated herein by reference.

The film hardener is added in the form of a solution, and the solution is added to the coating liquid for the protective layer preferably in the period of 180 minutes before coating to immediately before coating, more preferably in the period of 60 minutes before coating to 10 seconds before coating. The method and conditions of mixing the film hardener into the coating liquid are not particularly limited as long as the advantageous effects of the invention can be sufficiently obtained. In an embodiment, the film hardner is mixed with the coating liquid in a tank while controlling the addition flow rate and the feeding amount to the coater, such that the average retention time calculated from the addition flow rate and the feeding amount to the coater is the desired time. In another embodiment, the film hardner is mixed with the coating liquid by a method using a static mixer described, for example, in N. Harnby, M. F. Edwards, and A. W. Nienow, translated by Koji Takahashi, Ekitai Kongo Gijutsu, Chapter 8 (Nikkan Kogyo Shimbun, Ltd., 1989), the disclosure of which is incorporated herein by reference.

8) Surfactant

Surfactants described in JP-A No. 11-65021 (the disclosure of which is incorporated herein by reference in its entirety), Paragraph 0132, solvents described in ibid, Paragraph 0133, supports described in ibid, Paragraph 0134, antistatic layers and conductive layers described in ibid, Paragraph 0135, methods for forming color images described in ibid, Paragraph 0136, and slipping agents described in JP-A No. 11-84573 (the disclosure of which is incorporated herein by reference in its entirety), Paragraph 0061 to 0064 and JP-A No. 2001-83679 (the disclosure of which is incorporated herein by reference in its entirety) Paragraph 0049 to 0062, can be used in the invention.

In the invention, it is preferable to use a fluorochemical surfactants. Specific examples of the fluorochemical surfactants include compounds described in JP-A Nos. 10-197985, 2000-19680, and 2000-214554, the disclosures of which are incorporated herein by reference. Further, fluorine-containing polymer surfactants described in JP-A No. 9-281636 (the disclosure of which is incorporated herein by reference) are also preferable in the invention. In an embodiment, the fluorochemical surfactants described in JP-A Nos. 2002-82411, 2003-057780, and 2003-149766 (the disclosures of which are incorporated herein by reference) are used in the photothermographic material of the invention. The fluorochemical surfactants described in JP-A Nos. 2003-057780 and 2003-149766 are particularly preferred from the viewpoints of the electrification control, the stability of the coating surface, and the slipping properties in the case of using an aqueous coating liquid. The fluorochemical surfactants described in JP-A No. 2003-149766 are most preferred because they are high in the electrification control ability and are effective even when used in a small amount.

In the invention, the fluorochemical surfactant may be used on the image-forming layer side and/or on the back side, and is preferably used on both the image-forming layer side and the back side. It is particularly preferable to use a combination of the fluorochemical surfactant and the above-described conductive layer including a metal oxide. In this case, sufficient performance can be achieved even if the fluorochemical surfactant in the electrically conductive layer side is reduced or removed.

The amount of the fluorochemical surfactant used in each of the emulsion surface and the back surface is preferably 0.1 to 100 mg/m², more preferably 0.3 to 30 mg/m², further preferably 1 to 10 mg/m². In particular, the fluorochemical surfactants described in JP-A No. 2003-149766 can exhibit excellent effects, whereby the amount thereof is preferably 0.01 to 10 mg/m², more preferably 0.1 to 5 mg/m².

9) Antistatic Agent

The photothermographic material of the invention preferably comprises an electrically conducting layer including an electrically conductive material such as a metal oxide or an electrically conductive polymer. The electrically conducting layer (antistatic layer) may be the same layer as a layer selected from the undercoat layer, the back surface protective layer, and the like, or may be provided as a separate layer which is different from those layers. The conductive material in the antistatic layer is preferably a metal oxide whose conductivity has been heightened by incorporation of oxygen defects and/or hetero-metal atoms.

The metal oxide is preferably ZnO, TiO₂, or SnO₂. It is preferable to add Al or In to ZnO. It is preferable to add Sb, Nb, P, a halogen atom, or the like to SnO₂. It is preferable to add Nb, Ta, or the like to TiO₂. SnO₂ to which Sb has been added is particularly preferable conductive substance for the electrically conducting layer. The amount of the hetero atom is preferably 0.01 to 30 mol %, more preferably 0.1 to 10 mol %. The particles of the metal oxide may be in a spherical shape, in a needle shape, or in a plate shape. The metal oxide particles are preferably needle-shaped particles with the ratio of the major axis to the minor axis of 2.0 or higher in view of the conductivity, and the ratio is more preferably 3.0 to 50. The amount of the metal oxide is preferably 1 to 1,000 mg/m², more preferably 10 to 500 mg/m², furthermore preferably 20 to 200 mg/m². The antistatic layer may be provided on the image-forming layer side or on the back side. In a preferable embodiment, the antistatic layer is provided between the support and the back layer. Specific examples of the antistatic layer are described in JP-A No. 11-65021, Paragraph 0135; JP-A Nos. 56-143430, 56-143431, 58-62646, and 56-120519; JP-A No. 11-84573, Paragraph 0040 to 0051; U.S. Pat. No. 5,575,957; and JP-A No. 11-223898, Paragraph 0078 to 0084; the disclosures of which are incorporated herein by reference.

10) Support

The support comprises preferably a heat-treated polyester, particularly a polyethylene terephthalate, which is subjected to a heat treatment at 130 to 185° C. so as to relax the internal strains of the film generated during biaxial stretching, thereby eliminating the heat shrinkage strains during heat development. In the case of a photothermographic material for medical use, the support may be colored with a blue dye (e.g., Dye-1 described in Examples of JP-A No. 8-240877, the disclosure of which is incorporated herein by reference) or uncolored. The support is preferably undercoated, for example, with a water-soluble polyester described in JP-A No. 11-84574, a styrene-butadiene copolymer described in JP-A No. 10-186565, a vinylidene chloride copolymer described in JP-A No. 2000-39684 or Japanese Patent Application No. 11-106881, Paragraph 0063 to 0080, the disclosures of which are incorporated herein by reference. When the support is coated with the image-forming layer or the back layer, the support preferably has a moisture content of 0.5% by mass or lower.

11) Other Additives

The photothermographic material of the invention may further include additives such as antioxidants, stabilizing agents, plasticizers, UV absorbers, and coating aids. The additives may be added to any one of the image-forming layer and the non-photosensitive layers. The additives may be used with reference to WO 98/36322, EP-A No. 803764A1, JP-A Nos. 10-186567 and 10-18568, the disclosures of which are incorporated herein by reference.

12) Coating Method

The photothermographic material of the invention may be formed by any coating method. Specific examples of the coating method include extrusion coating methods, slide coating methods, curtain coating methods, dip coating methods, knife coating methods, flow coating methods, extrusion coating methods using a hopper described in U.S. Pat. No. 2,681,294, the disclosure of which is incorporated herein by reference. The coating method is preferably an extrusion coating method described in Stephen F. Kistler and Petert M. Schweizer, Liquid Film Coating, Page 399 to 536 (CHAPMAN & HALL, 1997) (the disclosure of which is incorporated herein by reference), or a slide coating method, more preferably a slide coating method. Examples of slide coaters for the slide coating methods are described in the above reference, Page 427, FIG. 11b.1. Two or more layers may be simultaneously formed by any of methods described in the above reference, Page 399 to 536, and methods described in U.S. Pat. No. 2,761,791 and British Patent No. 837,095, the disclosures of which are incorporated herein by reference. Particularly preferred coating methods used in the invention include those described in JP-A Nos. 2001-194748, 2002-153808, 2002-153803, and 2002-182333, the disclosures of which are incorporated herein by reference.

In the invention, the coating liquid for the image-forming layer is preferably a so-called thixotropy fluid. The thixotropy fluid may be used with reference to JP-A No. 11-52509, the disclosure of which is incorporated herein by reference. The viscosity of the coating liquid for the image-forming layer is preferably 400 to 100,000 mPa.s at a shear rate of 0.1 S⁻¹, more preferably 500 to 20,000 mPa.s at a shear rate of 0.1 S⁻¹. Further, the viscosity of the coating liquid is preferably 1 to 200 mPa.s at a shear rate of 1,000 S⁻¹, more preferably 5 to 80 mPa.s at the shear rate of 1,000 S⁻¹.

In the preparation of the coating liquid, it is preferable to use a known in-line mixing apparatus or a known in-plant mixing apparatus when two or more liquids are mixed. An in-line mixing apparatus described in JP-A No. 2002-85948 and an in-plant mixing apparatus described in JP-A No. 2002-90940 can be preferably used in the invention. The disclosures of the above patent documents are incorporated by reference herein.

The coating liquid is preferably subjected to a defoaming treatment to obtain an excellent coating surface. Preferred methods for the defoaming treatment are described in JP-A No. 2002-66431, the disclosure of which is incorporated herein by reference.

In or before the application of the coating liquid, the support is preferably subjected to electrical neutralization so as to prevent adhesion of dusts, dirts, etc. caused by the electrification of the support. Preferred examples of the neutralizing methods are described in JP-A No. 2002-143747, the disclosure of which is incorporated herein by reference.

When a non-setting type coating liquid for the image-forming layer is dried, it is important to precisely control drying air and drying temperature. Preferred drying methods are described in detail in JP-A Nos. 2001-194749 and 2002-139814, the disclosures of which are incorporated herein by reference.

The photothermographic material of the invention is preferably heat-treated immediately after coating and drying, so as to increase the film properties. In a preferable embodiment, the heating temperature of the heat treatment is controlled such that the film surface temperature is 60 to 100° C. The heating time is preferably 1 to 60 seconds. The film surface temperature in the heat treatment is more preferably 70 to 90° C., and the heating time is more preferably 2 to 10 seconds. Preferred examples of the heat treatments are described in JP-A No. 2002-107872, the disclosure of which is incorporated herein by reference.

Further, the production methods described in JP-A Nos. 2002-156728 and 2002-182333 (the disclosures of which are incorporated herein by reference) can be preferably used to stably produce the photothermographic material of the invention continuously.

The photothermographic material of the invention is preferably a monosheet type material, which can form an image on the material without using another sheet such as an image-receiving material.

13) Packaging Material

It is preferable to pack the photosensitive material of the invention in a packaging material having a low oxygen permeability and/or a low water permeability so as to prevent deterioration of the photographic properties during storage or to prevent curling. The oxygen permeability is preferably 50 ml/atm·m²·day or lower at 25° C., more preferably 10 ml/atm·m²·day or lower at 25° C., furthermore preferably 1.0 ml/atm·m²·day or lower at 25° C. The water permeability is preferably 10 g/atm·m²·day or lower, more preferably 5 g/atm·m²·day or lower, furthermore preferably 1 g/atm·m²·day or lower.

Specific examples of the packaging material having a low oxygen permeability and/or a low water permeability include materials described in JP-A Nos. 8-254793 and 2000-206653, the disclosures of which are incorporated herein by reference.

14) Other Technologies

Other technologies usable for the photothermographic material of the invention include those described in EP-A Nos. 803764A1 and 883022A1, WO 98/36322, and JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546, and 2000-187298, the disclosures of which are incorporated herein by reference.

In the case a multi-color photothermographic material, the image-forming layers are generally separated from each other by providing functional or non-functional barrier layers between them as described in U.S. Pat. No. 4,460,681, the disclosure of which is incorporated herein by reference.

The multicolor photothermographic material may comprise a combination of two layers for each color or a single layer including all the components as described in U.S. Pat. No. 4,708,928, the disclosure of which is incorporated herein by reference.

3. Image Forming Method

1) Exposure

The exposure light source may be a red to infrared emission laser such as an He—Ne laser and a red semiconductor laser, or a blue to greed emission laser such as an Ar⁺ laser, an He—Ne laser, an He—Cd laser, and a blue semiconductor laser. The laser is preferably a red to infrared emission semiconductor laser, and the peak wavelength of the laser is 600 to 900 nm, preferably 620 to 850 nm. The laser is more preferably an infrared semiconductor laser (780 nm, 810 nm) because such a laser has high power and because the photothermographic material of the invention can be transparent.

In recent years, a blue semiconductor laser and a module comprising an SHG (Second Harmonic Generator) and a semiconductor laser have been developed, and thus laser output units with short wavelength ranges have attracted a lot of attention. Blue semiconductor lasers can form a highly fine image, can increase recording density, is long-lived, and has stable output, whereby the demand for blue semiconductor lasers is expected to be increased. The peak wavelength of the blue laser is preferably 300 to 500 nm, more preferably 400 to 500 nm.

In a preferable embodiment, the laser light is emitted in vertical multimode by high frequency superposition, etc.

2) Heat Development

The photothermographic material of the invention may be developed by any method, but is generally exposed imagewise and then heat-developed. The development temperature is preferably 80 to 250° C., more preferably 100 to 140° C., further preferably 110 to 130° C. The development time is preferably 1 to 60 seconds, more preferably 3 to 30 seconds, furthermore preferably 5 to 25 seconds, particularly preferably 7 to 15 seconds.

The photothermographic material of the invention can be developed even when the material is conveyed at a high conveying speed of 23 mm/sec or higher at heat development.

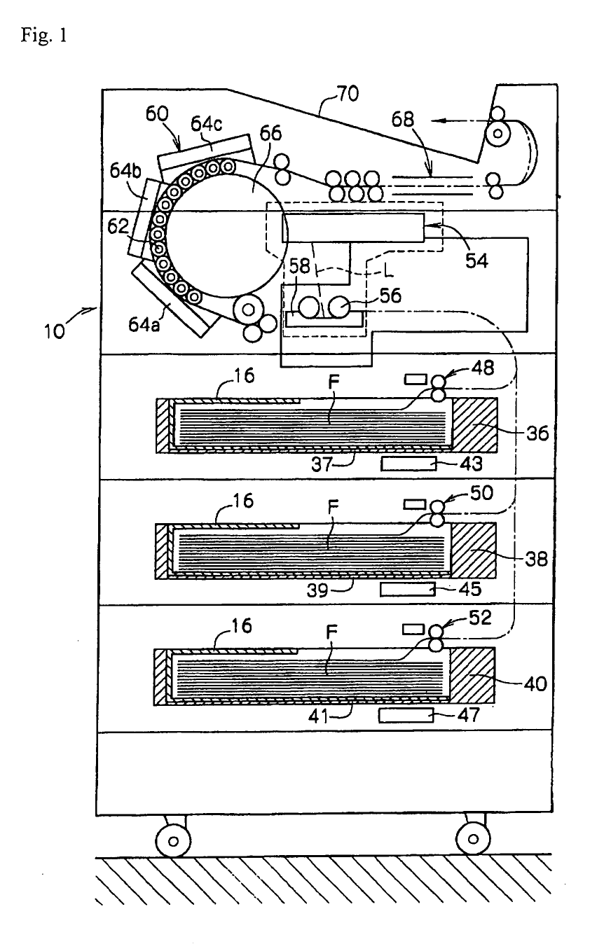

Heat development may be conducted by a drum heater or a plate heater, preferably by a drum heater. Further, when a protective layer is present on or over the image-forming layer, it is preferable to conduct a heat treatment by bringing the surface on the protective layer side into contact with a heating device in view of uniform heating, heat efficiency and operation efficiency. In a preferable embodiment, development is conducted by bringing the surface on the protective layer side into contact with the heater while conveying the photothermographic material. An example of the heat developing apparatus is shown in FIG. 1. Inside of an image recording apparatus 10 shown in FIG. I is to be described. Reference numerals 36 38, and 40 each represent a tray, reference numeral 16 represents a support paper, reference numerals 37, 39, and 41 each represents a bar code reading frame, reference numerals 43, 45, and 47 each represents a bar code reader. A film F is sent through a sheet feeding mechanism 48, 50 or 52 to a plate 58. A roller 56 is positioned on the plate 58 where the film F is exposed by a laser beam L from an image recording station 54. The film after exposure is sent by a roller 62 along the periphery of a drum 66 to a plate heater 64a, then to a plate heater 64b and, further, to a plate heater 64c, and developed thermally. Reference numeral 60 denotes a heat developing unit. Successively, the film F is cooled in a cooling station 68 and then discharged to a discharge station 70.

3) System

Fuji Medical Dry Laser Imager FM-DPL and DRYPIX 7000 and Kodak DRYVIEW 8700 Laser Imager Plus are known as laser imagers for medical use comprising an exposure region and a heat developing region. FM-DPL is described in Fuji Medical Review, No. 8, Page 39 to 55 (the disclosure of which is incorporated herein by reference), and the technologies disclosed therein can be applied to the invention. The photothermographic material of the invention can be used for the laser imager in AD Network, proposed by Fuji Film Medical Co., Ltd. as a network system according to DICOM Standards.

4) Dependence on Environmental Condition

The environment at exposure and heat development of the photothermographic material fluctuates continuously. The fluctuation of the environment includes seasonal fluctuation, daily fluctuation or hourly fluctuation within one day.

Factors for causing fluctuation include temperature and humidity. The fluctuation is a complicate phenomenon and the degree of fluctuation varies depending on the length of time which the material is left under such environmental conditions. While the seasonal fluctuation can be coped with by adjusting the condition setting at the turning of every seasons, it is not impossible to cope with the daily fluctuation or hourly fluctuation within one day.

Accordingly, the photothermographic material is preferably such that the material shows only a small performance change against the fluctuations and that a constant performance can be obtained under constant exposure and heat developing conditions. The photothermographic material according to the invention has less environmental dependency and is advantageous also in this respect.

### APPLICATION OF THE INVENTION

The photothermographic material of the invention forms black and white images of silver and is preferably used as a photothermographic material for medical diagnosis, industrial photography, printing, or COM. The photothermographic material of the invention is particularly preferably used as a photothermographic material for medical diagnosis.

### EXAMPLES

The present invention is to be described specifically by way of Examples. However, Examples should not be construed as limiting the invention.

### Example 1

1. Preparation of PET Support

1) Film Preparation

PET with an inherent viscosity IV=0.66 (measured in phenol/tetrachloroethane=6/4 (weight ratio) at 25° C.) was prepared using terephthalic acid and ethylene glycol in accordance with a usual method. After pelleting the product, it was dried at 130° C. for 4 hours, melted at 300° C., and then extruded from a T die and cooled rapidly to prepare a non-stretched film.

The film was stretched longitudinally by 3.3 times at 110° C. using rolls of different circumferential speeds and then stretched laterally by 4.5 times at 130° C. by a tenter. Subsequently, it was thermally set at 240° C. for 20 sec and then relaxed by 4% in the lateral direction at the same temperature. Then, after slitting the chuck portion of the tenter, both ends thereof were knurled, and the film was taken up under 4 kg/cm², to obtain a roll with a thickness of 175 μm.

2) Surface Corona Treatment

Both surfaces of the support were treated by a solid state corona processing machine model 6 KVA manufactured by Pillar Co. at room temperature at 20 m/min. Based on the measured current and voltage, it was found that a treatment at 0.375 kV·A·min/m² was applied to the support. The processing frequency was 9.6 kHz and the gap clearance between the electrode and the dielectric roll was 1.6 mm.

3) Undercoating

(1) Preparation of Undercoating Layer Coating Liquid

Formulation (1) (for undercoating layer on the image-forming layer side)

| | | |
|---|---|---|
| PESRESIN A-520 (30 mass % solution) manufactured by | 46.8 | g |
| Takamatsu Oils and Fats Co., Ltd. | | |
| VYLONAL MD-1200 manufactured by Toyo Boseki Co. | 10.4 | g |
| 1 mass % solution of polyethylene glycol mono nonyl phenyl | 11.0 | g |
| ether (average ethylene oxide number = 8.5) | | |
| MP-1000 (fine PMMA polymer particles, average | 0.91 | g |
| particle diameter 0.4 μm) manufactured by Soken Kagaku Co. | | |
| Distilled water | 931 | ml |

Formulation (2) (for first layer on back surface)

| | | |
|---|---|---|
| Styrene-butadiene copolymer latex (solid content 40 mass %, | 130.8 | g |
| styrene/butadiene weight ratio = 68/32) | | |
| Aqueous 8 mass % solution of sodium salt of 2.4-dichloro-6- | 5.2 | g |
| hydroxy-S-triazine | | |
| Aqueous 1 mass % solution of sodium lauryl benzene | 10 | ml |
| sulfonate | | |
| Polystyrene particle dispersion (average particle diameter | 0.5 | g |
| 2 μm, 20 mass %) | | |
| Distilled water | 854 | ml |

Formulation (3) (for second layer on back surface)

| | | |
|---|---|---|
| SnO₂/SbO (9/1 mass ratio, average particle diameter 0.5 μm, | 84 | g |
| 17 mass % dispersion) | | |
| Gelatin | 7.9 | g |
| METROSE TC-5 (aqueous 2 mass % solution) manufactured | 10 | g |
| by Shinetsu Chemical Industry Co. | | |
| Aqueous 1 mass % solution of sodium dodecylbenzene | 10 | ml |
| sulfonate | | |
| NaOH (1 mass %) | 7 | g |
| PROXEL (manufactured by Avecia Co.) | 0.5 | g |
| Distilled water | 881 | ml |

(2) Undercoating

After applying the corona discharging treatment described above to both surfaces of the biaxially stretched polyethylene terephthalate support having a thickness of 175 μm, the undercoating coating liquid formulation (1) described above was coated on one side (side on which image-forming layer was to be provided) by a wire bar in a wet coating amount of 6.6 ml/m² (per one side), and then dried at 180° C. for 5 min. Then, the undercoating coating liquid formulation (2) described above was coated on the rear face (back side) thereof by a wire bar in a wet coating amount of 5.7 ml/m² and dried at 180° C. for 5 min. Further, the undercoating coating liquid formulation (3) described above was coated on the rear face (back side) by a wire bar in a wet coating amount of 8.4 ml/m², and dried at 180° C. for 6 min to prepare an undercoated support.

2. Back Layer

1) Preparation of Back Layer Coating Liquid

(Preparation of Dye A Liquid Dispersion)

250 g of water was added to 15 g of dye A and 6.4 g of DEMOLE N manufactured by Kao Corporation and mixed thoroughly to form a slurry. 800 g of zirconia beads with an average diameter of 0.5 mm was charged, together with the slurry, in a vessel, and dispersed for 25 hours in a dispersing apparatus (¼ G sand grinder mill: manufactured by Imex Co., Ltd.), and then water was added thereto such that the dye concentration became 5 mass %. A dispersion of dye A was obtained in this way.

(Preparation of Antihalation Layer Coating Liquid)

A vessel was kept at a temperature of 40° C. 37 g of gelatin with an isoelectric point of 4.8 (PZ Gelatin, manufactured by Miyagi Chemical Industry Co.), 0.1 g of benzoisothiazolinone and water were added to the vessel, and the gelatin was dissolved. Further, 43 ml of an aqueous 3 mass % solution of sodium polystyrene sulfonate, 82 g of a 10 mass % liquid of SBR latex (styrenelbutadiene/acrylic acid copolymer; mass ratio 68.3/28.7/3.0), and 40 g of the dispersion of dye A were added thereto to give an antihalation layer coating liquid.

2) Preparation of Back Surface Protective Layer Coating Liquid

A vessel was kept at a temperature of 40° C. 43 g of gelatin with an isoelectric point of 4.8 (PZ Gelatin, manufactured by Miyagi Chemical Industry Co.), 0.21 g of benzoisothiazolinone and water were added to the vessel and the gelatin was dissolved. Further, 8.1 ml of a 1 mol/L aqueous solution of sodium acetate, 0.93 g of fine particles of mono-dispersed poly(ethylene glycol dimethacrylate-co-methylmethacrylate) (average particle diameter: 7.7 μm, standard deviation of particle diameter: 0.3 μm), 5 g of a 10 mass % emulsion of liquid paraffin, 10 g of a 10 mass % emulsion of dipentaerythritol hexaisostearate, 10 ml of an aqueous 5 mass % solution of sodium salt of di(2-ethylhexyl)sulfosuccinate, 17 ml of an aqueous 3 mass % solution of sodium polystyrene sulfonate, 2.4 ml of a 2 mass % solution of a fluorine-based surfactant (F-1), 2.4.ml of a 2 mass % solution of a fluorine-based surfactant (F-2), and 30 ml of a 20 mass % latex of ethyl acrylate/acrylic acid copolymer (copolymerization mass ratio 96.4/3.6) were mixed with the gelatin solution. Just before coating, 50 ml of an aqueous 4 mass % solution of N,N-ethylenebis(vinylsulfone acetamide) was added thereto to form a back surface protective layer coating liquid with a final liquid quantity of 855 ml. 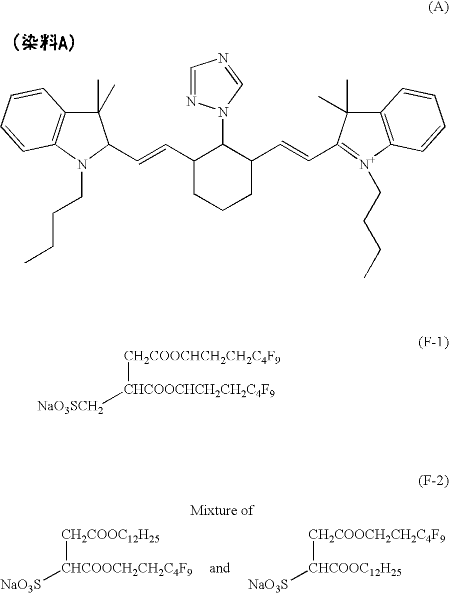
3) Coating of Back Layer

On the back surface of the undercoated support, the antihalation layer coating liquid and the back surface protective layer coating liquid were simultaneously coated by multi-layer coating method, and then dried to form a back layer. The coating amount of the antihalation layer coating liquid was such an amount that the gelatin coating amount was 1.0 g/m². The coating amount of the back surface protective layer coating liquid was such an amount that the gelatin coating amount was 1.0 g/m².

(Image-Forming Layer and Surface Protective Layer)

1. Preparation of Coating Material

1) Silver Halide Emulsion

<Preparation of Silver Halide Emulsion 1>

3.1 ml of a 1 mass % potassium bromide solution was added to 1421 ml of distilled water. Then, 3.5 ml of sulfuric acid at 0.5 mol/l concentration and 31.7 g of phthalated gelatin were added thereto. The mixture was stirred in a stainless steel reaction pot while its temperature was kept at 30° C. Separately, a solution A was prepared by adding distilled water to 22.22 g of silver nitrate such that the total volume became 95.4 ml. A solution B was prepared by adding distilled water to 15.3 g of potassium bromide and 0.8 g of potassium iodide such that the total volume became 97.4 ml. The entire solution A and the entire solution B were added to the reaction pot at a constant flow rate over 45 sec.

Then, 10 ml of an aqueous 3.5 mass % hydrogen peroxide solution was added thereto and, further, 10.8 ml of an aqueous 10 mass % benzimidazole solution was added thereto. Separately, a solution C was prepared by adding distilled water to 51.86 g of silver nitrate such that the total volume became 317.5 ml. A solution D was prepared by adding distilled water to 44.2 g of potassium bromide and 2.2 g of potassium iodide such that the total volume became 400 ml. The solutions C and D were added to the above mixture by a controlled double jet method; the entire solution C was added at a constant flow rate over 20 min, and the solution D was added while pAg of the solution D was maintained at 8.1.

Potassium hexachloro iridate (III) was added to the above mixture 10 min after the start of addition of the solutions C and D such that its concentration became 1×10⁻⁴ mol per one mol of silver. Further, an aqueous solution of potassium hexacyano ferrate (II) was added in an amount of 3×10⁻⁴ mol per one mol of silver 5 sec after the completion of addition of the solution C. The pH of the mixture was adjusted to 3.8 using sulfuric acid at 0.5 mol/L concentration, and stirring was stopped. Then, sedimentation, desalting, and water washing were conducted. The pH was adjusted to 5.9 using sodium hydroxide at 1 mol/L concentration to prepare a silver halide dispersion having a pAg of 8.0.

The silver halide dispersion was kept at 38° C. while stirred. 5 ml of 0.34 mass % solution of 1,2-benzoisothiazoline-3-one in methanol was added thereto. 40 min later, the temperature of the dispersion was elevated to 47° C. 20 min after the temperature elevation, a solution of sodium benzenethiosulfonate in methanol was added thereto such that the concentration of sodium benzenethiosulfonate became 7.6×10⁻⁵ mol per one mol of silver. 5 min later, a solution of a tellurium sensitizer C in methanol was added thereto such that the concentration of tellurium sensitizer C became 2.9×10⁻⁴ mol per one mol of silver. Then, the dispersion was subjected to aging for 91 min.

Then, a methanol solution of spectral sensitizing dyes A and B in a molar ratio of 3:1 was added to the dispersion such that the total quantity of the sensitizing dyes A and B became 1.2×10⁻³ mol per one mol of silver. One min later, 1.3 ml of a 0.8 mass % solution of N,N′-dihydroxy-N″,N″-diethylmelamine in methanol was added to the dispersion. 4 min later, a solution of 5-methyl-2-mercaptobenzimidazole in methanol, a solution of 1-phenyl-2-heptyl-5-mercapto-1,3,4-triazole in methanol, and a solution of 1-(3-methylureidophenyl)-5-mercaptotetrazole in water were added to the dispersion such that the concentration of 5-methyl-2-mercaptobenzimidazole became 4.8×10⁻³ mol per one mol of silver, the concentration of 1-phenyl-2-heptyl-5-mercapto-1,3,4-triazole became 5.4×10⁻³ mol per one mol of silver, and the concentration of an aqueous solution of 1-(3-methylureidophenyl)-5-mercaptotetrazole was 8.5×10⁻³ mol per one mol of silver. In this way, a silver halide emulsion 1 was obtained.

The grains in the silver halide emulsion thus prepared were silver iodobromide grains with an average equivalent sphere diameter of 0.042 μm and a variation coefficient of equivalent sphere diameter of 20% homogeneously containing 3.5 mol % of iodide. The grain diameter and the like were determined based on the average of 1000 grains using an electron microscope. The [100] face ratio of the grain was determined by the Kubelka-Munk method, and was found to be 80%.

<Preparation of Silver Halide Emulsion 2>

A silver halide emulsion 2 was prepared in the same manner as in the preparation of the silver halide emulsion 1 except that the liquid temperature upon grain formation was changed from 30° C. to 47° C., that the solution B was obtained by adding distilled water to 15.9 g of potassium bromide to make the total volume 97.4 ml, that the solution D was obtained by adding distilled water to 45.8 g of potassium bromide to make the total volume 400 ml, that the addition time of the solution C was changed to 30 min, and that potassium hexacyano ferrate (II) was omitted. Sedimentation, desalting, water washing, and dispersing operations were conducted in the same manner as in the preparation of the silver halide emulsion 1. Spectral sensitization, chemical sensitization, and addition of 5-methyl-2-mercaptobenzimidazole and 1-phenyl-2-heptyl-5-mercapto-1,3,4-triazole were conducted in the same manner as in the preparation of the silver halide emulsion 1 except that the addition amount of the tellurium sensitizer C was changed to 1.1×10⁻⁴ mol per one mol of silver, that the addition amount of the methanol solution of the spectral sensitizing dyes A and B in the molar ratio of 3:1 was changed to 7.0×10⁻⁴ mol per one mol of silver in terms of the total amount of the sensitizing dyes A and B, that the addition amount of 1-phenyl-2-heptyl-5-mercapto-1,3,4-triazole was changed to 3.3×10⁻³ mol per one mol of silver, and that the addition amount of 1-(3-methylureidophenyl)-5-mercaptotetrazole was changed to 4.7×10⁻³ mol per one mol of silver. The silver halide emulsion 2 was obtained in this manner.

The emulsion grains of the silver halide emulsion 2 were pure silver bromide cubic grains with an average equivalent sphere diameter of 0.080 μm and a variation coefficient of the equivalent sphere diameter of 20%.

<Preparation of Silver Halide Emulsion 3>

A silver halide emulsion 3 was prepared in the same manner as in the preparation of the silver halide emulsion 1 except for changing the liquid temperature upon grain formation from 30° C. to 27° C.

Sedimentation, desalting, water washing, and dispersion operations were conducted in the same manner as in the preparation of the silver halide emulsion 1. A silver halide emulsion 3 was obtained in the same manner as in the preparation of the silver halide emulsion 1 except that the addition amount of the tellurium sensitizer C was changed to 5.2×10⁻⁴ mol per one mol of silver, that a solid dispersion (in aqueous gelatin solution) of the spectral sensitizing dyes A and B in the molar ratio of 1:1 was added in an amount of 6.0×10⁻³ mol per one mol of silver in terms of the total amount of the sensitizing dyes A and B instead of the methanol solution of the spectral sensitizing dyes A and B, that 5×10⁻⁴ mol of bromoauric acid per one mol of silver and 2×10⁻³ mol of potassium thiocyanate per one mol of silver were added 3 min after the addition of the tellurium sensitizer. The emulsion grains of the silver halide emulsion 3 were silver iodobromide grains with an average equivalent sphere diameter of 0.034 μm and with a variation coefficient of the equivalent sphere diameter of 20% homogeneously containing 3.5 mol % of iodide.

(Preparation of Silver Halide Emulsions 4, 5, and 6)

A silver halide emulsion 4 with an average equivalent sphere diameter of 0.053 μm, a silver halide emulsion 5 with an average equivalent sphere diameter of 0.101 μm, and silver halide emulsion 6 with an average equivalent sphere diameter of 0.043 μm were prepared by controlling the liquid temperature upon grain formation and the addition amounts of additives such as the amount of the sensitizer, such that the average equivalent sphere diameters were 1.26 times the average equivalent sphere diameters of the silver halide emulsion 1, 2, and 3 respectively.

(Preparation of Mixed Emulsions 1 to 9 for Coating Liquids)

70 mass % of the silver halide emulsion 1, 15 mass % of the silver halide emulsion 2, and 15 mass % of the silver halide emulsion 3 were mixed, and an aqueous 1 mass % solution of benzothiazolium iodide was added thereto such that the concentration of the benzothiazolium iodide became 7×10⁻³ mol per one mol of silver.

The mixed emulsion was divided. Then, a compound whose 1-electron oxidized form formed by 1-electron oxidation can release 1 electron or more electrons and a compound having an adsorbent group and a reducing group in respectively optimized amounts were added to the mixed emulsion. The types of the compounds are shown in Table 1.

In the mixed emulsion 9 for coating liquid, the silver halide emulsions 4, 5, and 6 were used instead of the silver halide emulsions 1, 2, and 3 respectively.

Finally, water was added such that the content of the silver halide per 1 kg of the mixed emulsion for coating liquid was 38.2 g in terms of the silver amount.

2) Preparation of Fatty Acid Silver Salt Dispersion

(Preparation of Recrystallized Behenic Acid)

100 kg of behenic acid manufactured by Henkel Co. (trade name of product; EDENOR C 22-85R) was mixed with 1200 kg of isopropyl alcohol, and dissolved at 50° C., filtered through a 10 μm filter, and then cooled to 30° C. to be recrystallized. The cooling rate at recrystallization was adjusted to 3° C./hr. The resultant crystal was centrifugally filtered, washed with shower of 100 kg of isopropyl alcohol and then dried. When the obtained crystal was esterified and measured by GC-FID, it was found that behenic acid content was 96 mol %, lignoceric acid content was 2 mol %, arachidic acid content was 2 mol %, and erucic acid content was 0.001 mol %.

(Preparation of Nano Particles of Silver Behenate)

First, deionized water, a 10% solution of dodecylthiopolyacrylamide surfactant (72 g) and the recrystallized behenic acid described above (46.6 g) were charged in a reactor. The content in the reactor was stirred at 150 rpm, and heated to 70° C. during which a 10 mass % KOH solution (70.6 g) was charged in a reactor. Then, the content in the reactor was heated to 80° C. and kept for 30 min till it turns into a cloudy solution. Then, the reaction mixture was cooled to 70° C. and a silver nitrate solution comprising 21.3 g of silver nitrate (100%) was added to the reactor over 30 min while controlling the addition rate. Then, the content in the reactor was kept at the reaction temperature for 30 min, cooled to room temperature and then subjected to decantation. As a result, a dispersion of nano-particles of silver behenate having a median particle diameter of 150 nm was obtained (with a solid content of 3%).

(Purification and Concentration of Nano Particles of Silver Behenate)

The dispersion of the nano particles of silver behenate with a solid content of 3 mass % (12 kg) was charged in a diafiltration/ultrafiltration apparatus (having a osmotic membrane cartridge of Osmonics model 21-HZ20-S8J with an effective surface area of 0.34 m² and a nominal cut-off molecular weight of 50,000). The apparatus was operated such that the pressure on the osmotic membrane was 3.5 kg/cm² (50 lb/in²) and the pressure of the downstream of the osmotic membrane was 1.4 kg/cm² (20 lb/in²). The osmotic liquid was replaced with deionized water till 24 g of permeate was removed from the dispersion. Water for substitution was stopped at this stage, and the apparatus was operated till the solid content of the dispersion reached 28 mass %, to obtain a dispersion of the nano particles of silver behenate.

3) Preparation of Reducing Agent Dispersion

10 kg of water was added to 10 kg of a reducing agent 1 (2,2′-(3,5,5-trimethylhexylidene)bis(4,6-dimethlphenol)) and 16 kg of an aqueous 10 mass % solution of modified polyvinyl alcohol (POVAL MP203, manufactured by Kuraray Co.) and they were mixed thoroughly to form a slurry. The slurry was fed by a diaphragm pump, and was dispersed for 3 hrs by a horizontal sand mil (UVM-2; manufactured by Imex Co.) filled with zirconia beads with an average diameter of 0.5 mm. Then 0.2 g of sodium salt of benzoisothiazolinone and water were added thereto such that the concentration of the reducing agent became 25 mass %. The obtained dispersion was heated to 60° C. and maintained at 60° C. for 5 hours to form a reducing agent 1 dispersion. The reducing agent particles contained in the thus obtained reducing agent dispersion had a median diameter of 0.40 μm and a maximum particle diameter of 1.4 μm or less. The obtained reducing agent dispersion was filtered through a polypropylene filter of 3.0 μm pore size so that contaminants such as dusts were removed. The reducing agent dispersion was then stored.

4) Preparation of Polyhalogen Compound

<Preparation of Organic Polyhalogen Compound 1 Dispersion>

10 kg of an organic polyhalogen compound 1 (tribromo methanesulfonyl benzene), 10 kg of an aqueous 20 mass % solution of modified polyvinyl alcohol (POVAL MP203, manufactured by Kuraray Co.), 0.4 kg of an aqueous 20 mass % solution of sodium triisopropyl naphthalene sulfonate, and 14 kg of water were mixed thoroughly to form a slurry. The slurry was fed by a diaphragm pump and dispersed in a horizontal type sand mill filled with zirconia beads with an average diameter of 0.5 mm (UVM-2: manufactured by Imex Co.) for 5 hours and then 0.2 g of sodium salt of benzoisothiazolinone and water were added thereto such that the concentration of the organic polyhalogen compound became 26 mass %. An organic polyhalogen compound 1 dispersion was obtained in this way.

The obtained organic polyhalogen compound particles contained in the organic polyhalogen compound dispersion had a median diameter of 0.41 μm and a maximum particle diameter of 2.0 μm or less. The obtained organic polyhalogen compound dispersion was filtered through a polypropylene filter having a pore size of 10.0 μm so that contaminants such as dusts were removed. The organic polyhalogen compound dispersion was then stored.

(Preparation of Organic Polyhalogen Compound 2 Dispersion)

10 kg of an organic polyhalogen compound 2 (N-butyl-3-tribromomethanesulfonyl benzamide), 20 kg of an aqueous 10 mass % solution of modified polyvinyl alcohol (POVAL MP203, manufactured by Kuraray Co.), and 0.4 kg of an aqueous 20 mass % solution of sodium triisopropyl naphthalene sulfonate were mixed thoroughly to form a slurry. The slurry was fed by a diaphragm pump and dispersed in a horizontal type sand mill filled with zirconia beads with an average diameter of 0.5 mm (UVM-2: manufactured by Imex Co.) for 5 hours and then 0.2 g of sodium salt of benzoisothiazolinone and water were added thereto such that the concentration of the organic polyhalogen compound became 30 mass %. The dispersion was heated to 40° C. and maintained at 40° C. for 5 hours to form a polyhalogen compound 2 dispersion. The obtained organic polyhalogen compound particles contained in the organic polyhalogen compound dispersion had a median diameter of 0.40 μm and a maximum particle diameter of 1.3 μm or less. The obtained organic polyhalogen compound dispersion was filtered through a polypropylene filter having a pore size of 3.0 μm so that contaminants such as dusts were removed. The organic polyhalogen compound was then stored.

5) Preparation of Pigment 1 Dispersion

250 g of water was added to 64 g of C.I. Pigment Blue 60 and 6.4 g of DEMOLE N manufactured by Kao Corp. and they were mixed thoroughly to form a slurry. 800 g of zirconia beads with an average diameter of 0.5 mm were charged together with the slurry in a vessel and dispersed by a dispersing apparatus (¼ G sand grinder mill, manufactured by Imex Co.) for 25 hours. Then, water was added thereto such that the pigment concentration became 5 mass %. In this way, a pigment 1 dispersion was obtained. The average particle diameter of the pigment particles contained in the obtained pigment dispersion was 0.21 μm.

6) Preparation of Aqueous Solution

The aqueous solutions of the following compounds were prepared and added.

Compound of the Formula (I) or (II)

An aqueous 5 mass % solution of succinimide was prepared.

Preparation of an Aqueous Solution of 4-methylphthalic Acid

A 5 mass % aqueous solution of 4-methylphthalic acid was prepared.

2. Preparation of Coating Liquid

1) Preparation of Image-Forming Layer Coating Liquids 1 to 9

450 ml of water and 200 g of gelatin were charged in a vessel kept at a temperature of 40° C. The gelatin was dissolved, and then the fatty acid silver salt dispersion, the pigment 1 dispersion, the organic polyhalogen compound 1 dispersion, the organic polyhalogen compound 2 dispersion, the aqueous solution of succinimide, the reducing agent dispersion, the aqueous solution of 4-methylphthalic acid and sodium iodide were added successively to the gelatin solution. Then, the mixed emulsion for coating liquids shown in Table 1 selected from mixed emulsions 1 to 9 was added thereto just before coating. The components in the mixture were mixed thoroughly to form an image-forming layer coating liquid. The image-forming layer coating liquid was directly fed to a coating die.

The amount of zirconium in the coating liquid was 0.18 mg per 1 g of silver.

2) Preparation of Surface Protective Layer Coating Liquid

2400 ml of water and 300 g of gelatin were charged in a vessel kept at a temperature of 40° C. The gelatin was dissolved, and 60 g of an aqueous 5 mass % solution of sodium salt of di(2-ethylhexyl)sulfosuccininate and 900 g of the aqueous succinimide solution were added successively to the gelatin solution. The mixture was stirred thoroughly to form a surface protective layer coating liquid.

3. Preparation of Photothermographic Material

On the undercoated surface on the opposite side to the back side, the image-forming layer coating liquid and the surface protective layer coating liquid were simultaneously coated in this order in a simultaneous multi-coating manner by a slide bead coating method to form a sample of a photothermographic material. In the coating operation, the temperatures of the image-forming layer coating liquid and the surface protective layer coating liquid were adjusted to 37° C.

The coating amount (g/m²) of each compound in the image-forming layer was as described below. Further, the surface protective layer was coated such that the dry coating amount of gelatin was 2.0 (g/m²).

| | |
|---|---|
| Fatty acid silver salt | 5.42 |
| Pigment (C. I. Pigment Blue 60) | 0.036 |
| Polyhalogen compound 1 | 0.10 |
| Polyhalogen compound 2 | 0.34 |
| 4-methylphthalic acid | 0.08 |
| Succinimide | 0.54 |
| Gelatin | 3.90 |
| Sodium iodide | 0.04 |
| Reducing agent 1 | 0.75 |
| Silver halide (in terms of Ag quantity) | 0.10 |

Chemical structures of the compounds used in the examples of the invention are shown below.

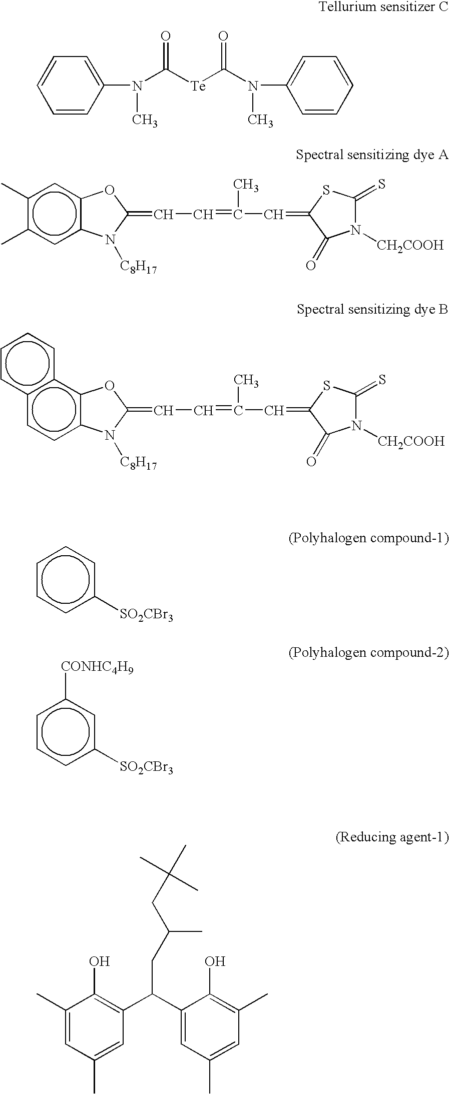

TABLE 1

| | Mixed | | | | | | | | | | |
|---|---|---|---|---|---|---|---|---|---|---|---|
| | emulsion | | | | | | | | | | |
| | for coating | Compound | Compound | Coating | Photographic | | Pre-use | | Environmental | | |
| Sample | liquid | PD* | RD** | surface | property | | storability | | dependence | | |
| No. | No. | Compound | Compound | state | Fogging | Sensitivity | fogging | sensitivity | Δ fogging | Δ sensitivity | Remarks |
| 1 | 1 | — | — | good | 0.19 | 100 | 0.21 | 76 | 5 | 17 | Comp. Example |
| 2 | 2 | A | — | good | 0.20 | 240 | 0.22 | 218 | 5 | 10 | Invention |
| 3 | 3 | B | — | good | 0.20 | 234 | 0.21 | 201 | 5 | 7 | Invention |
| 4 | 4 | C | — | good | 0.19 | 204 | 0.22 | 181 | 4 | 5 | Invention |
| 5 | 5 | — | D | good | 0.19 | 230 | 0.21 | 207 | 5 | 7 | Invention |
| 6 | 6 | — | E | good | 0.19 | 219 | 0.21 | 191 | 5 | 5 | Invention |
| 7 | 7 | — | F | good | 0.18 | 195 | 0.20 | 170 | 4 | 5 | Invention |
| 8 | 8 | A | D | good | 0.19 | 224 | 0.21 | 206 | 5 | 5 | Invention |
| 9 | 9 | — | — | good | 0.20 | 204 | 0.23 | 147 | 10 | 20 | Comp. Example |
| | | | | | | | | | | | (emulsion with |
| | | | | | | | | | | | larger grain size) |

Compound PD*: Compound whose 1-electron oxidized form formed by 1-electron oxidation can release one or more electron(s)
Compound RD**: Adsorbent redox compound having adsorbent group and reducing group

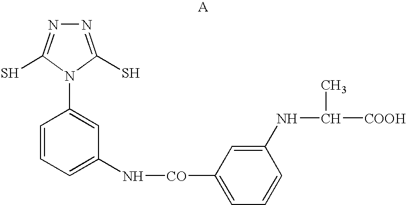

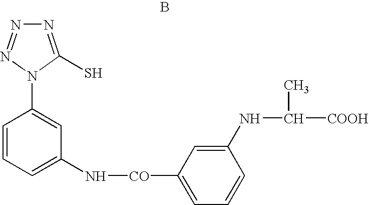

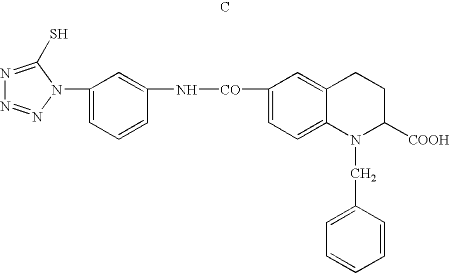

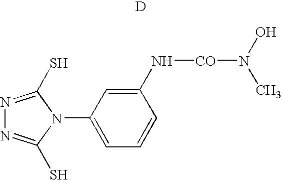

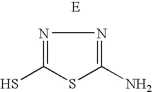

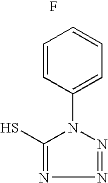

4. Evaluation of Performance
4-1 Coating Surface State

Defects such as coating streaks or contaminant spots caused by aggregates were not observed both in the samples of the invention and in the comparative samples, and they showed excellent surface state.

The results are shown in Table 1.

4-2 Photographic Property

1) Preparation

Each of the obtained samples was cut into the half size (43 cm in length×35 cm in width), and then packed in the following packaging material in an environment of 25° C., 50% RH. Thereafter, each sample was stored at normal temperature for 2 weeks, and then the following evaluations were conducted.

<Packaging Material>

Laminate film comprising (PET 10 μm)-(PE 12 μm)-(aluminum foil 9 μm)-(Ny 15 μm)-(polyethylene 50 μm containing 3 mass % of carbon):

oxygen permeability: 0.02 ml/atm·m²·25° C.·day

moisture permeability: 0.10 g/atm·m²·25° C.·day

2) Exposure and Development of Photothermographic Material

After exposing each sample by a laser at 810 nm, they were thermally developed by the heat developing apparatus having a drum heating device shown in FIG. 1. The conveyance speed for each sample was controlled such that the line speed in the heat developing unit was 23 mm/sec, that the temperature in the heating unit was 124° C., and that the heating time was 14 sec.

The obtained images were evaluated by a densitometer.

3) Evaluation Items

Fogging: Density in the non-image area was measured by a Macbeth densitometer;

Sensitivity: Sensitivity is based on the reciprocal of such exposure as to give the image density which is the fog density +1.0. The sensitivity of each sample is indicated by a relative value assuming the sensitivity of the sample No. 1 is 100;

Pre-use storability: The same evaluations as described above were conducted after storing each sample in an atmosphere of 35° C. and 40% RH for one week.

4-3. Environmental Dependence of Exposure and Heat Development

The difference between the photographic property under the following condition 1 and the photographic property under the following condition 2 was evaluated. In order to achieve equilibrium in the environment before conducting the test, the experiment was carried out after leaving the sample for three hours under the specified environmental conditions.

Condition 1 Temperature: 25° C., relative humidity: 40% RH

Condition 2 Temperature: 32° C., relative humidity: 75% RH

The minimum density Dmin (fogging) on each sample and the sensitivity of each sample were measured. The photothermographic material was evaluated based on the difference in fogging and sensitivity between the sample stored under the condition 1 and the sample stored under the condition 2, as represented by the following formula.
Δ=100×((condition 2)−(condition 1))/(condition 1)

As the difference is smaller, the property of the photothermographic material is better since the photothermographic material is less dependent on the environmental temperature and humidity.

4-4. Evaluation Results

The obtained results are shown in Table 1.

As is clear from Table 1, the photothermographic materials according to the invention were excellent in the coating surface state. Further, although the photothermographic materials of the invention had high sensitivity, they had better pre-use storability than the sample 9 whose sensitivity had been improved by a method different from the method of the invention. Further, the photothermographic materials of the invention showed extremely small environmental dependence.

As described above, the present invention provides a photothermographic material which has excellent coating surface state, high sensitivity, excellent pre-use storability, and less environmental dependence at exposure and heat development. The invention also provides an image forming method using the same.

What is claimed is:

1. A photothermographic material comprising a support and an image-forming layer provided on at least one side of the support, wherein the image-forming layer includes a photosensitive silver halide, a non-photosensitive organic silver salt, a reducing agent, and a binder, at least 50% by mass of the binder is a hydrophilic binder, the non-photosensitive organic silver salt has a silver behenate content of 50% by mol or higher, and the photothermographic material further comprises a compound represented by the following formula (I) or (II) as a silver carrier and a compound whose one-electron oxidized form is capable of releasing one or more electron(s): 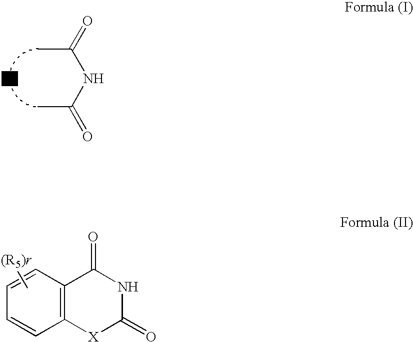
wherein in the formulae (I) and (II), Q represents an atomic group required for forming a five- or six-membered imide ring; R₅ represents a hydrogen atom, an alkyl group, a cycloalkyl group, an alkoxy group, an alkylthio group, an arylthio group, a hydroxy group, a halogen group, or N(R₈R₉); R₈ and R₉ each independently represent a hydrogen atom, an alkyl group, an aryl group, a cycloalkyl group, an alkenyl group, or a heterocyclyl group; r represents 0, 1 or 2; R₈ and R₉ may be bonded to each other to form a substituted or unsubstituted five- to seven-membered heterocyclic ring; when there are two R₅s, they may be the same as each other or different from each other, and they may be bonded to each other to form an aromatic, heteroaromatic, alicyclic, or heterocyclic condensed ring; X represents O, S, Se, or N(R₆); R₆ represents a hydrogen atom, an alkyl group, an aryl group, a cycloalkyl group, an alkenyl group, or a heterocyclyl group.

2. A photothermographic material comprising a support and an image-forming layer provided on at least one side of the support, wherein the image-forming layer includes a photosensitive silver halide, a non-photosensitive organic silver salt, a reducing agent, and a binder, at least 50% by mass of the binder is a hydrophilic binder, the non-photosensitive organic silver salt has a silver behenate content of 50% by mol or higher, the photothermographic material further comprises a compound represented by the following formula (I) or (II) as a silver carrier and an adsorbent redox compound having an adsorbent group and a reducing group: 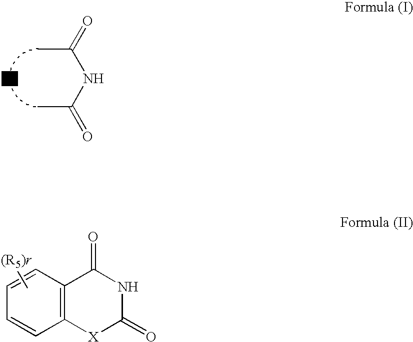
wherein in the formulae (I) and (II), Q represents an atomic group required for forming a five- or six-membered imide ring; R₅ represents a hydrogen atom, an alkyl group, a cycloalkyl group, an alkoxy group, an alkylthio group, an arylthio group, a hydroxy group, a halogen group, or N(R₈R₉); R₈ and R₉ each independently represent a hydrogen atom, an alkyl group, an aryl group, a cycloalkyl group, an alkenyl group, or a heterocyclyl group; r represents 0, 1 or 2; R₈ and R₉ may be bonded to each other to form a substituted or unsubstituted five- to seven-membered heterocyclic ring; when there are two R₅s, they may be the same as each other or different from each other, and they may be bonded to each other to form an aromatic, heteroaromatic, alicyclic, or heterocyclic condensed ring; X represents O, S, Se, or N(R₆); R₆ represents a hydrogen atom, an alkyl group, an aryl group, a cycloalkyl group, an alkenyl group, or a heterocyclyl group.

3. The photothermographic material according to claim 2, further comprising a compound whose one-electron oxidized form is capable of releasing one or more electron(s).

4. The photothermographic material according to claim 1, wherein the compound whose one-electron oxidized form is capable of releasing one or more electron(s) is
a) a compound whose one-electron oxidized form is capable of releasing one or more electron(s) through a bond-cleavage reaction, or
b) a compound whose one-electron oxidized form is capable of releasing one or more electrons after a bond-formation reaction.

5. The photothermographic material according to claim 2, wherein the adsorbent redox compound having an adsorbent group and a reducing group is a compound represented by formula (G):
A-(W)ₙ—B Formula (G)
wherein in formula (G), A represents a group capable of being adsorbed by the silver halide; W represents a divalent connecting group; n represents 0 or 1; and B represents a reducing group.

6. The photothermographic material according to claim 1, wherein the photothermographic material further comprises polyacrylamide or a derivative of polyacrylamide.

7. The photothermographic material according to claim 6, wherein particles of the non-photosensitive organic silver salt are formed in the presence of the polyacrylamide or derivative of polyacrylamide.

8. The photothermographic material according to claim 7, wherein the non-photosensitive organic silver salt particles are nano-particles.

9. The photothermographic material according to claim 8, wherein an average particle diameter of the nano-particles is 10 nm to 1000 nm.

10. The photothermographic material according to claim 1, wherein the reducing agent is a compound represented by the following formula (R): 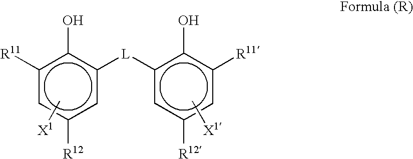
wherein in formula (R), R¹¹ and R^{11′} each independently represent an alkyl group; at least one of R¹¹ and R^{11′} represents a secondary or tertiary alkyl group; R¹² and R^{12′} each independently represent a hydrogen atom or a substituent which can be bonded to the benzene ring; L represents an —S— group or a —CHR¹³— group; R¹³ represents a hydrogen atom or an alkyl group; and X¹ and X^{1′} each independently represent a hydrogen atom or a substituent which can be bonded to the benzene ring.

11. The photothermographic material according to claim 1, wherein the hydrophilic binder is gelatin or a derivative of gelatin.

12. The photothermographic material according to claim 1, wherein the mass ratio of the non-photosensitive organic silver salt to the binder is in the range of 1.0 to 2.5.

13. The photothermographic material according to claim 1, wherein the photothermographic material further comprises a non-photosensitive layer containing gelatin or a gelatin derivative.

14. The photothermographic material according to claim 13, wherein the non-photosensitive layer is a surface protecting layer of the image-forming layer.

15. A method of forming an image comprising:
exposing the photothermographic material of claim 1; and
thermally developing the photothermographic material at a linear velocity of 23 mm/sec or higher.

16. The photothermographic material according to claim 2, wherein the photothermographic material further comprises polyacrylamide or a derivative of polyacrylamide.

17. The photothermographic material according to claim 16, wherein particles of the non-photosensitive organic silver salt are formed in the presence of the polyacrylamide or derivative of polyacrylamide.

18. The photothermographic material according to claim 17, wherein the non-photosensitive organic silver salt particles are nano-particles.

19. The photothermographic material according to claim 18, wherein an average particle diameter of the nano-particles is 10 nm to 1000 nm.

20. The photothermographic material according to claim 2, wherein the reducing agent is a compound represented by the following formula (R): 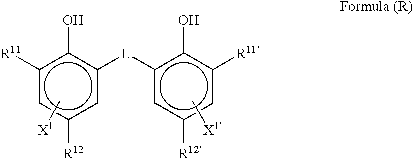
wherein in formula (R), R¹¹ and R^{11′} each independently represent an alkyl group; at least one of R¹¹ and R^{11′} represents a secondary or tertiary alkyl group; R¹² and R^{12′} each independently represent a hydrogen atom or a substituent which can be bonded to the benzene ring; L represents an —S— group or a —CHR¹³— group; R¹³ represents a hydrogen atom or an alkyl group; and X¹ and X^{1′} each independently represent a hydrogen atom or a substituent which can be bonded to the benzene ring.
